(19) United States
(12) Patent Application Publication
(10) Pub. No.: US 2017/0293471 A1
(43) Pub. Date: Oct. 12, 2017

(54) ARITHMETIC UNITS AND RELATED CONVERTERS

(71) Applicant: UNIVERSIDAD DE MÁLAGA, Málaga (ES)

(72) Inventors: Francisco Javier Hormigo Aguilar, Málaga (ES); Julio Villalba Moreno, Málaga (ES)

(21) Appl. No.: 15/300,049

(22) PCT Filed: Mar. 27, 2015
(86) PCT No.: PCT/ES2015/000050

§ 371 Date: Jun. 14, 2017

(30) Foreign Application Priority Data
Mar. 28, 2014 (ES) P201430451
Mar. 28, 2014 (ES) P201430453
Mar. 28, 2014 (ES) P201430454
Mar. 28, 2014 (ES) P201430455
Mar. 28, 2014 (ES) P201430456

(51) Int. Cl. G06F 7/523; G06F 7/50

(52) U.S. Cl. CPC G06F 7/523; G06F 7/50

(57) ABSTRACT

Devices for adding floating point numbers, devices for multiplying floating point numbers, devices for floating-point fused multiply-add operations, devices for performing fixed point number operations, and associated converters thereof. A preprocessed fixed point format is a fixed point format wherein the LSD of all numbers exactly represented in said format is equal to B/2 (i.e. one for binary radix), and the rest are rounded to one of these numbers. A preprocessed floating point format is a floating point format wherein the significand is a preprocessed fixed point number.

The present disclosure relates to data processing and more specifically to devices for adding floating point numbers, devices for multiplying floating point numbers, devices for floating-point fused multiply-add operation, devices for for performing fixed point number operation, and associated converters thereof.

### BACKGROUND ART

In information processing systems, the representation of numbers is performed by binary strings. The bits can be arranged in digits depending on the radix or base.

The numbers may be represented in various formats. The formats mostly used are the Floating Point (FP) format and the Fixed point Format (FF). In fixed point format, which includes the integer numbers, the number of fractional and integer digits is fixed. In this representation, the negative numbers are typically represented in complement format, with respect to the base. For example in binary numbers a two's complement format is used.

In floating point, the number comprises the mantissa (Ma), the base (B) and the exponent (Ex). The value (Va) represented would thus be Va=Ma*B̂Ex. Then, only the numbers Ma and Ex need to be stored. The IEEE-754 standard format is the most extensive one. The standard defines five basic formats that are named for their numeric base and the number of bits used in their interchange encoding. The typical precision of the basic binary formats is one bit more than the width of its significand (or mantissa). The extra bit of precision comes from an implied (hidden) leading 1 bit. The typical floating point number will be normalized such that the most significant bit will be a one. If the leading bit is known to be one, then it need not be encoded in the interchange format.

Systems for performing operations between such numbers may use a plurality of functional units. These units may perform numerical transformations such as arithmetic operations, format conversions, function evaluation, etc. The format used for representing the numbers with which these circuits operate completely defines the design of these circuits and, therefore their fundamental efficiency parameters such as precision, range, speed, area and power. Consequently, the format used in these system influences enormously their efficiency.

Two basic circuits that are required in the majority of such functional units are rounding circuits and two's complement circuits.

The rounding circuits are used when it is necessary to reduce the number of significant digits, both in numbers in fixed format and in the mantissa in floating point format numbers. The circuit that performs a two's complement function is used to change the sign of the number. Any improvement in the efficiency of these two circuits directly affects the efficiency of the majority of the functional units that include them.

To perform the base complement of a number, first a complement to the base minus one is performed, an operation that is performed with all the digits in parallel. Subsequently the Unit-in-the-Last-Place (ULP) digit is added to the number. In the binary case, for a circuit to perform the two's complement of a number of n bits, n inverters and an n-bit adder would be required. In case of a subtraction operation (X−Y=X+(−Y)), which actually involves a sum with the two's complement of the subtrahend, the input carry bit of the adder is typically used to add to the ULP. However, this does not mean that every time that it is required to perform the two's complement the reason is a subtraction. Such cases are the absolute value operation or the addition/subtraction of numbers in sign-magnitude representation, a representation typically used in floating point.

With respect to rounding circuits, there are various forms of rounding used. One that demonstrates significant properties and is used most is the “rounding to nearest tie to even”. In this mode, the value that it is used as final value is the value that it is closer to the real value and, in case of a tie, the even value. Using this type of rounding, an error inferior to +−0.5ULP is achieved and there is no statistical deviation in the errors.

Given a number of d1-digits, to perform a rounding operation of d2-Digits, assuming d1>d2, d1-d2 digits need to be discarded. In order for the rounding to be to the nearest number, it is important to examine the value of the most significant digit of the ones that need to be discarded (MD) and the least significant digit of the ones that remain (LD):
If MD<(B/2) then simply said digits are discarded.
IF MD>(B/2) then said digits are discarded and the value of one is added to the least significant digit that remains.
If MD=(B/2) then it must be verified if one of the digits to be discarded is not zero (sticky bit). If it is so, then the rounding is performed according to the second case. If all digits are zero, then if the LD digit is even then the rounding is performed according to the first case and if it is odd according to the second case.

Therefore, the basic circuit to implement this rounding type requires an adder to add one if necessary and a circuit to calculate the sticky bit.

The rounding and base's complement circuits are required in functional units such as adders, multipliers, dividers, FMAD units, absolute value operators, format converters or precision converters etc. The additional cost, e.g. in area or delay, that such circuits pose in the aforementioned functioning units is usually substantial, mostly because they are typically in the critical path.

Various attempts have been made in the prior art to reduce the effects of these calculations, namely the two's complement, the rounding and sticky bit calculations. In certain prior art documents it has been proposed to precalculate the sticky bit or remove these operations from the critical path or reduce the overall number of rounding operations needed or combine rounding and two's complement.

It would be desirable to have circuits and methods that reduce the cost in area, delay or power in rounding to nearest circuits and/or in base's complement circuits.

The present disclosure relates to various methods and devices for avoiding or at least partly reducing this problem.

### SUMMARY

The present disclosure is directed to fixed point operations configurations and circuits that implement techniques for encoding numbers to perform “round to nearest” and base's complement functions without the need to perform an addition. Thus systems using the proposed encoding type and requiring these operations may, simultaneously, reduce area, delay and power consumption.

To this end the present disclosure focuses on the design of more efficient (faster, lower cost, lower power consumption) digital information processing systems through the use of a new family of formats or a modification of the numerical coding formats, applicable to most current formats, which implies changes in the circuits that process said formats. These formats drastically simplify rounding to the nearest and base's complement circuits, without adversely affecting the rest of the circuit.

In a first aspect, a device for performing a desired addition or subtraction operation of at least two preprocessed floating point numbers to generate a third preprocessed floating point number is disclosed. Each number may have a preprocessed significand of m+2 digits. The device may comprise an exponent data path and a significand data path. The significand data path may comprise a first input arranged to receive at most the m+1 Most Significant Digits (MSDs) of the preprocessed significand of first number and a second input arranged to receive at most the m+1 MSDs of the preprocessed significand of the second number. The significand data path may be arranged to generate at most the m+1 MSDs of the preprocessed significand of the third number. The Least Significant Digit (LSD) of all preprocessed significands may be equal to B/2, B being the base of the numerical system. In case the numerical system is binary, then B=2 and the LSD is equal to 1.

One advantage of the device is the ability to perform the aforementioned operations without using explicitly the LSD of the significand of the floating point numbers. To achieve this, the floating point numbers need to be in a preprocessed format. The proposed format may be derived from any unprocessed format, either fixed point or floating point format. In case of fixed point numbers the preprocessed format may be obtained by adding a new digit as a Least Significant Digit (LSD). The value of said digit (KD) is equal to the representation base divided by two. In case of floating point numbers, the same process takes place for the significand of the FP number.

Therefore, in principle, the preprocessed numbers need one more digit than the unprocessed ones with the same precision. However, as this KD digit (or LSD) is a constant, it does not have to be stored or transmitted explicitly. It may only be required to represent this digit in an explicit form when there is a need to perform operations (arithmetic, conversions or other type) with those numbers. Therefore, the storage and transmission of preprocessed format numbers (implied) is equivalent to the conventional one.

Furthermore, the number of values represented exactly in the two corresponding formats (preprocessed and unprocessed) shall be the same. However, the values exactly represented in each format, shall be different. For example, in a binary fixed point format with only two fractional bits, four values are exactly represented (0, 0.25, 0.5, 0.75), and in the corresponding preprocessed format (i.e., three fractional bits), also four values are exactly represented but different ones (0.125, 0.375, 0.625, 0.875). More specifically, the values exactly represented in the preprocessed format will appear exactly at the halfway points between the exact numerical representations of the unprocessed exactly represented values in the original unprocessed format. This means that the accuracy will be equivalent in both formats, but conversion between them may not be exact.

A digital system using the preprocessed format may be implemented more efficiently if the digit KD is implicit. Said digit KD may be added at the input of a processing circuit or be introduced when an operation requires its presence. On the other hand if the number needs to include explicitly the digit KD, e.g. for a subsequent operation, then the digit KD may be added at the output of a previous operation.

Summarizing, a preprocessed fixed point format is a fixed point format wherein the LSD of all numbers exactly represented in said format is equal to B/2 (i.e. one for binary radix), and the rest are rounded to one of these numbers. Thus, said LSB may be stored, transmitted, or even operated implicitly. A preprocessed floating point format is a floating point format wherein the significand is a preprocessed fixed point number.

Using preprocessed format numbers greatly simplifies the operation of rounding to “nearest” or to “nearest tie to even”. This is the principal advantage of using this format. Given a fixed point number or the significand of a floating point number of d1-digits, the rounding operation “to nearest” to d2+1-digit preprocessed format, assuming d1 and d2 are natural numbers such that d1>d2, is performed by discarding the d1-d2 LSDs (truncation). In the case of rounding “to nearest tie to even”, before operating it is necessary to check if the d1-d2 LSDs are all zero (which is typically performed by calculating the sticky bit). If so, while eliminating the d1-d2 least significant digits, the following process would be performed on the next digit:
If the next digit is even, then it may remain the same.
If the next digit is odd, then one (1) may be subtracted from said digit (which in no case would provoke a carry digit).

Using preprocessed format numbers also simplifies the operation of base's complement. Due to the specific value of the LSD, the addition of 1 ULP after complementing the number to the base minus one simply returns the value of the LSD to B/2 and no carry is produced towards the rest of the digits. For example, in binary format, after one's complementing a preprocessed binary number, the LSB is equal to zero and the addition of one ULP does not produce any carry but only sets the LSB to one again. Therefore, the implementation of the base's complement of a preprocessed number only requires complementing to the base minus one all digits but the LSD which remains equal.

Implementations according to said aspect have the advantage that there is no need for a rounding up logic. The elimination of the logic for rounding up, which usually is an independent adder (incrementer) or a compound adder (adder which returns X+Y and X+Y+1) along with other control logic is made possible because the rounding “to nearest” to obtain a preprocessed number is performed, as it is explained before, only by truncation. Furthermore, there is no need for logic for computing the sticky bit. The elimination of logic for computation of the sticky bit is possible because, if alignment is required, the sticky is always one since the last hidden digit is necessarily always B/2 (digit KD). This is advantageous for rounding and for when the effective operation is a subtraction. Finally, another advantage is that no overflow may occur after rounding, since rounding up is not performed.

In the following description of embodiments it is generally considered that the floating point format uses unsigned significands and an independent sign bit, however, one skilled in the art may apply the teaching disclosed herein also for signed significands in a straightforward manner.

In some embodiments, the exponent data path may be arranged to define the effective operation between the significands according to the desired floating point operation and the signs of the inputs. Furthermore, it may be arranged to detect the floating point number with the highest exponent and generate a first shift amount to align the input significands. It may also be arranged to compute the output exponent and the output sign. Finally, it may be arranged to detect special values of the inputs, such as zero, infinity, “not a number” or denormalize numbers, and instruct the adder to produce the result accordingly. Besides, it may be arranged to detect and resolve exceptions, such as overflow or underflow, and special values, such as the previous ones, after said effective operation.

In some embodiments said preprocessed significands may be normalized. Normalisation means that except for the number zero, a real number is represented with one integer digit with a value not equal to zero and a fractional part. In those embodiments said first and second inputs may be arranged to receive the m MSDs of the fractional part of the first and second preprocessed significands, respectively.

In some embodiments the device may further comprise a third input for receiving the LSD of said first and second preprocessed significands. Alternatively, the third input may have the value of B/2, as the LSD of preprocessed significands is equal to B/2. Therefore, the entire preprocessed significand shall be used for the subsequent operations, although it was not necessary to transmit the entire significand up to the input of the device.

In floating point addition, the operation of the significand data path is generally split into various cases. In some implementations it may be split into two cases: the close path, when it computes the effective subtractions for an exponent difference |d|≦1, and the far path when it computes all the effective additions and the effective subtractions for an exponent difference |d|>1. In some implementations said significand data path, or any part of it, may be implemented using two or more parallel paths to calculate separately the cases to achieve better performance. Each sub-path performs the computation supposing a different case and a final multiplexor selects the correct result for the actual case. In the following description of embodiments it is generally considered a unified implementation of the significand data path, however, one skilled in the art may appreciate that the various modules described herein may be used in a replicated or divided form, with minor modifications, to implement them in parallel paths. Furthermore, although the following descriptions of embodiments represent circuits designed for binary logic, the person skilled in the art may apply the teaching disclosed herein also for non-binary logic circuits in a straightforward manner.

In some embodiments, the significand data path may comprise at least one adding module arranged to receive the at most m+1 MSBs of the first and second preprocessed significand. If the number is normalised then it may receive only m LSBs of the m+1 MSBs as the MSB of a normalised number is always 1 and needs not be received. Otherwise, it may receive all the m+1 MSBs. The significand data path may be arranged to receive an instruction from the exponent data path about the significand corresponding to the number with the highest exponent, the first shift amount and the effective operation. Furthermore, the significand data path may be arranged to generate a value that corresponds either to the addition or to the subtraction operation between said preprocessed significands after aligning them.

In some embodiments said at least one adding module is further arranged to generate a value that corresponds to the absolute value of the result of the effective operation between said preprocessed significands.

In some embodiments, the adding module may comprise a first shifting module arranged to receive the at most m+1 MSBs of the preprocessed significand corresponding to the number with the lowest exponent at a first input and the first shift amount at a second input and generate an output value corresponding to the right shifting of said preprocessed significand corresponding to the number with the lowest exponent. The first shifting module may further comprise a third input having the value of 1 to aggregate explicitly the LSB to the significand before shifting it. A swapping module may be used to receive an indication of the significand corresponding to the number with the lowest exponent and provide it to the first shifting module. In the case that both exponents are equal, any of the significands may be provided as the one corresponding to the lowest exponent, with no change in the functionality. For clarity in the explanation, although both exponents were equal, we will name “the significand corresponding to the number with the lowest exponent” to refer to one of significands and the opposite to refer to the other one. The first shifting module may be arranged to selectively negate the output value. Since the significand is a preprocessed number, this negation may be implemented by only inverting all bits but the LSB, and no addition is required. In some implementations, the sign bit of the significand may be included initially as the MSB of the significand whereas in others a sing bit may be added to the left of the significand before inverting it. In other implementations, the sign bit may be added after the inversion, just before operating with the number. In an alternative implementation, the significant of the floating point format may be signed and therefore negation would not be necessary.

In some embodiments the first shifting module may comprise a right shifter coupled to a conditional bit inverter. In some implementations, the right shifter is placed before the conditional bit inverter and additional logic may be required to set to one the LSB of the output after inversion if the exponents are equal since no shifting is performed and the LSB of the significand is explicitly represented. In other implementations, the right shifter, which should be implemented with sign extension, is placed after the conditional bit inverter and no additional logic is required since the LSB of the significand is added after the inverter circuit.

In some embodiments the adding module may further comprise an integer adder having a first input coupled to the output of the first shifting module and a second input arranged to receive the at most m+1 MSBs of the preprocessed significand with the highest exponent. The integer adder may be arranged to generate a value that corresponds to the result of the effective operation between said preprocessed significands after aligning them. In some implementations the integer adder may be further arranged to generate an overflow signal as an independent output, whereas others may add an extra MSB to the output. In some implementations the integer adder may produce a negative output and a sign bit may be generate. In some implementations the sign bit may be delivered as an independent output, whereas others may add it as the MSB of the output.

In some implementations the integer adder may be arranged to incorporate explicitly the LSB of the preprocessed significand with the highest exponent, which is always one, before the effective operation is performed. In other implementations the integer adder may be arranged to take into account said LSB internally when the effective operation is performed.

In some embodiments the integer adder may be arranged to selectively negate the preprocessed significand corresponding to the number with the highest exponent. This may be used when the effective operation is subtraction, a positive result is required and the exponents are equal.

In some embodiments the integer adder may comprise a conditional bit inverter to selectively negate the preprocessed significand with the highest exponent. Again, an advantage of the proposed embodiments is that in order to negate only an inversion is necessary. In some implementations, the sign bit of the significand may be included initially as the MSB of the significand whereas in others a sign bit may be added to the left of the significand before inverting it.

In some embodiments the adding module may further comprise a control circuit arranged to receive the effective operation and selectively instruct the first shifting module or the integer adder to selectively negate. The control circuit may be different according to output requirements, for example when the output is required in absolute value format or when a negative output is allowed.

In some embodiments the device may further comprise a normalization module. The normalization module of the FP adder may have a first input coupled to the output of the adding module and a second input for receiving a second shift amount. The normalization module may be arranged to generate the at most m+1 MSBs of the third preprocessed significand by selectively left or right shifting the output of the adding module. Since the output is a preprocessed number then the rounding to nearest may be performed by a simple truncation but some bias may appear after rounding.

In some embodiments the normalization module of the FP adder may further be arranged to selectively generate a value equivalent to subtracting one from the LSB of the result of the shifting operation when a selected bit or a combination of selected bits of the output of the adding module is equal to one. This arrangement allows the normalisation module to remove the bias (tie to even) when d={1, 0} and the effective operation is a subtraction, i.e. the close path case.

In some embodiments the normalization module may further be arranged to selectively generate the one complement of the result of said shifting or said subsequent subtraction. It allows a positive output, when the integer adder provides a negative output and, furthermore, removes the bias of the rounding when d=0 and the effective operation is a subtraction.

In some embodiments the normalization module may further be arranged to selectively fill the vacant positions, after a left-shifting operation, by setting them to zero or by setting the MSB of the vacant positions to zero and the rest to one or by setting the MSB of the vacant positions to one and the rest to zero.

In some embodiments, the normalization module may be arranged to selectively fill said vacant positions randomly based on the value of a selected bit or of a combination of selected bits of the first input of the normalization module when the difference of the exponents is equal to 1. In alternative implementations, said value may be any bit or combination of bits with adequate random characteristics. In other implementations, a new input may be arranged. This allows to remove any bias in the rounding when d=1.

In some embodiments, the normalization module may further be arranged to force to zero the second LSB of the value that corresponds to the third preprocessed significand when the input operands have the same exponent, the values of the second LSB of the preprocessed significands of said operands are different, and the effective operation is addition. This allows removing the bias in the rounding for the aligned sum (tie to even).

In some embodiments the device may further comprise a circuit arranged to identify the position of the leading significant bit of the output of the adding module and calculate the second shift amount to be used by the exponent data path to compute the output exponent and by the normalization module to normalize the significand.

In a second aspect, a device for performing a multiplication operation of at least two preprocessed floating point numbers to generate a third preprocessed floating point number is disclosed. Each number has a preprocessed significand of m+2 digits. The device comprises an exponent data path and a significand data path. The significand data path may comprise a first input arranged to receive at most the m+1 Most Significant Digits (MSDs) of the preprocessed significand of first number and a second input arranged to receive at most the m+1 MSDs of the preprocessed significand of the second number. The significand data path may be arranged to generate at most the m+1 MSDs of the preprocessed significand of the third number. The Least Significant Digit (LSD) of all preprocessed significands may be equal to B/2, B being the base of the numerical system. In case the numerical system is binary, then B=2 and the LSD is equal to 1.

In some embodiments, the exponent data path may be arranged to compute the output exponent and the sign of the output. Furthermore, it may be arranged to detect special values of the inputs, such as zero, infinity, “not a number” or denormalize numbers, and instruct the multiplier to produce the result accordingly. Besides, it may be arranged to detect and resolve exceptions, such as overflow or underflow, and special values, such as the previous ones, after said operation.

In some embodiments said preprocessed significands may be normalized.

In some embodiments the device may further comprise a third input for receiving the LSD of said first and second preprocessed significands. Alternatively, the third input may have the value of B/2, as the LSD of preprocessed significands is equal to B/2. Therefore, the entire preprocessed significand shall be used for the subsequent operations, although it was not necessary to transmit the entire significand up to the input of the device.

In some embodiments, the mantissa data path may comprise a fixed point multiplying module arranged to receive, at a first and a second input, the at most m+1 MSBs of the first and second preprocessed mantissas respectively. If the numbers are normalized then it may receive only m LSBs of the m+1 MSBs as the MSB of a normalized number is always 1 and needs not be received. Otherwise, it may receive all the m+1 MSBs. The fixed point multiplying module may be arranged to generate the m+2 MSBs of the value that corresponds to the multiplication operation between said preprocessed mantissas.

Implementations according to embodiments disclosed herein have the advantage that the LSB of the significands of the operands is not required explicitly, only the m+2 MSBs of the product have to be generated and there is no need for a rounding logic, including the computation of the sticky bit. In some implementations of said fixed point multiplier module, a standard fixed point multiplier having two m+2 bit input may be used by setting the LSB of said two inputs to one and the remaining bits equal to the inputs of said multiplier module whereas, in other implementations, the implicit LSB is taken into account internally to the multiplier.

In some embodiments the fixed point multiplying module may comprise a redundant multiplier arranged to receive, at a first and a second input, the at most m+1 MSBs of the first and second preprocessed mantissas respectively and generate, in a redundant representation format, the 2*m+3 MSDs of a value corresponding to the multiplication operation between said preprocessed mantissas. Furthermore, the fixed point multiplying module may comprise a conversion module, coupled to the output of said multiplying module, arranged to receive the m+2 MSDs of the output of said redundant multiplier and a carry bit, and generate an m+2 bits output corresponding to the conversion of the received redundant value to non-redundant representation format. Furthermore, the fixed point multiplying module may comprise a carry net module arranged to receive the m+1 LSDs of the output of said redundant multiplier and generate said carry bit corresponding to the output carry of the conversion of the m+1 LSDs of the output of said redundant multiplier to a non-redundant representation.

Someone skilled in the art may appreciate that the word lengths of the intermediate values of in embodiments disclosed herein guarantee the lowest rounding error. However, if a greater error is allowed those sizes may be reduced to simplify the hardware in a straightforward manner. For example, the size of the output of the redundant multiplier may be lower than 2m+3 digits, such as the input of the conversion module remains the same whereas the input of the carry net module may be reduced accordingly.

In some embodiments the redundant multiplier may comprise a partial product generator arranged to receive, at a first and a second input, the at most m+1 MSBs of the first and second preprocessed mantissas respectively and generate their partial products at an output. Furthermore, the redundant multiplier may comprise a compressor tree, having a first input coupled to the output of the partial product generator and a second input arranged to receive the at most m+1 MSBs of the first and second preprocessed mantissas, said compressor tree arranged to generate, in a redundant representation, the 2*m+3 MSDs of a value corresponding to the multiplication operation between said preprocessed mantissas at an output.

As the LSB of the preprocessed significands is equal to 1, the partial product generator is not required to generate partial products for said LSBs and they may be considered already generated. They are directly introduced in the compressor tree (externally or internally) which results in fewer operations and logic for the partial product generator.

In some embodiments the fixed point multiplying module may comprise a third input having the value of 1.

In some embodiments the device may further comprise a normalization module having an input coupled to the output of the fixed point multiplying module, wherein the normalization module is arranged to generate the at most m+1 MSBs of the third preprocessed mantissa by selecting the m+1 LSBs of its input if the MSB is equal to zero or the m+1 MSBs if said bit is equal to one.

In a third aspect, a device for performing a floating-point fused multiply-add operation among three floating point preprocessed numbers to generate a fourth preprocessed floating-point number is disclosed. Each number has a significand of m+2 digits. The device comprises an exponent data path configured to receive the exponents of the three preprocessed numbers and generate the exponent of the result of the floating-point fused multiply-add operation, and a significand data path. The significand data path comprises a multiplication path and an adding path. The multiplication path comprises a first input arranged to receive at most the m+1 Most Significant Digits (MSDs) of the preprocessed significand of the first number and a second input arranged to receive at most the m+1 Most Significant Digits (MSDs) of the preprocessed significand of the second number. The multiplication path is configured to multiply said preprocessed significands of the first and second numbers and generate a multiplication result at an output. The adding path is configured to receive at most the m+1 Most Significant Digits (MSDs) of the preprocessed significand of the third number at a first input and the multiplication result at a second input and generate the at most m+1 MSDs of the significand of the fourth preprocessed number. The Least Significant Digit (LSD) of all preprocessed significands is equal to B/2, B being the base of the numerical system. When B=2 the digits are bits.

In some embodiments the exponent data path may be arranged to define the effective operation between the third significand and the multiplication result according the signs of the inputs; compute the output exponent; compute the output sign; and detect and resolve exceptions, such as overflow or underflow, and special values of the inputs or said operation.

In some embodiments the preprocessed significands may be normalized.

In some embodiments the device may further comprise a fourth input for receiving the LSD of said first, second, and third preprocessed significands. Alternatively, the fourth input may have the value of B/2, as the LSD of preprocessed significands is equal to B/2. Therefore, the entire preprocessed significand shall be used for the subsequent operations, although it was not necessary to transmit the entire significand up to the input of the device.

In some embodiments the adding path may comprise a first shifting module, configured to receive the at most m+1 Most Significant Bits (MSBs) of the third preprocessed significand at a first input. If the number is normalized then it may receive only m LSBs of the m+1 MSBs as the MSB of a normalized number is always 1 and needs not be received. Otherwise, it may receive all the m+1 MSBs. The first shifting module may further be arranged to receive an instruction from the exponent data path about the first shift amount and the effective operation between the third preprocessed significand and the output of the multiplication path, and align them, accordingly. The adding path may further comprise an adding module, configured to add the aligned output of the first shifting module with the output of the multiplication path. In these embodiments the LSB of the third significant is not required to obtain the aligned significand.

In some embodiments the multiplication path may comprise a multiplication module, configured to receive, at an input, the at most m+1 MSBs of the significands of the first and second floating point numbers, respectively, and generate the 2*m+3 MSBs of a value corresponding to the multiplication between said preprocessed significands at an output. If the numbers are normalized then it may receive only m LSBs of the m+1 MSBs as the MSB of a normalized number is always 1 and needs not be received. Otherwise, it may receive all the m+1 MSBs.

In some embodiments the multiplication path may comprise a redundant multiplier arranged to receive, at a first and a second input, the at most m+1 MSBs of the first and second preprocessed mantissas respectively and generate, in a redundant representation format, the 2*m+3 MSDs of a value corresponding to the multiplication operation between said preprocessed mantissas. Again If the numbers are normalized then it may receive only m LSBs of the m+1 MSBs as the MSB of a normalized number is always 1 and needs not be received. Otherwise, it may receive all the m+1 MSBs.

Not only the embodiments with a multiplication module but also the embodiments with a redundant multiplier have the advantage that the LSB of the input operands is not required explicitly, and the LSD (or LSB) of the output needs not be generated. In some implementations, a standard fixed point multiplier having two m+2 bit inputs may be used by setting the LSB of said two inputs to one and the remaining bits equal to the inputs of said multiplier module whereas, in other implementations, the implicit LSB may be taken into account internally to the multiplier. Similar argument is valid for the redundant multiplier.

In some embodiments the redundant multiplier may comprise a partial product generator and a compressor tree. The partial product generator may be arranged to receive, at a first and a second input, the at most m+1 MSBs of the first and second preprocessed mantissas and generate their partial products at an output. The compressor tree may have a first input coupled to the output of the partial product generator and a second input arranged to receive the at most m+1 MSBs of the first and second preprocessed mantissas, said compressor tree arranged to generate, in a redundant representation, the 2*m+3 MSDs of a value corresponding to the multiplication operation between said preprocessed mantissas at an output. As the LSB of the preprocessed significands is equal to 1, the partial product generator is not required to generate partial products for the LSBs and they may be considered already generated. They are directly introduced in the compressor tree which results in fewer operations and logic for the partial product generator.

In some embodiments the multiplication module may further comprise a third input having the value of 1.

In some embodiments the first shifting module may be arranged to receive the at most m+1 MSBs of the third preprocessed significand at a first input and the first shift amount at a second input and generate an output value corresponding to the right shifting of said preprocessed significand.

In some embodiments the first shifting module may be arranged to selectively negate the output value. Since the significand is a preprocessed number, this negation may be implemented by only inverting all bits but the LSB, and no addition is required. In some implementations, the sign bit of the significand may be included initially as the MSB of the significand whereas in others a sign bit may be added to the left of the significand before inverting it. In other implementations, the sign bit may be added after the inversion, just before operating with the number. In an alternative implementation, the significant of the floating point format may be signed and therefore negation would not be necessary.

In some embodiments the first shifting module may further comprise a third input having the value of one to aggregate explicitly the LSB to the significand before shifting it.

In some embodiments the first shifting module may comprise a right shifter coupled to a conditional bit inverter. In some implementations, the right shifter, which should be implemented with sign extension, is placed after the conditional bit inverter and no additional logic is required since the LSB of the significand is added after the inverter circuit. In other implementations, the right shifter is placed before the conditional bit inverter but additional logic may be required add one to the LSB of the output after inversion since said output is not a preprocessed number.

In some embodiments the adding module may comprise an adder configured to receive the output of the multiplication path at a first input and the output of the first shifting module at a second input, and generate a value corresponding to the signed addition of both values at an output.

In some embodiments, said adder may be configured to receive the 2*m+3 MSBs of the multiplication of the first and second preprocessed significands at a first input and the output of the first shifting module at a second input and generate a value corresponding to a signed addition of both values at an output. In other embodiments said adder may be configured to receive the 2*m+3 MSDs of the multiplication of the first and second preprocessed significands, in a redundant representation format, at a first input and the output of the first shifting module at a second input and generate a value corresponding to the signed addition of both values at an output. Implementations according to embodiments disclosed herein may have the advantage that the LSD (or LSB) of said multiplication result is not received explicitly. In some implementations the adder may be arranged to incorporate explicitly said LSB, which is always one, before the effective operation is performed. In other implementations the adder may be arranged to take into account said LSB internally, when the effective operation is performed.

In some embodiments, said signed addition may comprise n bits, n>m, and said adder may be configured to generate the at most n−1 MSBs of said signed addition at a first output. The LSB may be implicit when it is equal to one or not required for certain cases. In some embodiments, said adder may be further configured to generate the LSB of said signed addition at a second output. In some implementations, said n bits may be aligned with the multiplication result, i.e., the LSB of said n bits has the same weight than the LSB of the multiplication result. However, in other implementations, bits with less weight may be considered, but they do not contribute to obtain more precise final result. Similarly, in other implementations, the LSB of said n bits may have more weight than the LSB of the multiplication result, but the final result may be less precise in certain cases. In some implementation, n may be equal to 3*m+6 and a signal may be generated to detect overflow. In other implementation, n may be equal to 3*m+7, and the MSB may be the sign bit and no overflow signal is required.

In some embodiments the significand data path may further comprise a normalization module having a first input coupled to the adding module and a second input for receiving a second shift amount, wherein the normalization module is arranged to generate the at most m+1 MSBs of the fourth preprocessed significand by left shifting the output of the adding module. Since the output is a preprocessed number then the rounding to nearest may be performed by a simple truncation but some bias may appear after rounding.

In some embodiments the normalization module may further be arranged to selectively generate the value equivalent to subtracting one from the LSB of the result of the shifting operation when a selected bit or a combination of selected bits is equal to one. In some implementations, this bit or bits may be selected from the first input of the normalization module. In other implementations, a new input may be arranged. This arrangement allows the normalization module to remove the bias of the rounding.

In some embodiments the normalization module may further be arranged to selectively fill the vacant positions, after a left-shifting operation, by setting them to zero or by setting the MSB of the vacant positions to zero and the rest to one or by setting the MSB of the vacant positions to one and the rest to zero. This arrangement allows the normalization module to provide the correct result in certain cases, such as when the LSB of the addition result is implicit.

In some embodiments the normalization module may be arranged to selectively fill said vacant positions randomly based on the value of a selected bit or of a combination of selected bits with adequate random characteristic. In some implementations, this bit or bits may be selected from the first input of the normalization module. In other implementations, a new input may be arranged. Such arrangements allow the normalization module to remove the bias of the rounding.

The normalization modules arranged according to some of the embodiments described herein allow performing rounding to nearest without bias in certain cases. One such case is after an FMAD operation, when the normalization requires a left shift of more than 2*m+2 bits. Filling the vacant positions to the right with zeros produces an effective rounding up and consequently some bias. Since, in this case, the LSB of the result of the addition is always one, the normalization module may be easily arranged, as described previously, to produce randomly a rounding down which eliminates said bias. If said LSB is received explicitly, this is performed by randomly subtracting one from the LSB of the shifted value. Now, if the LSB is not received explicitly this may be achieved by setting randomly either the MSB of the vacant positions to zero and the rest to one or by setting the MSB of the vacant positions to one and the rest to zero. The same solutions may be used when the operation is a sole addition and the exponent of the third input is one greater than the exponent of the other addend. We name sole addition the case when either the first or the second input is equal to one and then the FMAD operation is effectively just an addition between the third input and the input which is not one. Similarly, another case when bias may be produce is, if after a sole addition when the exponent of the third input is one lower than the exponent of the other addend, the normalization requires a left shift of more than 2*m+2 bits. In this case, the bias may be avoided by setting randomly either the MSB of the vacant positions to zero and the rest to one or by setting the MSB of the vacant positions to one and the rest to zero, since the LSB of the result of the addition is implicit and equal to one. Finally, another case is after a sole addition when the exponent of the third input and the exponent of the other addend are equal. Since, in this case, the result of the addition may be either positive or negative and its LSB is zero, the bias may be avoided by two ways. One way is by just filling the vacant positions with zeroes. Another way is by filling with zeroes and also subtracting one from the LSB of the shifted value if a selected bit, or combination of them, of the result of the sole addition is one.

In some embodiments, the normalization module may be further arranged to force to zero the second LSB of the value that corresponds to the fourth preprocessed significand when the operation is a sole addition, the third input operand and the other addend have the same exponent and sign, and the values of the second LSB of the preprocessed significands of said operands are different. This allows removing the bias in the rounding for the aligned sole addition (tie to even).

In some embodiments the normalization module may further be arranged to selectively generate the one complement of the result of said shifting or said subsequent subtraction operation. It allows a positive output, when the adding module provides a negative preprocessed number. Since it is a preprocessed number, this negation may be implemented by only inverting all bits but the LSB, and no addition is required. The adder could provide a negative unprocessed number only when performing a sole addition of two numbers with the same exponent and different sign. In this case, the bit inversion would change the sign and also remove the bias of the rounding. In alternative implementations, the significant of the floating point format may be signed and the inversion would not be necessary.

In an alternative implementation, the exponent data path may be arranged to distinguish among a fused multiply-add operation or sole multiplication or sole addition. The sole multiplication may be recognized if the third input operand is a special value zero and the device may be instructed to produce the result of a sole multiplication. In some implementations, the sole addition may be recognized if either the first or second input operand is a special value one, whereas in others, it may be recognized by an external instruction. In some implementations the multiplication path may be instructed to generate an output corresponding either to the first or second significand, if sole addition is recognized. In some implementations, the normalization module may be instructed, if sole addition is recognized, to generate an output accordingly.

In some implementations the device may further comprise a circuit arranged to identify the position of the leading significant bit of the output of the adding module and calculate the second shift amount to be used by the exponent data path to compute the output exponent and by the normalization module to normalize the significand.

In a fourth aspect, a device configured to be connected to an arithmetic unit is disclosed. Said arithmetic unit is configured to process at least a first preprocessed floating point number to generate at least a second preprocessed floating point number. Said preprocessed floating point numbers have a significand with an LSD equal to B/2, B being the base of the numerical system. The device is configured to convert an input number to said first preprocessed floating point number or said second preprocessed floating point number to an output number.

One advantage of the device is that it allows numbers represented in unprocessed format to operate in arithmetic units for preprocessed floating-point numbers, and deliver the results also in a format different from a preprocessed one.

In the following description of embodiments, it is generally considered that the fixed point numbers, both unprocessed and preprocessed, are represented in two's complement representation, but minor modifications to the disclosed embodiments are required to support other formats.

In some embodiments the device may further comprise a preprocessed-fixed-point-to-preprocessed-floating-point numbers converter for converting a preprocessed n+2-bit fixed-point number to a preprocessed floating point number having a significand of m+2 bits. The preprocessed-fixed-point-to-preprocessed-floating-point converter may comprise a shift amount calculator, an exponent calculator having a first input for receiving a third shift amount from the shift amount calculator and an output for generating the exponent of the preprocessed floating point number, and a significand calculator. The significand calculator may comprise a normalization module having a first input for receiving the n MSBs of the n+1 LSBs of the fixed-point number and a second input for receiving the third shift amount. The normalization module may be arranged to left shift the n MSBs according to said shift amount and fill the vacant positions by setting the MSB of the vacant positions to zero and the rest to one or by setting the MSB of the vacant positions to one and the rest to zero to generate the at most m+1 MSBs of the significand. The sign of the preprocessed floating point number may correspond to the MSB of the preprocessed fixed point number. Introducing such a converter before the adding module allows a number in a preprocessed fixed format to be processed by adding devices according to embodiments described herein.

In some embodiments the normalization module of the significand calculator may be arranged to randomly fill said vacant positions based on the value of a selected bit or of a combination of selected bits. In some implementations said bit (or bits) may be selected from the fixed point number. In other implementations, a new input may be arranged.

In some embodiments the normalization module of the significand calculator may be further arranged to selectively generate the one complement of the result of said shifting.

In some embodiments the device may further comprise an unprocessed-fixed-to-preprocessed-floating-point numbers converter for converting an unprocessed fixed-point number of R bits to a preprocessed floating point number having a significand of m+2 bits. The unprocessed-fixed-to-preprocessed-floating-point numbers converter may comprise a shift amount calculator, a normalization module arranged to receive the R bits of the unprocessed fixed point number and generate the at most m+1 MSBs of the significand of the preprocessed floating point number, and an exponent calculator having a first input for receiving a fourth shift amount from the shift amount calculator and an output for generating the exponent of the preprocessed floating point number. The sign of the preprocessed floating point number may correspond to the MSB of the unprocessed fixed point number. Introducing such a converter before the adding module allows a number in an unprocessed fixed format to be processable by adding devices according to embodiments described herein.

In some embodiments the normalization module of the unprocessed-fixed-to-preprocessed-floating-point numbers converter may comprise a first input for receiving the r bits of the unprocessed fixed-point number and a second input for receiving the fourth shift amount. The normalization module may be arranged to generate a value that corresponds to the at most m+1 MSBs of the preprocessed significand by left shifting the r−2 MSBs of the r−1 LSBs of the first input followed to the right by a zero bit and by filling the vacant positions with the value of the LSB of the first input.

In some embodiments the normalization module of the unprocessed-fixed-to-preprocessed-floating-point numbers converter may be further arranged to selectively generate the one complement of said value if the input is negative.

In some embodiments the normalization module of the unprocessed-fixed-to-preprocessed-floating-point numbers converter may comprise a first input for receiving the r bits of the unprocessed fixed-point number and a second input for receiving a fourth shift amount, wherein the normalization module is arranged to generate a value that corresponds to the at most m+1 MSBs of the preprocessed significand by left shifting the r−1 LSBs of the first input.

The normalization modules according to some embodiments herein, may comprise a special barrel left shifter arranged to receive a bit for filling the vacant positions. In some embodiments, the special barrel left shifter may comprise a number of successive multiplexers that is equal to the first integer greater or equal to the base 2 logarithm of a maximum shift amount [log 2(maximum shift amount)]. Each multiplexer may be arranged to perform a left shifting operation that is equal to 2̂i places, iε[0, number of multiplexers−1] and arranged to fill the vacant positions using the value of said received bit.

Furthermore, the normalisation modules according to some embodiments herein may be further arranged to selectively generate the one complement of the result of said shifting operation.

In some embodiments the exponent calculator of the unprocessed-fixed-to-preprocessed-floating-point numbers converter may be arranged to decrement, according to the fourth shift amount, a base value to obtain the exponent.

In some embodiments the exponent calculator of the unprocessed-fixed-numbers preprocessed-floating-point converter may be further arranged to detect underflow, overflow or zero values and instruct the converter to generate the output accordingly.

In some embodiments the device may further comprise a preprocessed-floating-point-to-unprocessed-fixed-point numbers converter for converting the third preprocessed floating point number to a third unprocessed fixed-point number. When the unprocessed fixed-point number has h+1 bits, the converter comprises a preprocessed-floating-point-to-preprocessed-fixed-point numbers converter having an output of h+2 bits coupled to a rounding module.

In some embodiments, the rounding module of the preprocessed-floating-point-to-unprocessed-fixed-point numbers converter may comprise an adder. Said adder may be arranged to receive, at an input, the h+1 MSBs of the output of said preprocessed-floating-point-to-preprocessed-fixed-point numbers converter and increment said input value if the LSB of said output is equal to 1. Introducing such a converter after devices according to embodiments disclosed herein allows for the result of the operations to be used by circuits functioning in unprocessed format.

In some embodiments the device may further comprise a preprocessed-floating-point-preprocessed-floating-point numbers converter for converting an initial preprocessed floating point number having a significand of j+2 bits to a subsequent preprocessed floating point number. Said subsequent preprocessed floating point number may have at least a different size of significand. This may be useful, for example, when the two operands are provided to the adder from different sources and need to have significands of equal size to allow operations between them. Accordingly, if the result of the operation needs to be converted to a floating point number having a significand of different size so that it may be used by a subsequent circuit. Therefore, the converter may be placed either before or after the FP adder, accordingly.

When the subsequent preprocessed floating point number has a significand with j+2−p bits, p<j+1 then the converter may comprise a rounding unit for removing the p+1 LSBs of the j+2 bits of the initial preprocessed significand to generate at most j+1−p MSBs of the significand of the subsequent preprocessed floating point number. The LSB of the significand of the subsequent preprocessed floating point number is equal to 1. The converter may further comprise an exponent calculator for generating the exponent of the subsequent preprocessed floating point number.

When the subsequent preprocessed floating point number has a significand with j+2+q bits then the converter may comprise a filling module, arranged to receive the at most j+1 MSBs of the significand of the initial preprocessed floating point number and generate the at most j+q+1 MSBs of the significand of the subsequent preprocessed floating point number by setting the MSB of the q LSBs to one or zero and the remaining q−1 bits of said q LSBs to the complement of said MSB. The at most j+1 MSBs of the significand of the subsequent preprocessed floating point number may be the same as the at most j+1 MSBs of the significand of the initial preprocessed floating point number The converter may further comprise an exponent calculator for generating the exponent of the subsequent preprocessed floating point number.

In some embodiments the filling module of the preprocessed-floating-point-to-preprocessed-floating-point numbers converter may be arranged to randomly set said MSB based on the value of a selected bit or of a combination of selected bits. In some implementations, said bit (or bits) may be selected from the significand of the initial preprocessed floating point number.

In some embodiments the device may further comprise a preprocessed-floating-point-preprocessed-fixed-point numbers converter for converting a preprocessed floating point number having a significand of f+2 bits to a preprocessed fixed-point number. Introducing such a converter after devices according to embodiments disclosed herein allows for the result of the operations to be used by circuits functioning in preprocessed fixed point format.

When the preprocessed fixed-point number comprises L bits, wherein L<f+4, the preprocessed-floating-point-to-preprocessed-fixed-point numbers converter may comprise a shift amount calculator receiving the exponent of the preprocessed floating point number at an input and generating a fifth shift amount at an output. The converter may further comprise a shifting module having a first input for receiving the L−1 MSBs of the significand of the preprocessed floating point number and a second input coupled to the output of the shift amount calculator and a third input for receiving the sign of said floating point number to generate the L−1 MSBs of the preprocessed fixed-point number at an output. The LSB of said preprocessed fixed point number is equal to B/2 and may be implicit.

In some embodiments the shifting module of the preprocessed-floating-point-to-preprocessed-fixed-point numbers converter may comprise an arithmetic right shifter coupled to a conditional bit inverter.

When the preprocessed fixed-point number comprises f+c+3 bits, c>0, the preprocessed-floating-point-to-preprocessed-fixed-point numbers converter may comprise a shift amount calculator receiving the exponent of the preprocessed number at an input and generating a fifth shift amount at an output, and an arithmetic right shifting module having a first input coupled to the output of the shift amount calculator and arranged to generate the f+c+2 MSBs of the preprocessed fixed point number by arithmetic right shifting an intermediate f+c+2 bit value. Said intermediate value may have, from left to right, the sign bit, the f+1 MSBs of the significand of the preprocessed floating point number, and the MSB of the c LSBs set to zero and the rest to one or the MSB of the c LSBs set to one and the rest to zero.

In some embodiments, the arithmetic right shifting module may be arranged to randomly set said MSB of the c LSBs of said intermediate f+c+2 bit value based on the value of a selected bit or of a combination of selected bits. In some implementations, said bit (or bits) may be selected from the preprocessed floating point number.

In some embodiments the arithmetic right shifting module may be further arranged to selectively generate the one complement of the result of said shifting operation.

In some embodiments, the device may further comprise a unprocessed-floating-point-to-preprocessed-floating-point numbers converter for converting an unprocessed floating point number having a significand of e+2 bits to a preprocessed floating point number. Introducing this converter at some stage before a device according to embodiments described herein, allows for numbers that are not in the preprocessed format to be processed by the aforementioned devices.

When the preprocessed floating point number has a significand with e+2−d bits, d<e+1 then the unprocessed-floating-point-to-preprocessed-floating-point numbers converter may comprise a rounding unit arranged to remove the d+1 LSBs of the significand of the unprocessed floating point number to generate the e+1−d MSBs of the significand of the preprocessed floating point number. The LSB of the significand of the preprocessed floating point number is equal to one. The unprocessed-floating-point-to-preprocessed-floating-point numbers converter may further comprise an exponent calculator for generating the exponent of the preprocessed floating point number.

In some embodiments, the rounding unit of the unprocessed-floating-point-to-preprocessed-floating-point numbers converter may be further arranged to selectively set to zero the second LSB of the significand of the preprocessed floating point number if all of the d+1 LSBs of the significand of the unprocessed floating point number are equal to zero.

When the preprocessed floating point number has a significand with e+2+g bits then the unprocessed-floating-point-to-preprocessed-floating-point numbers converter may comprise a filling module, arranged to receive the significand of the unprocessed floating point number and generate the e+g+1 MSBs of the significand of the preprocessed floating point number by setting the e+2 MSBs of the preprocessed floating point number equal to the value of the e+2 bits of the significand of the unprocessed floating point number and the remaining bits to zero. The LSB of the significand of the preprocessed floating point number is equal to one. The unprocessed-floating-point-to-preprocessed-floating-point may further comprise an exponent calculator arranged to generate the exponent of the preprocessed floating point number.

In some embodiments the filling module of the unprocessed-floating-point-to-preprocessed-floating-point numbers converter may be further arranged to selectively generate the value corresponding to subtracting one from the second LSB of the said generate significand when a selected bit or a combination of selected bits of the input unprocessed significand is equal to one.

In some embodiments the device may further comprise a preprocessed-floating-point-to-unprocessed-floating-point numbers converter for converting a preprocessed floating point number of u+2 bits to an unprocessed floating point number. Introducing such a converter after devices according to embodiments described herein allows for the result of the operation to be processed by common floating point circuits.

When the unprocessed floating point number has a significand with u+2−v bits, then the converter may comprise a rounding module, arranged to receive the at most u+3−v MSBs of the significand of the preprocessed floating point number and generate the at most u+2−v bits of the significand of the unprocessed floating point number, and an exponent calculator arranged to generate the exponent of the unprocessed floating point number.

In some embodiments the rounding module of the preprocessed-floating-point-to-unprocessed-floating-point numbers converter may comprise an adder. The adder may be arranged to receive, at an input, the at most u+2−v MSBs of the significand of the preprocessed floating point number and increment said input value if the u+3−vth MSB of said significand is equal to 1, and generate an instruction to the exponent calculator, if an overflow is produced.

In some embodiments, the exponent calculator may be further arranged to increment the output exponent when said instruction from the rounding module is generated.

When the unprocessed floating point number has a significand with U+2+W bits then the preprocessed-floating-point-to-unprocessed-floating-point numbers converter may comprise a filling module, arranged to receive the at most u+1 MSBs of the significand of the preprocessed floating point number and generate the u+w+2 bits of the significand of the unprocessed floating point number by setting the MSB of the w+1 LSBs to one and the remaining bits to zero, and an exponent calculator arranged to generate the exponent of the preprocessed floating point number.

In a fifth aspect, a device for performing a desired operation of at least a first preprocessed fixed point number having n+1 digits to generate at least a second preprocessed fixed point number having z+1 digits is disclosed. The device comprises at least one arithmetic unit having a first input for receiving the n MSDs of said at least first preprocessed fixed point number. The at least one arithmetic unit is arranged to generate the z MSDs of the at least second preprocessed fixed point number. The Least Significant Digit (LSD) of all preprocessed fixed point numbers is equal to B/2, B being the base of the numerical system.

In some embodiments, the at least one arithmetic unit may further comprise at least a second input for receiving the L MSDs of a third preprocessed fixed point number having L+1 digits, wherein L≧N and the LSD is equal to B/2. One skilled in the art may appreciate that if L<N, both numbers, i.e. the first and third number, may be interchanged to fulfil said condition. Said arithmetic unit may further comprise an addition module to generate a value corresponding to the second preprocessed fixed point number. Said second preprocessed fixed point number may be the result, rounded to nearest, of the addition of the first and the third preprocessed fixed point numbers. In alternative implementations, said third preprocessed fixed point number may be a constant and may not be received explicitly. In these implementations the adding module may be further optimized to perform the addition of said constant number.

In some embodiments, the addition module may comprise an adder configured to receive the n MSBs of the first and third preprocessed fixed point number, at a first and second input, respectively. In the following embodiments the LSB of the first preprocessed fixed point number is considered implicitly to perform the addition. In alternative implementations the adder may be arranged to incorporate explicitly the LSB of said number, which is always one, augmenting by one bit the size of the adder.

When z≦n, said adder may be configured to generate the z MSBs of a value equivalent to adding said two inputs plus a carry input. Said carry input may be equal to the n+1 th MSB of the third preprocessed fixed point number, since the LSB of the first preprocessed fixed point number is one. The main advantages of this configuration is that no additional circuit is required to perform rounding to nearest of the result and even the generation of the n−z LSBs is not required. Thus, one skilled in the art may appreciate that a significant part of said adder may be optimized internally, since only the last carry signal corresponding to the addition of the n−z LSBs is required.

On the other hand, when z=n=L, the LSB of the exact result of the addition is zero and thus a rounding up is always performed which produces some bias. In this case the adding module may be further configured to set to zero the second LSB of the second preprocessed fixed point number. This additional configuration avoids said bias. Besides, the adder may be simplified since said second LSB may not be generated. In alternative implementations, to avoid said rounding up, the arithmetic unit or the device may be configured to deliver the exact result of the addition which is an unprocessed number (since the LSB is zero).

When z>n, said adder may be configured to generate the n MSBs of the second preprocessed fixed point number by producing a value equivalent to adding said two inputs plus a carry input. Said carry input may be equal to the n+1th MSB of the third preprocessed fixed point number, since the LSB of the first preprocessed fixed point number is one. The adding module may be further configured to set the n+1th MSB of the second preprocessed fixed point number equal to the inverse of the n+1th MSB of the third preprocessed fixed point number, which is equivalent to adding one to it. Said adding module may be further configured to set the remaining z−n−1 LSBs of the z MSBs of the second preprocessed fixed point number equal to the z−n−1 LSBs of the z MSBs of the third preprocessed fixed point number. The LSB of the second preprocessed fixed point number is implicit and equal to one. Again, no additional circuit is required to perform rounding to nearest of the result.

In some embodiments the adding module may be further arranged to negate one of the input numbers. As stated before, said negation is performed by inverting all bits except the LSB.

In some embodiments said negation operation may be performed selectively according to a control signal.

In other implementations, the adding module may comprise more than two inputs for receiving more than two preprocessed numbers to be added, respectively. In this case, the LSB of all input preprocessed numbers may be added to the result of the addition of the remaining bits as a constant value being the result of the addition of the LSB of all input preprocessed numbers. For instance, if the adding module is configured to receive nn preprocessed input operands, all having mm+1 bits, the result of the adding module may be obtained by adding the value nn (which is the addition of the LSB of all inputs), correctly aligned, to the result of the addition of the mm MSBs of all input numbers. If the sizes of the input numbers are not the same, the weight of each LSB needs to be taken into account to generate said constant value. On the other hand, if said constant value is odd then the result of the addition is a preprocessed number. Otherwise, the second LSB of the result may be set to zero to avoid the bias due to rounding.

Although the adding modules of the embodiments disclosed herein have the output result in non-redundant format, one skilled in the art may appreciate that the extension of these embodiments to implementations having the output in a redundant format, such as carry-save or signed-digit formats, may be performed in a straightforward manner.

In some embodiments the at least one arithmetic unit may comprise a multiplication module to generate a value corresponding to the second preprocessed fixed point number.

In some embodiments the multiplication module may be a squarer. Said in a different way the multiplication module may be configured to generate said value corresponding to the second preprocessed fixed point number which may be the result, rounded to nearest, of the square of the first preprocessed fixed point number, having the LSD equal to B/2.

When the first preprocessed fixed point number is signed, the squarer may comprise a module arranged to generate the n−1 MSBs of the magnitude (i.e., the value without sign) of the first preprocessed fixed point number. In this case, an unsigned squarer may be used to compute the magnitude of the second preprocessed fixed point number whereas the sign, which is always positive, may be added later. In alternative implementations a signed squarer may be used instead of the magnitude calculator and the unsigned squarer. In other implementations, the first approach may be used to design a combined unsigned/signed squarer.

In some embodiments the multiplication module may be configured to generate said value corresponding to the second preprocessed fixed point number which may be the result, rounded to nearest, of the multiplication of the first preprocessed fixed point number and a fourth preprocessed fixed point number of t+1 digits, having the LSD equal to B/2.

When the fourth preprocessed fixed point number is a constant number, the multiplication module may be a constant multiplier. In this case, said constant number may not be received explicitly. One skilled in the art may appreciate that any optimization technique for implementation of constant multipliers may be applied to the disclosed invention in a straightforward manner.

In some embodiments the at least one arithmetic unit may further comprise at least a second input for receiving the t MSDs of the fourth preprocessed fixed point number.

In some embodiments the multiplication module may comprise a multiplier. The multiplier may be configured to generate the n+t+1 MSBs of the result of the multiplication, since the LSB of said result is always one for preprocessed input numbers. If the multiplication module is a squarer only the 2*n MSB are required to be generated since, also, the second LSB is always zero. The multiplication module may further comprise a truncation module, coupled to the output of the multiplier for receiving the n+t+1 MSBs result and generating the z MSBs of the second number by truncating said output. The LSB of the second preprocessed fixed point number is implicit and equal to one. Again, no additional circuits are required to perform rounding to nearest of the result, such as an adder for rounding up or a sticky calculator.

Since the n+t−z+2 LSBs of the exact result of the multiplication are not required to obtain a correctly rounded second preprocessed fixed point number, the multiplier module may be optimized by avoiding the explicit generation of said n+t−z+2 LSBs. Thus, in some embodiments the multiplication module may comprise a redundant multiplication module arranged to receive, at a first input, the n MSBs of the first preprocessed fixed point numbers and generate, in a redundant representation format, at most the n+t+1 MSDs of a value corresponding to the multiplication operation between said preprocessed number and the fourth preprocessed fixed point number. The LSD of the result of said multiplication is implicit and equal to one. If the multiplication module is a squarer the second LSB is also constant but equal to zero and it may not be generated. The multiplication module may further comprise a conversion module, coupled to the output of said redundant multiplication module, arranged to receive the z MSDs of the output of said redundant multiplication module and a carry bit, and generate a z-bit output corresponding to the conversion of the received redundant value to non-redundant representation format. The multiplication module may further comprise a carry net module arranged to receive the at most n+t+1−z LSDs of the output of said redundant multiplication module and generate said carry bit corresponding to the output carry of the conversion of the n+t+1−z LSDs of the output of said redundant multiplication module to a non-redundant representation.

One skilled in the art may appreciate that the word lengths of the intermediate values of embodiments disclosed herein guarantee the lowest rounding error. However, if a greater error is allowable those sizes may be reduced to simplify the hardware in a straightforward manner. For example, the size of the output of the redundant multiplier may be lower than n+t+1 digits, such that the input of the conversion module may remain the same whereas the input of the carry net module may be reduced accordingly.

One skilled on the art may appreciate that, besides the approach described above, different optimization techniques which may take advantage of the fact that the n+t−z+2 LSBs are not required explicitly, such as truncated multipliers, may be applied to the disclosed invention in a straightforward manner.

In some embodiments the redundant multiplication module may comprise a partial product generator arranged to receive, at a first input, the n MSBs of the first preprocessed number and generate, at an output, the partial products corresponding to the multiplication of said input and the t MSBs of the fourth preprocessed fixed point number. If said fourth preprocessed fixed point number is a constant, said partial product generator may be optimized to generate a reduced set of partial products corresponding to the multiplication of said first input times said constant number without receiving the constant explicitly. If it is not a constant, said partial product generator may be arranged to receive said t MSBs. The redundant multiplication module may further comprise a compressor tree, having a first input coupled to the output of the partial product generator and a second input arranged to receive the n MSBs and the t MSBs of the first and fourth preprocessed numbers, respectively. In an alternative implementation, when the fourth preprocessed number is a constant, said t MSBs may be taken into account within the compressor tree to generate a more optimized circuit. Said compressor tree may be arranged to generate, in a redundant representation, at most the n+t+1 MSDs of a value corresponding to the multiplication operation between said preprocessed numbers at an output. As the LSB of the preprocessed numbers is equal to 1, the partial product generator is not required to generate partial products for said LSBs and they may be considered already generated. They may be directly introduced in the compressor tree (externally or internally) which results in fewer operations and logic for the partial product generator. In an alternative implementation, said LSBs may be considered within the partial product generator and said values may not be introduced at said second input of the compressor tree.

In some embodiments the arithmetic unit may comprise a left shifting module configured to generate a value corresponding to the second preprocessed fixed point number. Said second preprocessed fixed point number may be the result, rounded to nearest, of the left shifting of the first preprocessed fixed point number. Although, the left shifting operation (i.e., the multiplication by a power of the base) for unprocessed fixed-point formats is an exact operation, i.e. the result does not need any rounding, this is not true for preprocessed fixed-point formats. The exact result of left shifting a preprocessed fixed-point number is not a preprocessed number, since its LSD is not equal to B/2. Thus, a rounding operation is required, which at first may not imply any additional operation. However, this rounding may produce some bias introduced by the fact that a rounding up is always performed. In alternative implementations, to avoid said rounding up, the arithmetic unit or the device may be configured to deliver the exact result of the shifting which is an unprocessed number.

In some embodiments the left shifting module may be further arranged to selectively fill the vacant positions, after the left-shifting operation, by setting the MSB of the vacant positions to zero and the rest to one, or by setting the MSB of the vacant positions to one and the rest to zero. This configuration produces a rounding down for the former and a rounding up for the latter.

In some embodiments the left shifting module may be arranged to selectively fill said vacant positions randomly based on the value of a selected bit or of a combination of selected bits. This configuration allows avoiding bias in the rounding. In some embodiments said selected bit (or bits) may be part of the input number, while in other embodiments a new input may be configured.

In some embodiments the left shifting module may be further arranged to receive the shift amount to select the number of bits to shift.

In some embodiments the left shifting module may comprise a barrel shifter arranged to receive a bit for filling the vacant positions.

In some embodiments, the barrel shifter may comprise a number of successive multiplexers that is equal to the first integer greater or equal to the base 2 logarithm of a maximum shift amount [log 2(maximum shift amount)], each multiplexer arranged to perform a left shifting operation that is equal to 2̂i places, iε[0, number of multiplexers−1] and arranged to fill the vacant positions using the value of said received bit.

In some embodiments, at least one arithmetic unit may comprise an absolute value module to generate a value corresponding to the second preprocessed fixed point number. Said second preprocessed fixed point number may be the result of the absolute value of the first preprocessed fixed point number. This operation involves the negation of the input number if it is negative. Since the input number is preprocessed, this negation may be implemented by only inverting all bits but the LSB, and no addition is required. Thus, the absolute value module may comprise a conditional bit inverter arranged to receive, at a first input, the n MSBs of the first preprocessed number. Said conditional bit inverter may generate a value corresponding to the one complement of the first input if its MSB is equal to one.

In some implementations at least one arithmetic unit may comprise an elementary function calculator module to generate a value corresponding to the second preprocessed fixed point number. Said second preprocessed fixed point number may be the result, rounded to nearest, of applying an elementary function to the first preprocessed fixed point number. Said elementary function may be any mathematical function of one variable, such as trigonometric functions, logarithm, exponential, etc. But, one skilled in the art may appreciate that an extension to multivariable functions is straightforward. The elementary function calculator module may comprise a table lookup arranged to receive, at a first input, the n MSDs of the first preprocessed numbers. Said table lookup may be further arranged to store and to deliver the z MSDs of said second preprocessed fixed point number corresponding to each possible input. The LSD of said second preprocessed fixed point number is equal to B/2 and may be implicit. One advantage of this proposal is that the LSB of the output number does not need to be stored or delivered explicitly. Another advantage is that the value stored in the table lookup is exactly rounded to any precision below z+1 Digits, just by truncation.

In some embodiments, the device may further comprise an unprocessed-to-preprocessed fixed point numbers converter coupled at an input of the arithmetic unit configured to receive an unprocessed fixed point number of e+1 bits and generate a preprocessed fixed point number. Introducing such a converter according to embodiments disclosed herein allows a number in an unprocessed fixed-point format to be operated by said arithmetic units functioning in preprocessed fixed point format.

When the preprocessed fixed point number has e+1−k1 bits, with k1<e, then the converter may comprise a rounding unit arranged to remove the k1+1 LSBs of the unprocessed fixed point number to generate the e−k1 MSBs of the preprocessed fixed point number. The LSB of said preprocessed fixed point number is equal to B/2 and is implicit.

In some embodiments the rounding unit may be further arranged to selectively set to zero the second LSB of the preprocessed fixed point number if all of the k1+1 LSBs of the unprocessed fixed point number are equal to zero. This configuration avoids the bias due to rounding.

When the preprocessed fixed point number has e+1+k2 bits then the converter may comprise a filling module, arranged to receive the unprocessed fixed point number and generate the e+k2 MSBs of the preprocessed fixed point number by setting the e+1 MSBs of the preprocessed fixed point number equal to the value of the e+1 bits of the unprocessed fixed point number and the remaining bits to zero. The LSB of the preprocessed fixed point number is equal to one and is implicit.

In some embodiments, the filling module may be further arranged to selectively generate the value corresponding to subtracting one from the second LSB of the said preprocessed fixed point number when a selected bit or a combination of selected bits of the input unprocessed number is equal to one. This configuration avoids the bias due to rounding.

In some embodiments the device may further comprise a preprocessed-to-preprocessed fixed point numbers converter coupled at an input and/or output of the arithmetic unit and configured to receive an initial preprocessed fixed point number of j+1 bits and generate a subsequent preprocessed fixed point number of different size. This may be useful at the input, for example, when an operand is provided to the arithmetic unit with more precision (or with less precision) than needed. Accordingly, if the result of the operation needs to be converted to a number of different size so that it may be used by a subsequent circuit. Therefore, the converter may be placed either before or after the arithmetic unit, accordingly.

When the subsequent preprocessed fixed point number has j+1−p1 bits, p1<J then the converter may comprise a rounding unit for removing the p1+1 LSBs of the J+1 bits of the initial preprocessed number to generate the j−p1 MSBs of the subsequent preprocessed fixed point number. The LSB of the subsequent preprocessed fixed point number is equal to B/2 and is implicit.

When the subsequent preprocessed fixed point number has j+1+p2 bits then the converter may comprise a filling module, arranged to receive the j MSBs of the initial preprocessed fixed point number and generate the j+p2 MSBs of the subsequent preprocessed fixed point number by setting the MSB of the p2 LSBs to one or zero and the remaining p2−1 bits of said p2 LSBs to the complement of said MSB. Depending of the value of said MSB, an effective rounding up or rounding down is produced. The j MSBs of the subsequent preprocessed fixed point number may be the same as the j MSBs of the initial preprocessed fixed point number and is implicit.

In some embodiments the filling module may be further arranged to randomly set said MSB based on the value of a selected bit or on a combination of selected bits. In some implementations, said bit (or bits) may be selected from the initial preprocessed fixed point number.

In some embodiments, the device may further comprise a preprocessed-to-unprocessed fixed point numbers converter, coupled at the output of an arithmetic unit and configured to receive a preprocessed fixed point number of w+1 bits and generate an unprocessed fixed point number. Introducing such a converter according to embodiments disclosed herein allows a preprocessed number generated by said arithmetic unit to be operated by common fixed-point circuits.

When the unprocessed fixed point number has w+1−v1 bits, v1<w, then the converter may comprise a rounding module, arranged to receive the w+2−v1 MSBs of the preprocessed fixed point number and generate the w+1−v1 bits of the unprocessed fixed point number.

In some embodiments, the rounding module may comprise an adder. Said adder may be arranged to receive, at an input, the w+1−v1 MSBs of the preprocessed fixed point number and increment said input value if the w+2−v1th MSB of said preprocessed number is equal to 1. The computation of the sticky bit is not required since the input is a preprocessed number and its LSB is equal to one.

When the unprocessed fixed point number has w+1+v2 bits then the converter may comprise a filling module, arranged to receive the W MSBs of the preprocessed fixed point number and generate the w+v2+1 bits of the unprocessed fixed point number by setting the MSB of the v2+1 LSBs to one and the remaining bits to zero.

In the following embodiments of converters, it is considered that the floating point numbers, both unprocessed and preprocessed, are represented by a sign bit, an exponent and a normalized significand without sign, the MSB being equal to one and explicitly included in the significand representation. However, one skilled in the art may appreciate that other formats with a different representation may be used with minor modifications in the circuits described herein.

In some embodiments the device may further comprise a preprocessed-floating-point-to-preprocessed-fixed-point numbers converter coupled at the input of an arithmetic unit and configured to receive a preprocessed floating point number having a significand of f+2 bits and to generate a preprocessed fixed-point number. Introducing such a converter before an arithmetic unit according to embodiments disclosed herein allows a number in a preprocessed floating point format to be operated by said arithmetic units functioning in preprocessed fixed point format.

When the preprocessed fixed-point number comprises g bits, wherein g<f+4, the preprocessed-floating-point-to-preprocessed-fixed-point numbers converter may comprise a shift amount calculator receiving the exponent of the preprocessed floating point number at an input and generating a shift amount at an output. The converter may further comprise a shifting module having a first input for receiving the g−1 MSBs of the significand of the preprocessed floating point number and a second input coupled to the output of the shift amount calculator and a third input for receiving the sign of said floating point number to generate the g−1 MSBs of preprocessed fixed-point number at an output. The LSB of said preprocessed fixed point number is equal to B/2 and may be implicit.

In some embodiments the shifting module of the preprocessed-floating-point-to-preprocessed-fixed-point numbers converter may comprise an arithmetic right shifter coupled to a conditional bit inverter. In some embodiments the inverter is before the shifting module, in others it may be in the contrary.

When the preprocessed fixed-point number comprises f+c+3 bits, c>0, the preprocessed-floating-point-to-preprocessed-fixed-point numbers converter may comprise a shift amount calculator receiving the exponent of the preprocessed number at an input and generating a shift amount at an output, and an arithmetic right shifting module having a first input coupled to the output of the shift amount calculator and arranged to generate the f+c+2 MSBs of the preprocessed fixed point number by arithmetic right shifting an intermediate f+c+2 bit value. Said intermediate value may have, from left to right, the sign bit, the f+1 MSBs of the significand of the preprocessed floating point number, and the MSB of the c LSBs set to zero and the rest to one or the MSB of the c LSBs set to one and the rest to zero.

In some embodiments, the arithmetic right shifting module may be arranged to randomly set said MSB of the c LSBs of said intermediate f+c+2 bit value based on the value of a selected bit or of a combination of selected bits. In some implementations, said bit (or bits) may be selected from the preprocessed floating point number.

In some embodiments the arithmetic right shifting module may be further arranged to selectively generate the one complement of the result of said shifting operation.

In some embodiments the device may further comprise a preprocessed-fixed-point-to-preprocessed-floating-point numbers converter coupled at an output of an arithmetic unit, and configured to convert a preprocessed q+2-bit fixed-point number to a preprocessed floating point number having a significand of m+2 bits. The preprocessed-fixed-point-to-preprocessed-floating-point numbers converter may comprise a shift amount calculator, an exponent calculator having a first input for receiving a shift amount from the shift amount calculator and an output for generating the exponent of the preprocessed floating point number, and a significand calculator. The significand calculator may comprise a normalization module having a first input for receiving the q MSBs of the q+1 LSBs of the fixed-point number and a second input for receiving the third shift amount. The normalization module may be arranged to left shift the q MSBs according to said shift amount and fill the vacant positions by setting the MSB of the vacant positions to zero and the rest to one or by setting the MSB of the vacant positions to one and the rest to zero to generate the at most m+1 MSBs of the significand. The sign of the preprocessed floating point number may correspond to the MSB of the preprocessed fixed point number. Introducing such a converter after an arithmetic unit according to embodiments disclosed herein allows a number in a preprocessed fixed format generated by it, to be processed by preprocessed FP devices.

In some embodiments the normalization module of the significand calculator may be arranged to randomly fill said vacant positions based on the value of a selected bit or of a combination of selected bits. In some implementations said bit (or bits) may be selected from the fixed point number. In other implementations, a new input may be arranged.

In some embodiments the normalization module of the significand calculator may be further arranged to selectively generate the one complement of the result of said shifting.

In some embodiments the device may further comprise a preprocessed-fixed-point-to-unprocessed-floating-point numbers converter, coupled at an output of an arithmetic unit, and configured to convert a preprocessed h+2 bit fixed-point number to an unprocessed floating point number having a significand of r+1 bits.

In some embodiments said preprocessed-fixed-point-to-unprocessed-floating-point numbers converter may comprise a shift amount calculator, an exponent calculator and a significand calculator. Said exponent calculator may have a first input for receiving a shift amount from the shift amount calculator and an output for generating the exponent of the unprocessed floating point number. The significand calculator may comprise a normalization module having a first input for receiving the h MSBs of the h+1 LSBs of the fixed-point number and a second input for receiving the shift amount. Said normalization module may be arranged to generate a value corresponding to the at most r+2 MSBs of the h+1 LSBs of the fixed point number left shifted according to said shift amount. Said significand calculator may further comprise a rounding module arranged to receive the output of the normalization module and generate the at most r+1 MSBs of the significand of the unprocessed floating point number. The sign of the unprocessed floating point number may correspond to the MSB of the preprocessed fixed point number.

In some embodiments said normalization module may be further arranged to selectively generate the negation of said at most r+2 bit value.

In some embodiments the rounding module may comprise an adder. Said adder may be arrange to receive, at an input, the at most r+1 MSBs of the output of the normalization module and to increment said input value if the LSB of said output is equal to 1.

In some embodiments the device may further comprise an unprocessed-floating-point-to-preprocessed-fixed-point numbers converter, coupled at an input of an arithmetic unit, and configured to convert an unprocessed floating point number having a significand of s bits to a preprocessed fixed-point number of A+2 bits. Introducing such a converter according to embodiments disclosed herein allows a number in a unprocessed floating point format to be operated by said arithmetic units functioning in preprocessed fixed point format.

In some embodiments said unprocessed-floating-point-to-preprocessed-fixed-point numbers converter may comprise a shift amount calculator, receiving the exponent of the unprocessed floating point number at an input and generating shift amount at an output, an unprocessed-to-preprocessed fixed point numbers converter according to embodiments disclosed herein, and a shifting module. Said unprocessed-to-preprocessed fixed point numbers converter may be arranged to receive the at most s bits of the significand of the unprocessed floating point number and to generate the A MSBs of a preprocessed fixed-point number. The shifting module may have a first input for receiving the A bit output of said converter and a second input coupled to the output of the shift amount calculator and a third input for receiving the sign of said floating point number. Said shifting module may be arranged to generate the A+1 MSBs of the output preprocessed fixed-point number by right shifting, according to the second input, the first input augmented to the left with the sign bit. The LSB of said preprocessed fixed point number is equal to B/2 and may be implicit. In some implementations the MSB of the significand of the floating point number may be implicit, since it is always equal to one, and it may not be received explicitly by the converter.

In some embodiments said shifting module may be further arranged to selectively generate a value equal to the one complement of the result of said shifting.

In some embodiments the shifting module may comprise an arithmetic right shifter coupled to a conditional bit inverter. In some embodiments the inverter is before the shifting module, in others it may be in the contrary.

In some embodiments the device may further comprise a third input and/or output for receiving and/or generating the LSD of said first and/or third preprocessed fixed-point numbers. Alternatively, said third input and/or output may have the value of B/2, as the LSD of preprocessed fixed-point numbers is equal to B/2. Therefore, the entire preprocessed number shall be used for the subsequent operations, although it was not necessary to transmit the entire number up to the input and/or output of the device.

In some embodiments, the device may comprise a plurality of arithmetic units and an operation selection input for receiving a desired operation signal. Said device may be configured to select the output of an arithmetic unit from the plurality of arithmetic units based on said received desired operation signal.

### BRIEF DESCRIPTION OF THE DRAWINGS

Particular embodiments of the present invention will be described in the following by way of non-limiting examples, with reference to the appended drawings, in which:

FIG. 1 illustrates the significand data path of a floating point (FP) adder according to an example wherein rounding may produce some bias;

FIG. 1a shows in detail an example of a special conditional bit inverter;

FIG. 2 illustrates another example implementation of the significand data path of a FP adder which eliminates some sources of bias;

FIG. 2a illustrates an example implementation of a special left-shifter;

FIG. 3 illustrates another example implementation of the significand data path of a FP adder which eliminates some sources of bias in a more simplify way;

FIG. 3a illustrates an example implementation of a two's complement adding module;

FIG. 4 illustrates an example implementation of a FP adder which avoids the bias due to rounding;

FIG. 4a illustrates an example implementation of a close rounding module;

FIG. 4b illustrates an example implementation of a far rounding module;

FIG. 5 illustrates the significand data path of a dual-path floating point (FP) adder according to an example;

FIGS. 6 and 6b illustrate the significand data path of a floating point (FP) multiplier according to two examples;

FIG. 7 illustrates a floating point fused multiply-add (FMAD) circuit according to an example

FIG. 8 illustrates a floating point FMAD circuit according to another example which eliminates bias and it is optimized on speed.

FIGS. 9 and 10 illustrate example implementations of the left shifting module of an floating point FMAD circuit;

FIG. 11 shows an example of an arithmetic unit connected to an input converter and an output converter;

FIG. 12 illustrates an example implementation of a preprocessed-fixed-point-to-preprocessed-floating-point numbers converter;

FIG. 13a illustrates an example implementation of a preprocessed left-shifter;

FIG. 14 illustrates an example implementation of an unprocessed-fixed-to-preprocessed-floating-point numbers converter;

FIGS. 14a and 14b illustrate example implementations of the normalization module of an unprocessed-fixed-to-preprocessed-floating-point numbers converter;

FIGS. 15a, 15b and 15c illustrate example implementations of a preprocessed-floating-point-to-preprocessed-floating-point numbers converter;

FIGS. 16, 17a and 17b illustrate example implementations of a preprocessed-floating-point-to-preprocessed-fixed-point numbers converter;

FIG. 18, 19a, 19b illustrate example implementations of the significand data path of a unprocessed-floating-point-to-preprocessed-floating-point numbers converter;

FIG. 20 illustrates an example implementation of a preprocessed-floating-point-to-unprocessed-floating-point numbers converter;

FIG. 20a illustrates an example implementation of the rounding module of a preprocessed-floating-point-to-unprocessed-floating-point numbers converter;

FIG. 21 illustrates an example implementation of a preprocessed-floating-point-to-unprocessed-fixed-point numbers converter;

FIG. 22a, 22b, 22c, 22d y 22e illustrate implementation examples of a fixed point adding module;

FIG. 23 illustrates the implementation of a fixed-point subtractor circuit for preprocessed numbers according to an example;

FIG. 24 illustrates an implementation of a fixed-point adder/subtractor circuit for preprocessed numbers according to an example;

FIG. 25a illustrates an implementation example of a fixed point multiplication module for preprocessed numbers;

FIG. 25b illustrates implementation examples of a fixed point multiplication module for preprocessed numbers;

FIGS. 26a and 26b illustrate implementation examples of a redundant multiplier for preprocessed numbers;

FIG. 27a, 27b y 27c illustrate implementation examples of a fixed point squaring module for preprocessed numbers;

FIG. 28 illustrates the implementation of a redundant squaring module for preprocessed numbers according to an example;

FIG. 29 illustrates an implementation example of a squaring module for preprocessed signed numbers;

FIG. 30a, 30b y 30c illustrate implementation examples of a fixed point constant multiplication module for preprocessed numbers;

FIG. 31 illustrates the implementation of a redundant constant multiplication module for preprocessed numbers according to an example;

FIG. 32 illustrates an implementation example of a left-shifter for preprocessed numbers;

FIG. 33a, 33b y 33c illustrate implementation examples of converters for converting preprocessed fixed-point numbers to preprocessed fixed-point numbers;

FIG. 34 illustrates an implementation example of a converter for converting preprocessed fixed-point numbers to unprocessed fixed-point numbers;

FIG. 35 illustrates an implementation example of a converter for converting preprocessed fixed-point numbers to unprocessed fixed-point numbers by rounding to nearest;

FIG. 36 illustrates an implementation example of a converter for converting preprocessed fixed-point numbers to preprocessed floating-point numbers;

FIG. 37 illustrates an implementation example of a converter for converting preprocessed fixed-point numbers to unprocessed floating-point numbers;

FIG. 38 illustrates an implementation example of a converter for converting unprocessed floating-point numbers to preprocessed fixed-point numbers;

### DETAILED DESCRIPTION OF EMBODIMENTS

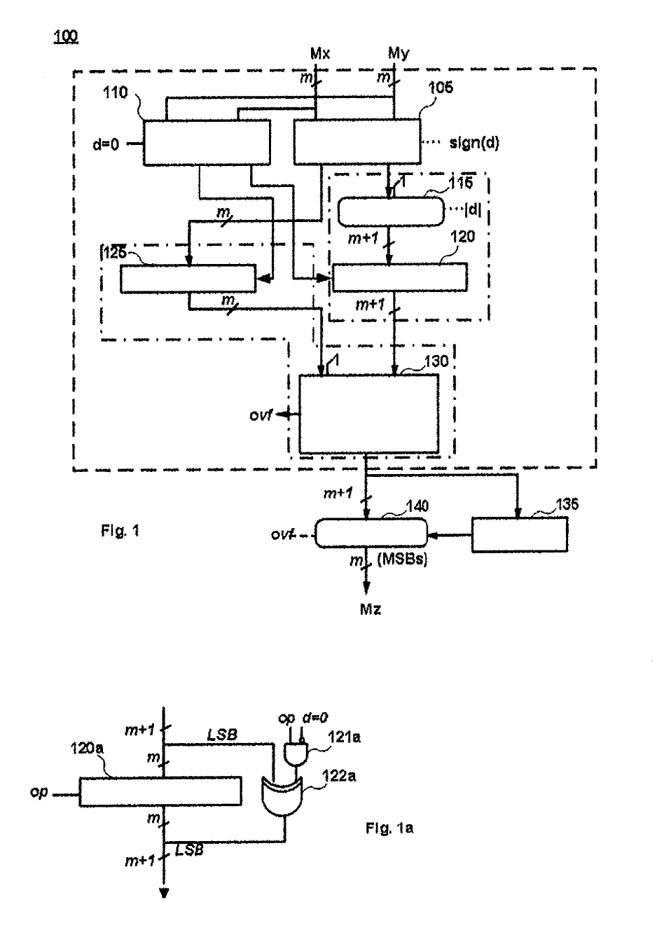

FIG. 1 illustrates the significand data path of a floating point (FP) adder according to an example. The output of the adder 100 illustrated in FIG. 1 is always positive. FP adder 100 receives m bits from a first Significand Mx and from a second Significand My, respectively. Both significands belong to preprocessed floating point numbers. Significands Mx and My both have m+1 digits. However, as both significands pertain to preprocessed numbers, the LSB of both significands is equal to one (1) and does not need to be introduced in the adder at the input. In the example of FIG. 1 the two floating point numbers are normalized. However, to simplify the description, both the MSB of the normalized number and the sign bit are included in the m bits that are introduced in the adder 100. In an alternative implementation, these bits may be introduced after the swap module. FP adder 100 comprises a swap module 105 and a comparator 110, both having a first and second input for receiving the m bits of the significands. The swap module 105 has a first output and a second output and is arranged so that the number with the lower exponent is output at the first output and the number with the higher exponent is output at the second output. Swap module 105 further comprises a third input for receiving the sign of the exponent difference. This shall be calculated by an exponent comparator (not shown). Comparator module 110 further comprises a third input for receiving a control signal in case the numbers have the same exponents and the effective operation is subtraction. The comparator module 110 generates a first control signal at a first output and a second control signal at a second output to instruct a negation of one of the significands when the effective operation is subtraction. As mentioned before, this negation may be implemented by only inverting all bits but the LSB. FP adder 100 further comprises a right shifter 115 having a first input coupled at a first output of swap module 105 and a second input for receiving the shift amount (depicted in FIG. 1 as the absolute value of the difference of the exponents). The first output of swap module 105 carries the m MSBs of the significand with the lowest exponent. The right shifter 115 may further comprise a third input coupled to a logical 1. This introduces the LSB of the significand to the right shifter 115 so that it receives the m+1 bits of the significand. The right shifter 115 shall right shift this m+1 number according to the shift amount received and generate a right shifted m+1 bit number. The right shifter 115 is coupled to a special conditional bit inverter 120. Special conditional bit inverter 120 shall receive the first control signal from the comparator module 110 to carry out a bit-wise inversion of all the m+1 received right shifted bits except if the numbers have the same exponents. In that case the LSB is forced to 1.

FIG. 1a shows in detail the special conditional bit inverter 120. It comprises a standard conditional bit inverter 120a receiving m MSBs of the input and performing a bit-wise inversion of the m bits. The LSB is introduced in a XOR gate 122a along with the output of a two input AND gate 121a that receives the effective operation at the first input and a signal indicating if the exponents are equal at the second input. Therefore the output of the special conditional bit inverter comprises m+1 bits, wherein the LSB of the m+1 bits is the output of the XOR gate 122a.

Accordingly, FP adder further comprises a conditional bit inverter 125 having a first input coupled to a second output of the swap module 105 for receiving the m MSBs of the significand that is not input to the right shifter 115 and a second input coupled to the second output of the comparator module. The conditional bit inverter 125 is a conventional conditional bit inverter with no special cases as the LSB of the significand is not introduced at its input. Now, the conditional bit inverter 125 generates an m bit number. When the effective operation is subtraction and d=0, the comparator module 110 compares the input significands and instructs either the conditional bit inverter 120 or the conditional bit inverter 125 to negate the lower one. If d< >0, the conditional bit inverter 120 always negates the input to perform an effective subtraction. The FP adder 100 further comprises a two's complement adding module 130 having a first input coupled to the output of the conditional bit inverter 125 and a second input coupled to the output of the special conditional bit inverter 120. The first input receives m bits while the second input receives m+1 bits. Therefore, the two's complement adding module 130 further comprises a third input coupled to 1, so that the m bits at the output of the conditional bit inverter 125 are augmented to the right by 1 bit. However, in alternative implementations, the introduction of the additional one may be performed internally to the module 130 without the need for a special input. It is merely illustrated in the example of FIG. 1 and in subsequent examples, to indicate the need for the functional introduction of the implicit LSB. The two's complement adding module 130 performs an addition of the two signed numbers and generates a result at a first output. The two's complement adding module 130 further comprises a second output for generating an overflow bit. The first output of the two's complement adding module 130 is coupled to a leading one detector (LOD) module 135 and to shifter 140. The LOD module 135 is arranged to calculate the number of bits to be left shifted by the shifter 140. In other implementations this module may alternatively be a leading zero anticipator (LZA) or similar circuit. The shifter 140 shifts one position to the right if there is an overflow. Otherwise it shifts as many positions to the left as indicated by the LOD module 135. The shifter 140 generates m MSBs of the significand Mz that is the sum or difference of significands Mx and My after aligning them. The LSB of the significand Mz is implicit and it is equal to 1. Therefore, the rounding to nearest is performed by truncating. However, this rounding produces bias in the aligned addition and in the close path case if left shifting is performed.

It should be noted that in this implementation the m MSBs of the significand include the sign bit and the integer bit. In an alternative implementation, the sign bit may be discarded after the addition, since it is always zero and, similarly, the integer bit may be discarded after normalization, since it is always one.

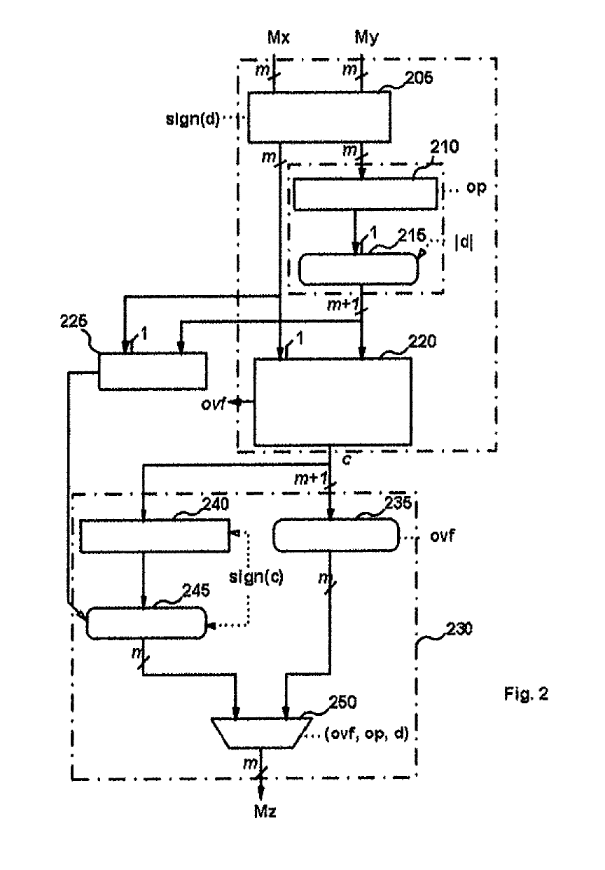

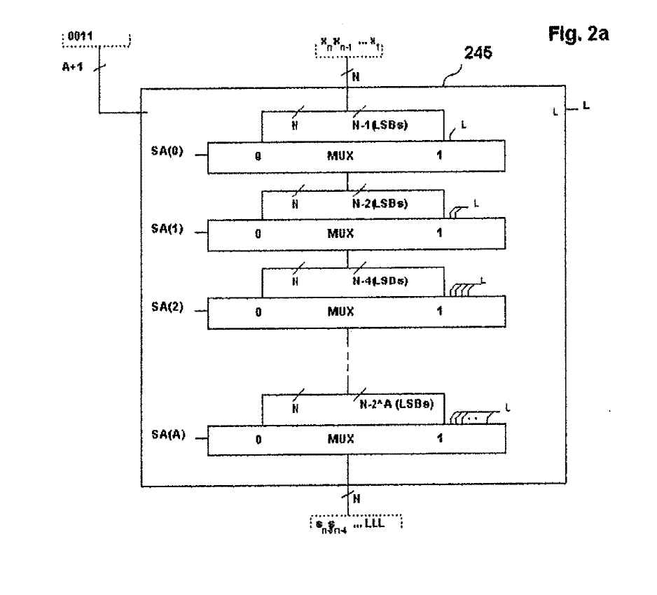

FIG. 2 illustrates the significand data path of a floating point (FP) adder according to another example. In this example, bias is produced due to rounding, only in the close path case if d=1, or if the sum is aligned. In case d=0 and effective subtraction then a “tie to away” rounding takes place. In this example there is no comparator module as in the example of FIG. 1. Therefore the output of the adder may also be negative. FP adder 200 receives m bits from a first Significand Mx and from a second Significand My, respectively. Both significands belong to preprocessed floating point numbers. Significands Mx and My both have m+1 bits. However, again, as both significands pertain to preprocessed numbers, the LSB of both significands is equal to one (1) and does not need to be introduced in the adder at the input. Therefore, again, as in the example of FIG. 1, only m bits from each significand Mx and My are input to FP adder 200. Furthermore, the two floating point numbers are again normalized. Again, to simplify the description, both the MSB of the normalized number and the sign bit are included in the m bits that are introduced in the adder 200, although, in an alternative implementation, they may be introduced just before they are required. FP adder 200 comprises a swap module 205 having a first and second input for receiving the m bits of the significands. Swap module 205, which has a function similar to the swap module 105 of FIG. 1, further comprises a third input for receiving the sign of the exponent difference. This shall be calculated by an exponent comparator (not shown). FP adder further comprises a conditional bit inverter 210 having a first input coupled to a first output of the swap module 205 for receiving the m bits of the significand with the lowest exponent and a second input for receiving a bit indicative of the effective operation (op). Conditional bit inverter 205 shall carry out a bit-wise inversion of the m bits, if the effective operation is a subtraction. FP adder 200 further comprises a right shifter 215 having a first input coupled at an output of the conditional bit inverter and a second input coupled to a logical 1. This introduces the LSB of the significand to the R-shifter so that the right shifter receives the m+1 bits. The right shifter 215 shall right shift this m+1-bit number according to the shift amount received at a third input and generate a right shifted m+1-bit number. The FP adder 200 further comprises a two's complement adding module 220 having a first input coupled to the output of the right shifter 215 and a second input coupled to a second output of the swap module 205. The first input receives m+1 bits while the second input receives m bits. Therefore, the two's complement adding module 220 further comprises a third input coupled to 1, so that the m bits at the second output of the swap module 205 are augmented by 1 bit. Again, in alternative implementations, the introduction of the additional one may be performed internally to the module 220 without the need for a special input. The two's complement adding module 220 performs an addition of the two signed numbers and generates an m+1-bit result at a first output. The two's complement adding module 220 further comprises a second output for generating an overflow bit. The two's complement adding module 220 is coupled to one-position right shifter 235 of normalization module 230. A control input of right shifter 235 is coupled to the second output of the two's complement adding module 220 and a right shift is performed if an overflow occurs. The FP adder 200 further comprises leading zero anticipation (LZA) module 225 having a first input coupled to the second output of swap module 205 and a second input coupled to the output of right shifter 215. The value 1 is also inserted at the input of the LZA module 225 so that the m bits at the second output of swap module 205 are augmented to the right by 1 bit corresponding to the implicit LSB. However, in other implementations the introduction of the additional one may be performed internally to the LZA module 225 without the need for a special input. Now the normalization module 230 further comprises a conditional bit inverter 240 having an input coupled to the first output of two's complement adding module 220 and a special left shifter 245 having a first input coupled at the output of conditional bit inverter 240. A second input of special left shifter 245 is coupled to the output of LZA module 225. The number of bits to be shifted by the special left shifter 245 is provided by the LZA module 225. This is a special shifter in such a way that in a left shift, the vacant positions are filled with a bit that comes from a third input of the special shifter which is coupled to the sign of the result of the two's complement adding module 220. An implementation of the special left-shifter 245 based on the classic barrel shifter implementation is illustrated in FIG. 2a.

The special left-shifter 245, shown in FIG. 2a, is implemented using several two-to-one multiplexors (ceil(log 2 of the maximum amount of shift required)) connected serially, such as the output of one shifter is used in the input of the next one. The data inputs of the first multiplexor are coupled to the first input of the left-shifter, no shifted and shifted one (2̂0) position, respectively, whereas the control bit is coupled to the LSB of the shift amount (second input). The data inputs of the second multiplexor are coupled to output of the first one, no shifted and shifted 2 (2̂1) positions, respectively, whereas the control bit is coupled to the second LSB of the shift amount (second input). The rest of the multiplexor are connected accordingly. In conventional left shifters the vacant position are always filled with zero. In this proposal, the vacant position is filled with the third input (new input L). In this example, the maximum shift amount is m−1. The output of special left shifter 245 comprises the m MSBs of the shifted value. The normalization module 230 further comprises a multiplexer 250 having a first input coupled to the output of right shifter 235 and a second input coupled to the output of special left shifter 245. The output of the multiplexer is either the output of the right shifter 235 or the output of the special left shifter 245 and comprises the m MSBs of the significand Mz that is the sum or difference of significands Mx and My after aligning them. Accordingly, the significand is normalized by the normalization module 230. Again, the LSB of the significand Mz is implicit and it is equal to 1.

It should be noted that in this implementation the m MSBs of the significand include the sign bit and the integer bit. In an alternative implementation, the sign bit may be extracted after the addition and, similarly, the integer bit may be discarded.

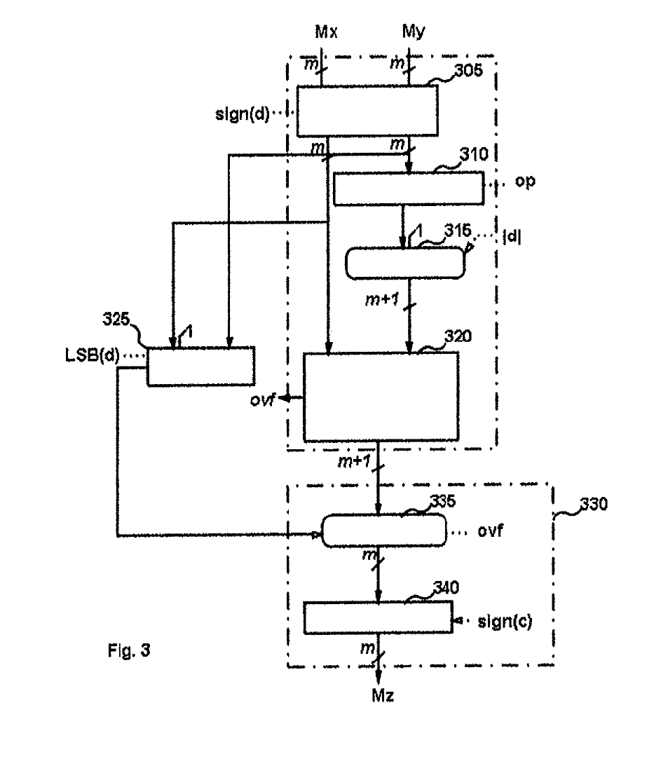

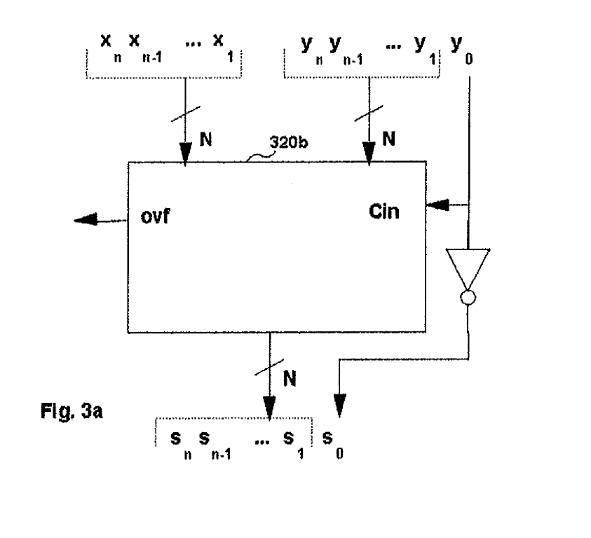

FIG. 3 illustrates the significand data path of a floating point (FP) adder according to yet another example. The example according to FIG. 3 has a different LZA module, a different two's complement adding module and a more simplified normalization module compared with the example according to FIG. 2. FP adder 300 receives m bits from a first Significand Mx and from a second Significand My, respectively. Both significands belong to preprocessed floating point numbers. Significands Mx and My both have m+1 digits. Again, as both significands pertain to preprocessed numbers, the LSB of both significands is equal to one (1) and does not need to be introduced in the adder at the input. Furthermore, the two floating point numbers are also normalized. Again, to simplify the description, both the MSB of the normalized number and the sign bit are included in the m bits that are introduced in the adder 300. Therefore, again, as in the examples of FIGS. 1 and 2, only m bits from each significand Mx and My are input to FP adder 300. FP adder 300 comprises a swap module 305, similar to swap modules 105 and 205, having a first and second input for receiving the m bits of the significands. Swap module 305 further comprises a third input for receiving the sign of the exponent difference. This shall be calculated by an exponent comparator (not shown). FP adder 300 further comprises a conditional bit inverter 310 having a first input coupled to a first output of the swap module 305 for receiving the m bits of the significand with the lowest exponent. Conditional bit inverter 310 shall carry out a bit-wise inversion of the m bits if the effective operation is a subtraction. FP adder 300 also, as in the FP adder of FIG. 2, further comprises a right shifter 315 having a first input coupled at an output of the conditional bit inverter and a second input coupled to a logical 1. The FP adder 300 also further comprises a two's complement adding module 320 having a first input coupled to the output of the right shifter 315 and a second input coupled to a second output of the swap module 305. Similarly to the FP adder of FIG. 2, the first input receives m+1 bits while the second input receives m bits. However, in this example the two's complement adding module 320 may add internally the implicit LSB of the second input. The two's complement adding module 320 performs an addition of the two signed numbers and generates an m+1 bit result at a first output. The two's complement adding module 320 further comprises a second output for generating an overflow bit. An implementation of the two's complement adding module 320 considering the implicit LSB set to one of the second input is illustrated in FIG. 3b. A standard adder 320b of m bits is used to generate the m MSBs of the first output and the overflow signal, whereas the LSB of the first input is coupled to the carry input of said standard adder and it generates the LSB of the first input by inverting it.

The first output of two's complement adding module 320 is coupled to a first input to shifter 335 of normalization module 330. A second input of shifter 335 is coupled to the output of LZA module 325. The FP adder 300 further comprises LZA module 325 having a first and a second input coupled to the first and second output of swap module 305, respectively, and a third input coupled to the LSB of the exponent difference. Similar to the LZA module of FIG. 2, the value 1 is also inserted at the input of the LZA module 325. Again, in other implementations the introduction of the additional one may be performed internally to the LZA module 325 without the need for a special input. Now, the normalization module 330 further comprises a conditional bit inverter 340 having an input coupled to the output of shifter 335. The output of the conditional bit inverter 340 comprises the m bits of the significand Mz that is the sum of significands Mx and My after aligning them. Again, the LSB of significand Mz is implicit, in the same way discussed with reference to FIGS. 1 and 2, as it is equal to 1. Accordingly, the significand is normalized by the normalization module 330.

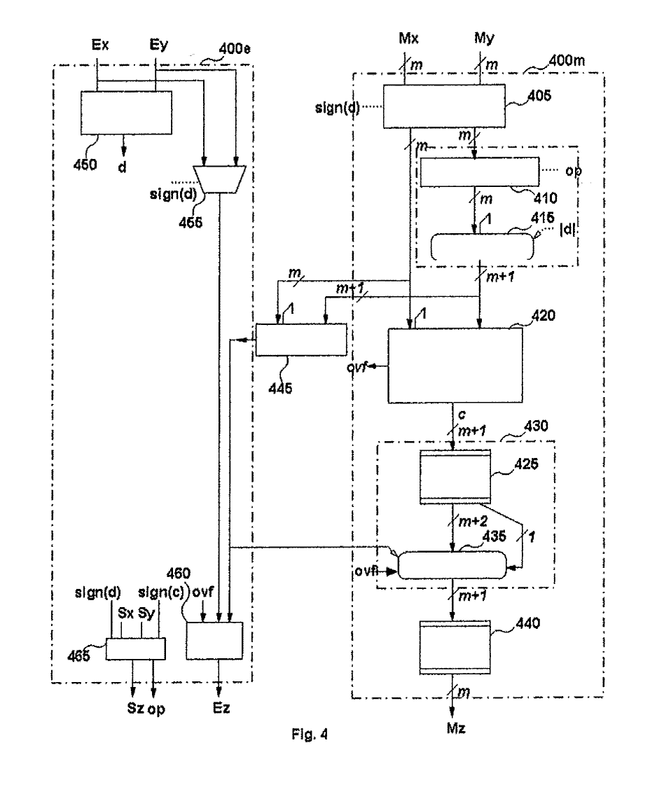

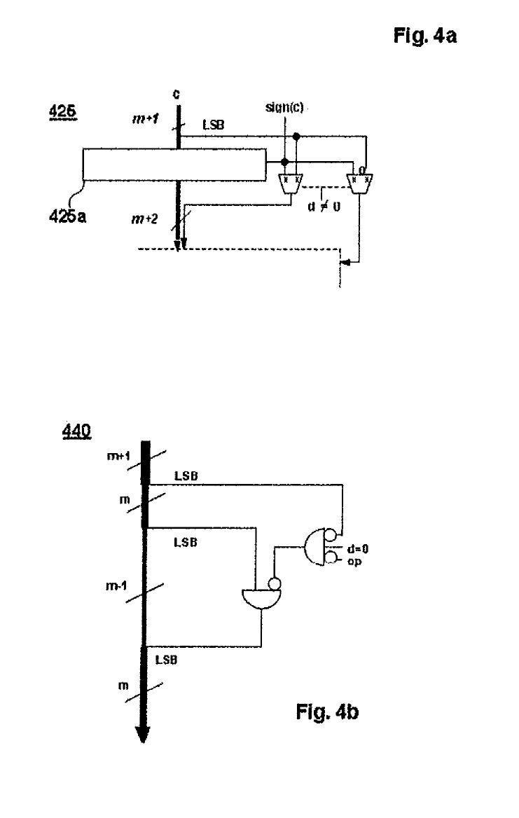

FIG. 4 illustrates a floating point (FP) adder according to an example. The example illustrated in FIG. 4 avoids any sources that may produce bias during rounding. FP adder 400 comprises a significand data path 400m and an exponent data path 400e. The significand data path 400m receives m bits from a first Significand Mx and from a second Significand My, respectively. Both significands belong to preprocessed floating point numbers. Significands Mx and My both have m+1 digits. Again, as both significands pertain to preprocessed numbers, the LSB of both significands is equal to one (1) and does not need to be introduced in the adder at the input. Therefore, again, as in the examples of FIGS. 1 and 2, only m bits from each significand Mx and My are input to significand data path 400m. Furthermore, the two floating point numbers are also normalized. Again, to simplify the description, both the MSB of the normalized number and the sign bit are included in the m bits that are introduced in the adder 400. Significand data path 400m comprises a swap module 405, similar to swap modules 105, 205 and 305, having a first and second input for receiving the m bits of the significands. Swap module 405 further comprises a third input for receiving the sign of the exponent difference. This shall be calculated by the exponent data path 400e. Significand data path 400m further comprises a conditional bit inverter 410 having a first input coupled at a first output of swap module 405 for receiving the m bits of the significand with the lowest exponent. The conditional bit inverter 410 shall carry out a bit-wise inversion of the m bits if the effective operation is a subtraction. The conditional bit inverter 410 has a second input for receiving a control bit indicating the effective operation. The significand data path 400m further comprises a right shifter 415 having a first input coupled to the output of conditional bit inverter 410 and a second input for receiving the shift amount (|d|). The right shifter 415 may further comprise a third input coupled to a logical 1. The right shifter 415 shall right shift this m+1 number according to the shift amount received and generate a right shifted m+1 bit number. The significand data path 400m also further comprises a two's complement adding module 420 having a first input coupled to the output of the right shifter 415 and a second input coupled to a second output of the swap module 405. Similarly to the FP adder of FIGS. 1, 2 and 3, the first input receives m+1 bits while the second input receives m bits. Therefore, the two's complement adding module 420 further comprises a third input coupled to 1, so that the m bits at the output of the swap module 405 are augmented by 1 bit. The two's complement adding module 420 performs an addition of the two signed numbers and generates an m+1 bit result at a first output. The two's complement adding module 420 further comprises a second output for generating an overflow bit.

The first output of two's complement adding module 420 is coupled to a first input of close rounding module 425 of normalization module 430. The normalization module 430 further comprises a special shifting module 435 having a first input coupled to the first output of close rounding module 425 for receiving m+2 bits. This is a special shifter in such a way that in a left shift of the first input, the vacant positions are filled with a third input which is coupled to a second output of close rounding module 425 for receiving 1 bit. The close rounding module 425 provides the adequate values to the special shifter module 435 to obtain correctly rounded and no biased results after normalization if the effective operation is a subtraction and the difference of exponents is less or equal to one (op=1,d={0,1}, close path case). FIG. 4a shows the close rounding module 425 in detail. The conditional bit inverter module 425a performs a bit-wise inversion of the m+1 input bits if the output of the adding module 420, is negative, i.e., the MSB of the input is equal to one (sign(c)=1). Otherwise the output of the conditional bit inverter module 425a, which produces the m+1 MSBs of the first output of the close rounding module 425, is equal to the input. Furthermore, the close rounding module 425 comprises logic that is arranged such that, if the operands have the same exponent (d=0), then the LSB of the first output and the second output of the close rounding module 425 are equal to the sign of the output of the adding module 420. If the exponents are different, this LSB of the first output is equal to the LSB of the output of the adding module 420 and the second output is equal to its inverse. However, when not in a close path case, then these two bits do not affect the output of the normalization module 430, as no left shifting greater than 1 position shall take place. In alternative implementations, the LSB of the first output may be any bit or combination of bits with adequate random characteristics, and the second output, its inverse.

The shifting module 435 provides an m+1-bit output corresponding to the MSBs of the first input (m+2 bits) after shifting it one bit to the right (overflow) or shifting it to the left according to the second input, which is coupled to the output of LZA module 445. The FP adder 400 further comprises LZA module 445 having a first input coupled to the second output of swap module 405 and a second input coupled to the output of right shifter 415. Similar to the LZA module of FIG. 2, the value 1 is also inserted at the input of the LZA module 445, to augment the second output value of the swap module 405 by one bit. Again, in other implementations the introduction of the additional one may be performed internally to the LZA module 445 without the need for a special input.

The significand data path 400m further comprises a far rounding module 440 having an input coupled to the output of the shifting module 435. The far rounding module 440 prevents rounding with bias in the aligned sum. The far rounding module 440 provides a m-bit bus at the output from a m+1-bit at the input. FIG. 4b illustrates in detail the far rounding module 440. The output is equal to the m+1 MSBs of the input, except if the effective operation is an addition (op=0), the exponent are equal (d=0) and the LSB of the input is zero. In this case, the LSB of the output is set to zero. The output of far rounding module 440 comprises the m bits of the significand Mz that is the sum or difference of significands Mx and My after aligning them. The LSB of significand Mz is implicit, in the same way discussed with reference to FIGS. 1, 2 and 3, as it is equal to 1. Accordingly, the significand is normalized by the normalization module 430.

The exponent data path comprises an exponent difference module 450 having a first input for receiving the first exponent Ex and a second input for receiving the second exponent Ey and generating, at an output, a value representing the difference of the exponents d. This value includes information relevant to the sign of the difference and the magnitude of the difference. A multiplexer 455 receives the exponents at a first and second input, respectively, and the sign of the difference of the exponents at a third input. The exponent data path further comprises an exponent update module 460 having a first input receiving the output of multiplexer 455, a second input receiving the output of LZA module 445 and a third input receiving the overflow bit from two's complement adder 420. The exponent update module generates the exponent Ez of the result of the effective operation. Further, a sign module 465 receives the sign bits Sx and Sy of the operands, the sign of the difference of the exponents (sign(d)) and the sign (sign(c)) of the difference of the significands, and generates the bit indicative of the effective operation (op) and the sign bit Sz of the result of the FP operation.

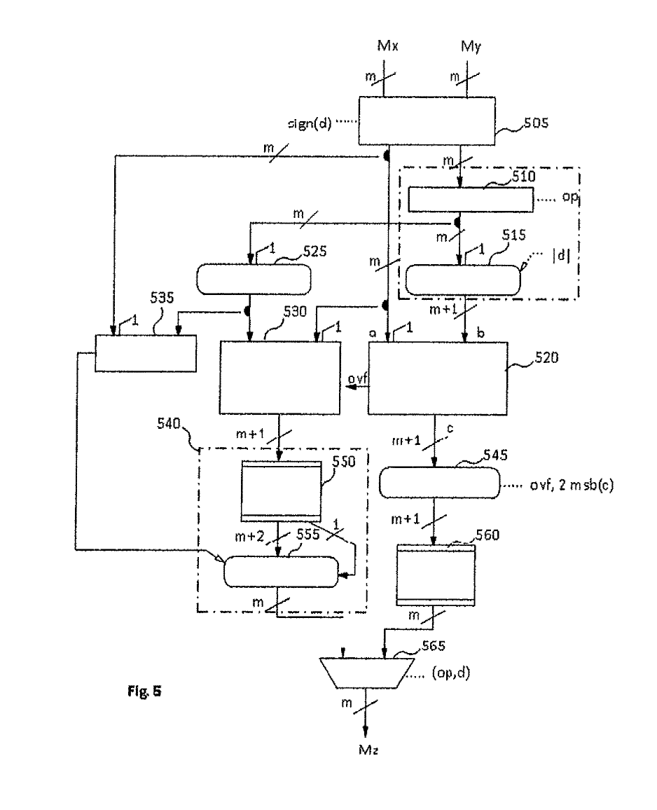

FIG. 5 illustrates the significand data path of a FP adder with a double path according to an example. The example illustrated in FIG. 5 avoids any sources that may produce bias during rounding. FP adder 500 receives m bits from a first Significand Mx and from a second Significand My, respectively. Both significands belong to preprocessed floating point numbers. Significands Mx and My both have m+1 bits. However, again, as both significands pertain to preprocessed numbers, the LSB of both significands is equal to one (1) and does not need to be introduced in the adder at the input. Therefore, again, as in the example of FIG. 1, only m bits from each significand Mx and My are input to FP adder 500. Furthermore, the two floating point numbers are again normalized. Again, to simplify the description, both the MSB of the normalized number and the sign bit are included in the m bits that are introduced in the adder 500. FP adder 500 comprises a swap module 505 having a first and second input for receiving the m bits of the significands. Swap module 505 further comprises a third input for receiving the sign of the exponent difference.

FP adder 500 further comprises conditional bit inverter 510 having a first input coupled at a first output of swap module 505 for receiving the m bits of the significand with the lowest exponent. The conditional bit inverter 510 shall carry out a bit-wise inversion of the m bits if the effective operation is a subtraction. The conditional bit inverter 510 has a second input for receiving a control bit indicating the effective operation. The FP adder 500 further comprises a right shifter 515 having a first input coupled to the output of conditional bit inverter 510 and a second input for receiving the shift amount (|d|). The right shifter 515 may further comprise a third input coupled to a logical 1 to receive the LSB of the significand. The right shifter 515 shall right shift this m+1 significand according to the shift amount received and generate a right shifted m+1 bit number. The FP adder 500 also further comprises a two's complement adding module 520 having a first input coupled to the output of the right shifter 515 and a second input coupled to a second output of the swap module 505. Similarly to the two's complement adding modules of FIGS. 1, 2, 3 and 4, the first input receives m+1 bits while the second input receives m bits. Therefore, the two's complement adding module 520 further comprises a third input coupled to 1, so that the m bits at the output of the swap module 505 are augmented by 1 bit. The two's complement adding module 520 performs an addition of the two signed numbers and generates an m+1 bit result at a first output. The two's complement adding module 520 further comprises a second output for generating an overflow bit.

The FP adder 500 further comprises a second right shifter 525 having a first input coupled to the output of conditional bit inverter 510. The second right shifter 525 further comprises a second input coupled to a logical 1, so that the m bits at the output of the conditional bit inverter 510 are augmented by 1 bit. The second right shifter 525 shall right shift at most one position this m+1 number generating a right shifted m+1 bit number.

The FP adder 500 further comprises a second two's complement adding module 530 having a first input coupled to the output of second right shifter 525 and a second input coupled to the second output of swap module 505. Similarly to the adding module 520, the first input receives m+1 bits while the second input receives m bits. Therefore, the second two's complement adding module 530 further comprises a third input coupled to 1, so that the m bits at the output of the swap module 505 are augmented by 1 bit. The two's complement adding module 530 performs an addition of the two signed numbers and generates an m+1 bit result at an output.

The output of two's complement adding module 530 is coupled to a first input of close rounding module 550 of normalization module 540.

The normalization module 540 further comprises a special left shifter 555. The special left shifter is equal to the one described with reference to FIG. 2. A first and a third input of left shifter 555 are coupled to the first and second output of close rounding module 550, respectively, while a second input of left shifter 555 is coupled to the output of LZA module 535. The close rounding module 550 provides the adequate values to the special left shifter 555 to obtain correctly rounded and no biased results after normalization if the effective operation is a subtraction and the difference of exponents is less or equal to one (op=1,d={0,1}, close path case). Furthermore, the close rounding module 550 comprises logic that is arranged such that, if the operands have the same exponent (d=0), then the LSB of the first output and the second output of the close rounding module 550 are equal to the sign of the output of the adding module 530. If the exponents are different, this LSB of the first output is equal to the LSB of the output of the adding module 530 and the second output equal to its inverse. The FP adder 500 further comprises LZA module 535 having a first input coupled to the second output of swap module 505 and a second input coupled to the output of right shifter 525. Similar to previous LZA modules, the value 1 is also inserted at the input of the LZA module 535, to augment the second output value of the swap module 505 by one bit. Again, in other implementations the introduction of the additional one may be performed internally to the LZA module 535 without the need for a special input.

The m-bit output of special left shifter 555, which is the output of normalization module 540, is introduced as a first input in multiplexer 565. The second input of multiplexer 565 is coupled to the output of far rounding module 560. Far rounding unit 560 is coupled to the m+1 bit output of shifting module 545 which, in turn, has an input coupled to the output of two's complement adding module 520. The shifting module 545 produces a right or left shifting of maximum one position to normalize the result of the far path. The far rounding unit 560 is equal to the one described with reference to FIG. 4b.

The multiplexer 565 receives the effective operation and the difference of the exponents and generates the m bits of the significand Mz that is the sum or difference of significands Mx and My after aligning them. The LSB of significand Mz is implicit, in the same way discussed with reference to FIGS. 1, 2, 3 and 4, as it is equal to 1. Accordingly, the significand is normalized by the normalization module 540. The multiplexer 565 selects either the close path, if the effective operation is subtraction and the difference of exponents is less than 2, op=1,d<2, or the far path in the rest of the cases.

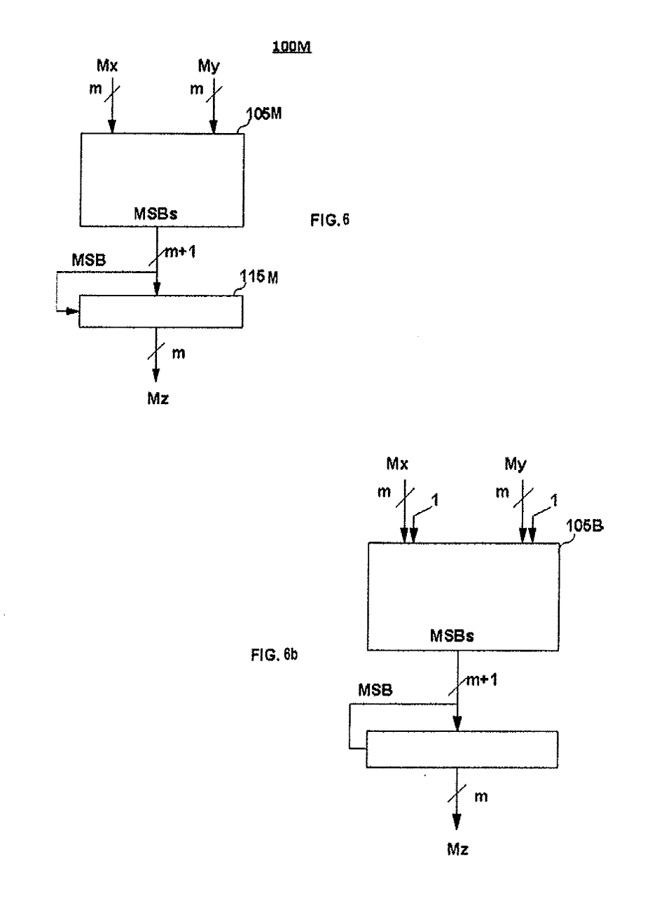

FIG. 6 illustrates the significand data path of a floating point (FP) multiplier according to an example. FP multiplier 100M receives m bits from a first Significand Mx and from a second Significand My, respectively. Both significands belong to preprocessed floating point numbers. Significands Mx and My both have m+1 bits. However, as both significands pertain to preprocessed numbers, the LSB of both significands is equal to one (1) and does not need to be introduced in the FP multiplier at the input. Furthermore, in the example of FIG. 6 the two floating point numbers are normalized. However, to simplify the description, the MSB of the normalized number, the integer bit, is included in the m bits that are introduced in the FP multiplier 100M. In an alternative implementation, this bit may be introduced either before the fixed point multiplier or internally to said fixed point multiplier. FP multiplier 100M comprises a fixed point multiplier 105M and a normalization module 115M. Normalization module 115M may be a one position right shifter. The fixed point multiplier 105M receives the m MSBs of the significands Mx and My. Fixed point multiplier 105M multiplies the significands and generates the m+1 MSBs of the result of said multiplication. Then, the normalisation module 115M displaces said result one position to the right if the MSB of said result is equal to one. The output of the normalisation module 115M is an m-bit number that corresponds to the m MSBs of the m+1 bit significand of the FP result of the multiplication of the FP input numbers. In the example of FIG. 6 the LSB of the input significands is implicit and is introduced within the fixed point multiplier. Alternatively, it may be introduced as a separate input of the fixed point multiplier, as shown in the fixed point multiplier 105b of FIG. 6b. The LSB of the significand Mz is implicit and it is equal to 1.

It should be noted that in this implementation the m MSBs of the significand include the integer bit. In an alternative implementation, the integer bit of the output significand may be discarded after normalization, since it is always one.

Implementation examples of fixed point multipliers are commented later in the text.

FIG. 7 illustrates a floating point fused multiply-add (FMAD) circuit according to an example. FMAD 100F receives three preprocessed floating point numbers X, Y and Z, and generates a result S that is the sum of the third floating point number with the product of the other two (S=Z+X*Y). The LSB of the significands is equal to 1. FMAD 100F comprises an exponent data path 105F and a significand data path 110F. The exponent data path 105F comprises an exponent logic 107F for receiving the exponents Ex, Ey and Ez of the three FP numbers and generates an intermediate exponent number at an output, according to the maximum value between Ez and Ex+Ey. The output of the exponent logic 107F is coupled to a first input of exponent update module 109F. A second input of exponent update module 109F is coupled to the significand data path 110F for receiving the number of leading zeros of the result of the addition operation or the number of the leading ones if said result is negative. A third input is coupled to the significand data path 110F for receiving an overflow (ovf) bit. In an alternative implementation, the two last inputs, i.e. the number of leading non-significant bits and the overflow bit, could be combined in only one value. The exponent update module 109F is configured to generate the exponent Es of the floating point number S by increasing or decreasing the intermediate exponent value according to the number of leading non-significant bits and the overflow signal. Besides, a sign logic circuit, (not shown), computes the effective operation signal (op) for the final sum and the sign of the result in a standard way based on the sign of the inputs and the sign of the result of the final sum.

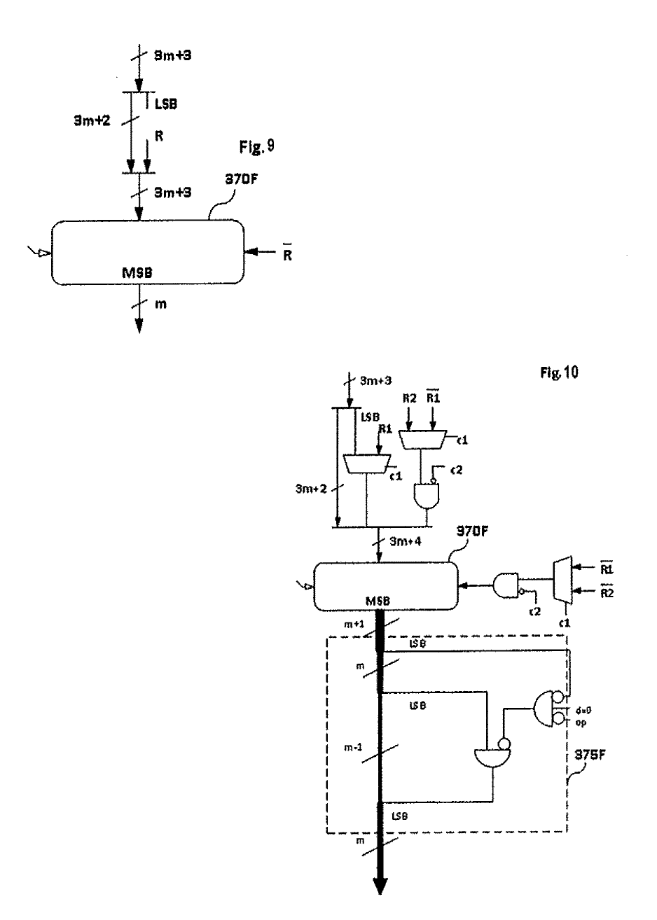

The significand data path 110F comprises a multiplication module 115F for receiving the m MSBs of the significands of the preprocessed FP numbers X and Y. The significands are represented by symbols Mx and My in FIG. 7. Significands Mx and My (as well as Mz) both have m+1 bits. However, as both significands pertain to preprocessed numbers, the LSB of both significands is equal to one (1) and does not need to be introduced in the FMAD at the input. Furthermore, in the example of FIG. 7 the three floating point numbers are normalized. However, to simplify the description, the MSB of the normalized number, the integer bit, is included in the m bits that are introduced in the FMAD 100F. In an alternative implementation, this bit may be omitted at the inputs and introduced either before the multiplication module 115F or internally to said multiplication module 115F for Mx and My, and either before the first shifting module 120F or internally to said module for Mz. In the example of FIG. 7 the LSB of the input significands is introduced as a separate input of the multiplication module 115F. Alternatively, it may be implicit and be introduced within the multiplication module 115F. It is merely illustrated in the example of FIG. 9 and in other subsequent examples, to indicate the need for the functional introduction of the implicit LSB. The multiplication module 115F receives the m MSBs of the significands Mx and My and generates the 2*m+1 MSBs of the product of the significands of X and Y (including their implicit LSB) at an output value. The LSB of said product is always one and it is not required explicitly. Said in a different way, if the m MSBs of Mx are represented by A, and the m MSBs of My are represented by B, then the 2*m+1 bit value at the output is equal to A*B+1/2A+1/2B.

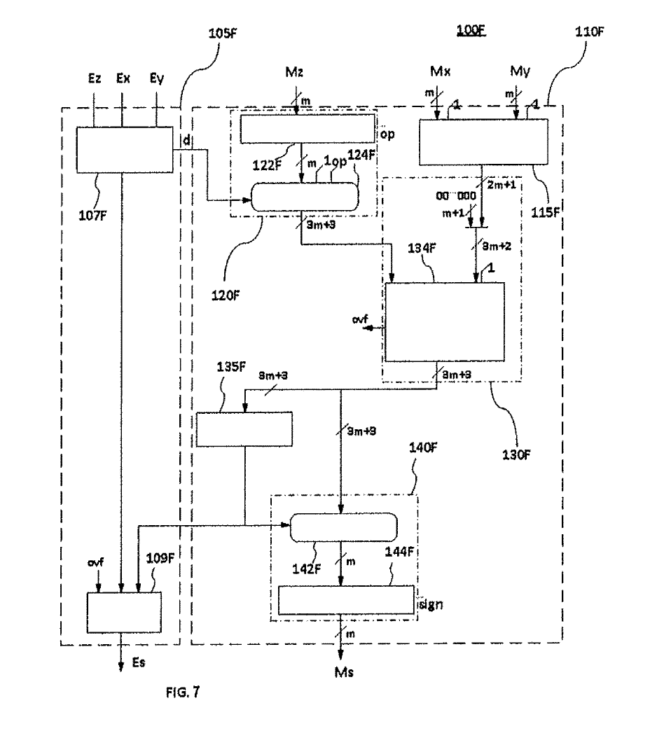

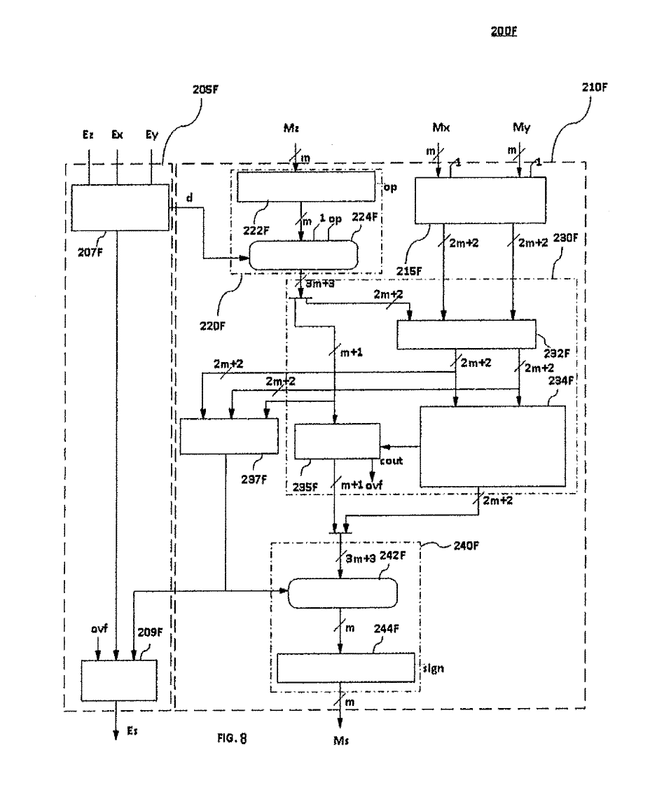

FIG. 8 illustrates a floating point (FP) fused multiply-add (FMAD) circuit according to another example configured to eliminate the bias for rounding and to improve the speed of the significant data path. FMAD 200F receives three preprocessed floating point numbers X, Y and Z, and generates a result S that is the sum of the third floating point with the product of the other two (S=Z+X*Y). The LSB of the significands is equal to 1. FMAD 200F comprises an exponent data path 205F and a significand data path 210F. The exponent data path 205F is similar to the exponent data path 105F discussed with reference to FIG. 1. The exponent data path 205F comprises an exponent logic 207F for receiving the exponents Ex, Ey and Ez of the three FP numbers and generates an intermediate exponent number at an output, according to the maximum value between Ez and Ex+Ey. The output of the exponent logic 207F is coupled to a first input of exponent update module 209F. A second input of exponent update module 209F is coupled to the significand data path 210F for receiving the number of leading zeros of the result of the addition operation (or the number of the leading ones, if said result is negative). A third input is coupled to the significand data path 210F for receiving an overflow (ovf) bit. Similarly to the previous example, in an alternative implementation, the two last inputs, i.e. the number of leading zeros and the overflow bit, could be combined in only one value. The exponent update module 209F is configured to generate the exponent Es of the floating point number S by increasing or decreasing the intermediate exponent number according to the number of leading non-significant bits and the overflow signal. Besides, a sign logic circuit, (not shown), computes the effective operation signal (op) for the final sum and the sign of the result in a standard way based on the sign of the inputs and the sign of the result of the final sum.

The significand data path 210F comprises a multiplication module 215F for receiving the m MSBs of the significands of the preprocessed numbers X and Y. Again, the significands are represented by symbols Mx and My in FIG. 8. The significands Mx and My (as well as Mz) both have m+1 bits. However, as both significands pertain to preprocessed numbers, the LSB of both significands is equal to one (1) and does not need to be introduced in the FMAD at the input. Furthermore, as in the example of FIG. 7, the three floating point numbers are normalized. However, to simplify the description, the MSB of the normalized number, the integer bit, is included in the m bits that are introduced in the FMAD 200F. In an alternative implementation, this bit may be omitted at the inputs and introduced either before the multiplication module 215F or internally to said multiplication module 215F for Mx and My, and either before the first shifting module 220F or internally to said module for Mz. In the example of FIG. 8 the LSB of the input significands is introduced as a separate input of the multiplication module 215F. Alternatively, it may be implicit and be introduced within the multiplication module 215F. The multiplication module 215F receives the m MSBs of the significands Mx and My and generates, in a redundant representation format, the 2+m+2 corresponding to the multiplication operation between said X and Y significands (including their implicit bit). The LSD of said value is always one but, although it is not required explicitly and it could be omitted as in the example of, FIG. 7, it is included in the output signal of this example to show different alternatives. The multiplication module 215F shown in FIG. 8 generates the result in carry-save format and then said result is delivered at a first and a second 2*m+2 bit outputs, corresponding to the sum word and carry word respectively. However, one skilled in the art may appreciate that other redundant representation formats may be used with minor modifications to the disclosed circuits, such as signed digit representations. The outputs of the multiplication module 215F are coupled to adding module 230F.

In a parallel path, the m MSBs of the significand Mz of the third preprocessed number is input to first shifting module 220F that is configured to align Mz so that it can be added to the result of the multiplication. First shifting module 220F comprises a conditional bit inverter 222F that is controlled by the bit op, and an arithmetic right shifter 224F. This bit op indicates the effective operation, which depends on the sign of the input floating point numbers (XOR of the three input signs). The m-bit output of conditional bit inverter 222F, augmented to the left with the op bit as its sign bit and to the right with the LSB of Mz, is input to the arithmetic right shifter 224F. Again, the right arithmetic shifter 224F is controlled by an output of the exponent logic 207F that indicates the difference (d) of the exponent of Z and the sum of the other two exponents. The output of the first shifting module 220F is a 3*m+3 bit number and is coupled to adding module 230F. At first, said number should have 3*m+4 bits to cover all displacement cases with minimum error. However, the sign bit (MSB of the shifted value) is omitted and its second MSB is used instead, since both bits are equal, except if no shifting is performed. In this last case, no addition is really performed, since no shifting means that the two numbers are too distant (Ez>>Ex+Ey and more specifically Ez>Ex+Ey+m+1). Thus, the sign of the result of the addition is not its MSB, but the bit to indicate the effective operation (op). In an alternative implementation, the inversion in both conditional inverters 222F and 244F may be prevented when this situation (Ez>Ex+Ey+m+1) is produced, and, concordantly, the sign may always be positive in this situation. In another alternative implementations, the sign of the result of the addition may be always its MSB and the overflow signal may be avoided if 3*m+4 bits are used for representing the aligned significant and the result of the addition.

The adding module 230F generates, in a non-redundant representation, the addition between the redundant output of the multiplication module 215F and the aligned output of the first shifting module 220F. In this particular example, since carry-save is used as redundant representation, the adding module 230F comprises a 3:2 counter 232F to add the two outputs of the multiplication module 215F and the 2*m+2 LSBs of the output of the first shifting module 220F. The 3:2 counter 232F generates two 2*m+2 bit words as a carry-save output. The adding module 230F further comprises a two's complement adder 234F couples to the output of the 3:2 counter 232F and an incrementing module 235F, having a first input for receiving the m+1 MSBs of the output of the first shifting module 220F and a second input for receiving a carry out bit from the two's complement adder 234F, to produce a significand in a non-redundant representation. In an alternative implementation, both modules may be substituted by a 3*m+3 bit two's complement adder having the m+1 MSBs of one of its inputs couple to zero, or a different circuit if the redundant representation selected is other. The m+1 bit output of the incrementing module 235F and the 2*m+2 output of the two's complement adder 234F comprise a 3*m+3 bit number that corresponds to the significand of result of the fused multiply-add operation before normalization. Said 3*m+3 bit number is input to a normalization module 240F. The incrementing module 235F further produces an overflow bit at a second output. In other implementations, the overflow information may be obtained from the output of a Leading Zero Anticipator (LZA), and this explicit output may not be required.

The significand data path 210F further comprises a Leading Zero Anticipator (LZA) 237F having a first input coupled to the output of 3:2 counter 232F and a second input for receiving the m+1 MSBs of the output of the first shifting module 220F. LZA 237F also receive an instruction (not shown in the figure) about the effective operation when no shifting is performed in the first shifting module. LZA 237F calculates the required left shift to normalize the result. In an alternative implementation, the LZA may take the inputs directly from the outputs of the multiplication module 215F and the first shifting module 220F or at a later stage from the output of the adding module 230F.

One skilled in the art may appreciate that the adding module 230F and the LZA 237F may be implemented (together or separately) in many different ways without departing from the scope of the invention.

The normalization module 240F comprises a left shifting module 242F and a conditional bit inverter 244F. The left shifting module 242F receives the 3*m+3 number from the adding module 230F at a first input and generates an m+1 bit normalized and rounded preprocessed number, having the LSB implicit and equal to one. It performs this operation based on a second shift amount received from the LZA 237F at a second input. The m MSBs of said preprocessed number is then input to conditional bit inverter 244F to negate it if its MSB is zero. This last indicates a negative result of the addition, since said MSB is the integer bit and it should be one (normalized number). One skilled in the art may appreciate that different options to detect a negative result of the addition may be used. On the other hand, in an alternative implementation, the conditional bit inverter may be before the left shifting module. The m-bit output of the conditional inverter 244F corresponds to the m MSBs of the preprocessed significand of the final result of the FMAD operation. The LSB of said preprocessed significand is implicit and it is equal to 1. It should be noted that in this implementation the m MSBs of the significand include the integer bit which is always one. Therefore, in an alternative implementation, the integer bit may be discarded after the normalization.

FIG. 9 y 10 illustrate different alternative implementation of the left shifting module 242F according to other examples. The left shifting module 242F allows avoiding of the bias produced by rounding in certain cases when a standard left shifter is used, as in the example of FIG. 7. The left shifting module represented in FIG. 9 comprises a special left shifter 370F having a first input coupled to the first input of left shifting module 242F. However, the LSB is coupled to a random bit. A second input of special left shifter 370F is coupled to the shift amount from the second input of the left shifting module 242F. This is a special shifter in such a way that in a left shift, the vacant positions are filled with a bit that comes from a third input of the special shifter which is coupled to the inverse of said random bit. The random bit may be any selected bit or the result of the combination of several selected bits of the first input or any other bit with adequate statistical characteristics. The output of special left shifter 370F comprises the m MSBs of the shifted value, which is the output of the left shifting module 242F. This example of implementation of the left shifting module 242F avoids the bias produced in a FMAD operation, as in the example of FIG. 7, when the shift amount (number of non-significant leading bits) is greater than 2*m+3 (when an effective subtraction operation produces a cancellation). In an alternative implementation, since the LSB of the first input is discarded, this bit may not be generated at the output of the adding module 230F.

FIG. 11 shows an example of device according to embodiments disclosed herein. The device 100 comprises an arithmetic unit 100C configured to process preprocessed floating point numbers and generated preprocessed floating point numbers. An input converter 110C is coupled at the input of said device. The input converter 110C is configured to convert an input number to a first preprocessed floating point number. Accordingly, the device comprises an output converter 120C coupled at the output of the arithmetic unit 100C and configured to receive a second preprocessed floating point number and generate an output number. Said input and output numbers may be unprocessed or preprocessed numbers, either fixed point or floating point. Furthermore, the converter 110C and/or the converter 120c may be internal to arithmetic unit 100C. In other implementations only one converter may be present at the input or at the output of arithmetic unit 100C. In yet other implementations the device may comprise a plurality of converters at the input and/or at the output of said arithmetic unit 100C for converting, e.g. in parallel, a plurality of input numbers, respectively.

The FP arithmetic units described above require FP numbers that have been preprocessed according to the invention as described also above. These preprocessed numbers may be generated by circuits, such as the aforementioned FP adders, that are designed to function with preprocessed numbers or they may be generated by converters, designed to convert unprocessed numbers or preprocessed non-FP numbers to preprocessed numbers. Furthermore, the preprocessed numbers generated by the adders described above may, accordingly, require converters so that the numbers generated may be used by circuits that are not designed to process preprocessed numbers.

In the following examples, it is considered that floating point numbers, both unprocessed and preprocessed) are represented by a sign bit, an exponent, and a unsigned normalized significand such as the MSB is equal to one and it is explicitly included in the significand representation. In the same way, fixed point numbers, both unprocessed and preprocessed, are represented in two's complement representation, being the MSB equivalent to the sign bit. However, one skilled in the art may appreciate that other formats having a different representation may be used with minor modifications to the disclosed circuits. Some of these variations may be:

### a) in FP:

implicit representation of the MSB of the significand, or
fused representation of sign and significand by two's complement representation or any other representation
   b) in fixed point: sign-and-magnitude representation, or natural representation

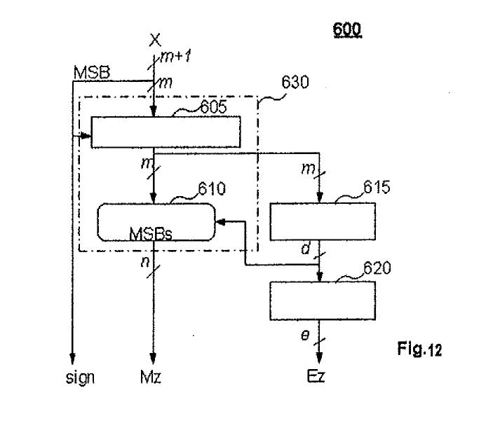

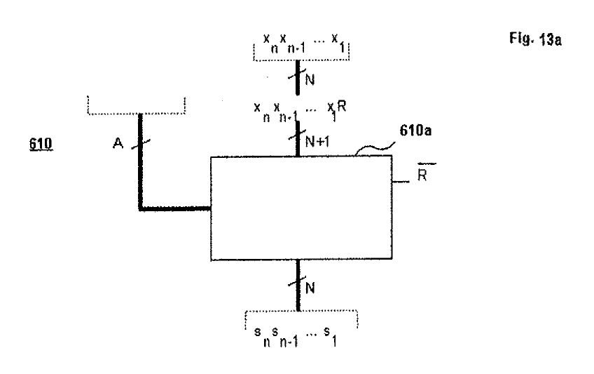

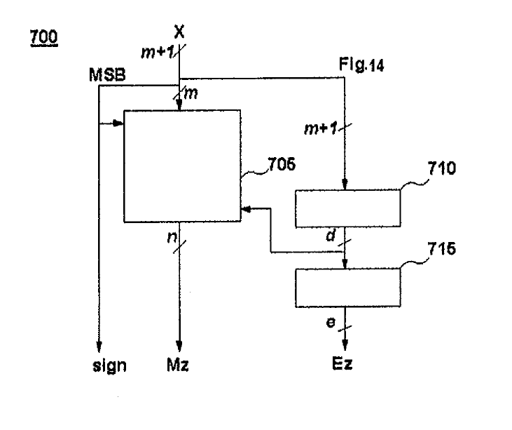

One category of such converters is converters for converting preprocessed integer numbers to preprocessed FP numbers. FIG. 12 illustrates an example of such a converter for a preprocessed integer numbers of m+2 bits and a preprocessed FP number having a significand of n+1 bits. Converter 600 comprises a normalization module 630 having a conditional bit inverter 605 in series with a preprocessed left shifter 610. The conditional bit inverter has a first input for receiving the m LSBs of an m+1 MSBs of the m+2 bits preproccesed fixed point number. The MSB of the m+2 bits number is the sign and shall be the sign of the preprocessed FP number as well as used to control the conditional bit inverter 605. The m-bit output of the conditional bit inverter 605 is input to preprocessed left shifter 610. In alternative implementations the special preprocessed left shifter 610 precedes the conditional bit inverter 605. The function of preprocessed left shifter 610 is described in more detail in FIG. 6a. The preprocessed left shifter 610 requires a special left-shifter 610a with a new third one-bit input which allows selecting the value used to fill the vacant positions after shifting. An implementation of the special left-shifter 610a may be similar to the one of the special left-shifter 245 illustrated in FIG. 2a. In this example of FIG. 13a, the maximum shift amount is m or m+1. If the fixed point number is equal to zero and the bit R in FIG. 13a is also equal to zero, it requires a maximum shift amount having an additional bit (m+1) so that the significand is normalized. Alternatively, if the integer is equal to zero, it may be treated as a special case and be converted to FP zero. Then the maximum shift amount would be equal to m.

Using this special left-shifter 610a, the input value of preprocessed left shifter 610 is augmented with an additional LSB set to any random bit (for instance, the LSB of the initial input value) and the third input of the special left-shifter is set to the inverted random value to fill both, the vacant positions required to complete the size of n if n>m+1, and the vacant positions produced after shifting. The output of preprocessed left shifter 610 comprises the n MSBs of the significand Mz of the preprocessed FP number. Said output corresponds only to the n MSBs of the shifted value if n<m. The LSB of the significand Mz is implicit and it is equal to 1.

In a parallel path, the converter 600 comprises el módulo detector de uno de cabecera (LOD) 615 having an input coupled to the output of conditional bit inverter 605 and an output for generating the shift amount for the special preprocessed left shifter 610 which is also used as input to exponent computation module 620 to generate the exponent Ez of the preprocessed FP number. Alternatively, the input of LOD module 615 may be directly coupled at the input of converter 600, but in this case it should detect the first zero, instead of the one, when the number is negative.

Compared with conventional fixed point FP converters, when M>N, there is no rounding up taking place after the shifting operation and therefore there is a reduction in components and processing. When M<N, then there is no bias produced because of the rounding with the used of the proposed converter.

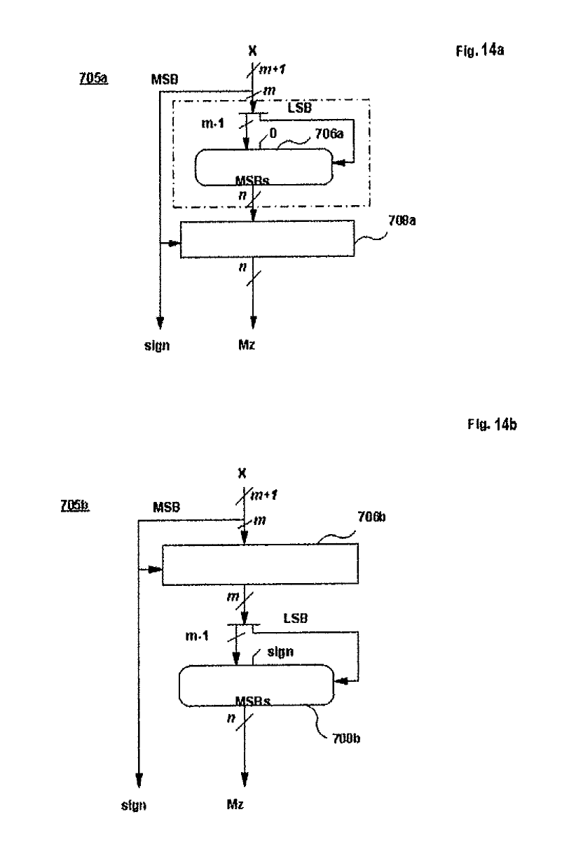

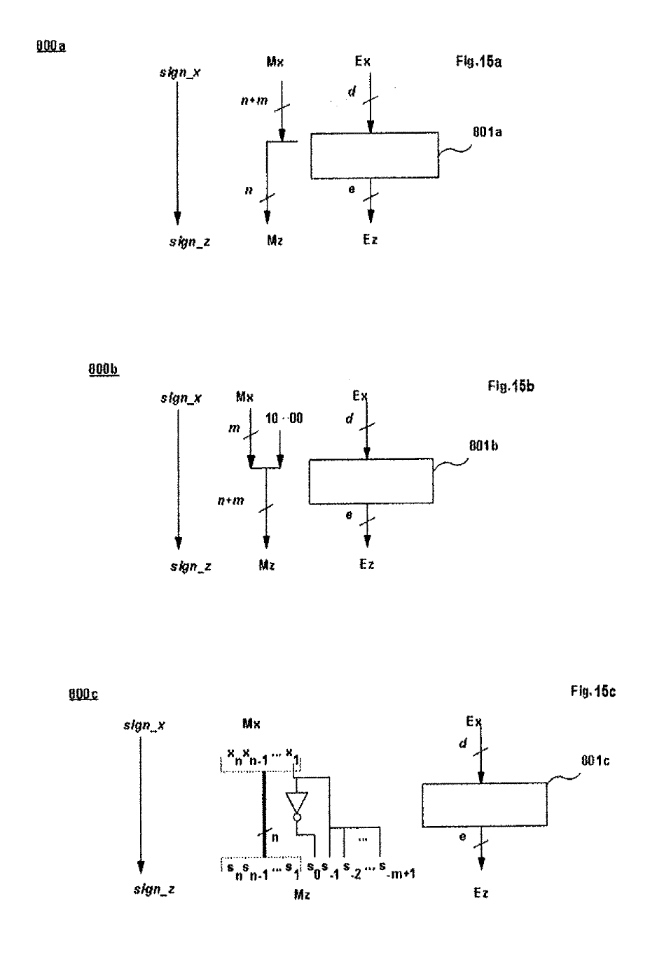

Another category of converters are converters for converting unprocessed fixed point numbers to preprocessed floating point numbers. FIG. 14 illustrates such a converter. Converter 700 comprises a normalization module 705 arranged to receive the m LSBs of an m+1 bit fixed point number. The MSB of the fixed point number is the sign of the fixed point number and it is used to control the normalization module 705 and to set the sign of the preprocessed FP number. The normalization module 705 may be similar to normalization modules 230 and 330 discussed in reference to FIG. 2 y 3. Furthermore, the normalization module may be implemented according to examples described in FIG. 14a and FIG. 14b. In FIG. 14a, normalization module 705a comprises special left-shifter 706a which is similar to special left-shifter 610a described in FIG. 13a. In this case the special left-shifter 706a receives the m−1 MSBs of the m LSBs of the unprocessed fixed point number, extended to the right with a bit set to zero and the LSB of the fixed point number is used as the third input of the special left-shifter 706a. The output of the special left shifter 706a corresponds to the n MSBs of the shifted value and it is input to a conditional bit inverter 708a having a second input for receiving the sign bit of the fixed point number. The output of the conditional bit inverter 708a is the n MSBs of the significand Mz of the FP preprocessed number. The LSB of the significand is implicit and it is equal to 1. In other implementations, the MSB of the normalized significand Mz may not include the leading one. Therefore, the output of the conditional bit inverter may be one bit less.

La FIG. 14b shows an alternative implementation of normalization module 705. Normalization module 705b comprises first a conditional bit inverter 706b for receiving the m LSBs of the unprocessed fixed point number. The output of conditional bit inverter 706b is input to special left-shifter 708b. The m−1 MSBs of the output of conditional bit inverter are introduced at the input of special left-shifter 708b while the LSB is used as the third input. Further the sign bit is introduced as the LSB of the first input of the special left-shifter 708b to augment the m−1 bits. The n-bit output of the special left-shifter is the n MSBs of the significand Mz of the FP preprocessed number. The LSB of the significand is implicit and it is equal to 1.

Returning to the converter 700 in FIG. 14, a parallel path comprises LOD module 710 having an input receiving the unprocessed fixed point number and an output for generating the shift amount for the normalization module 705 which is also used as input to exponent computation module 715 to generate the exponent Ez of the preprocessed FP number. In other implementations which may use normalization modulo 705b, the input of LOD module 710 may receive the output of the conditional bit inverter 706b instead.

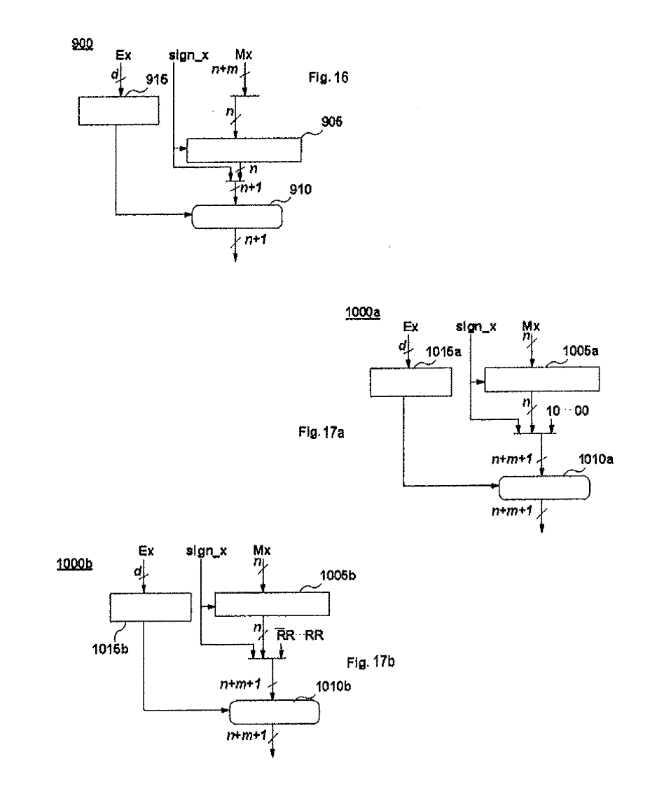

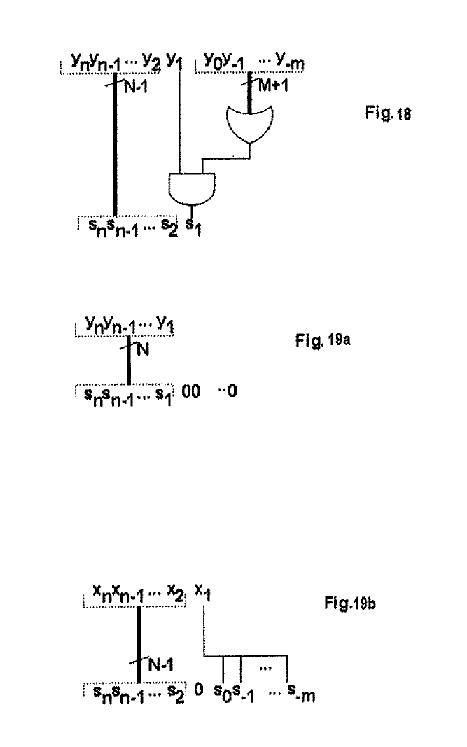

Another category of converters is converters for converting preprocessed FP numbers to preprocessed FP numbers of different size of significand. FIG. 15a is an example of such a converter. Converter 800a illustrates a converter adapted to convert a preprocessed FP number having an n+m+1 bit significand to an n+1 significand. The LSB of both significands is equal to 1 and is therefore not depicted. The sign (sign_x) of the original preprocessed FP number is going to remain the same in the target preprocessed FP number (depicted as sign_z). The n MSBs of the original significand shall be the n MSBs of the target preprocessed significand. That is, a simple truncation function takes place. Therefore, no overflow bit is generated and an exponent calculator 801a can generate the target exponent Ez simply based on the original exponent Ex.

FIG. 15b is another example of a preprocessed-FP-to-preprocessed-FP numbers converter. Converter 800b illustrates a converter adapted to convert a preprocessed FP number having an m+1 bit significand to an n+m+1 significand. Converter 800b is a biased version of such a converter. Again, The LSB of both significands is equal to 1 and is therefore not depicted. According to converter 800b, the sign bit remains the same, exponent calculator 801b computes the new exponent, and a circuit to expand the significand size by adding to the right a lagging one bit and as many zeros as required to complete the new significand size. Alternatively, it may be used a zero followed by ones.

FIG. 15c is yet another example of a preprocessed-FP-to-preprocessed-FP numbers converter. Converter 800c illustrates a converter adapted to convert a preprocessed FP number having an n+1 bit significand to an n+m+1 significand. Converter 800c is a unbiased version of such a converter. Again, The LSB of both significands is equal to 1 and is therefore not depicted. According to converter 800c, the sign bit remains the same, exponent calculator 801c computes the new exponent, and a circuit to expand the significand size by adding (to the right) a randomly selected bit value and as many bits with the inverse value as required to complete the new significand size. The random bit could be any of the initial significand one or combination of them, such as the second LSB, as shown in FIG. 8c.

Another category of converters is converters for converting preprocessed FP numbers to preprocessed fixed point number numbers. FIG. 16 illustrates such a converter for converting an FP number having an n+m+1 bit significand and a d-bit exponent to an fixed point number of n+2 bits. The n MSBs of the significand are input to conditional bit inverter 905. The LSB of the significand is equal to 1 and is not introduced. The sign of the preprocessed FP number is used to control the conditional bit inverter 905. The output of the conditional bit inverter 905 along with the sign (sign_x) is input to right shifter 910. Right shifter 910 has another input for receiving the shift amount from shift amount calculator 915. Shift amount calculator 915 receives the exponent of the preprocessed FP number and generates the shift amount. The output of the right shifter 910 is the n+1 MSBs of the preprocessed fixed point number. The LSB is similarly equal to 1 and is neither generated nor depicted.

FIG. 17a illustrates a biased converter for converting a preprocessed FP number having an n+1 bit significand and a d-bit exponent to a preprocessed fixed point number of n+m+2 bits. The n MSBs of the significand are input to conditional bit inverter 1005a. The LSB of the significand is equal to 1 and is not introduced. The sign of the preprocessed FP number is used to control the conditional bit inverter 1005a. The output of the conditional bit inverter 1005a along with the sign (sign_x) is input to right shifter 1010a. The output of the conditional bit inverter is expanded by adding to the right a lagging 1 and as many zeros as required to complete the new size. In an alternative implementation, this expansion may be performed with a bit to zero and as may bits to one as necessary. This expanded number is input to the right shifter 1010a. Right shifter 1010a has another input for receiving the shift amount from shift amount calculator 1015a. Shift amount calculator 1015a receives the exponent of the preprocessed FP number and generates the shift amount. The output of the right shifter 1010a is the n+m+1 MSBs of the preprocessed fixed point number. The LSB is similarly equal to 1 and is neither generated nor depicted.

FIG. 17b illustrates an unbiased converter for converting a preprocessed FP number having an n+1 bit significand and a d-bit exponent to a preprocessed fixed point number of n+m+2 bits. The n MSBs of the significand are input to conditional bit inverter 1005b. The LSB of the significand is equal to 1 and is not introduced. The sign of the preprocessed FP number is used to control the conditional bit inverter 1005b. The output of the conditional bit inverter 1005b along with the sign (sign_x) is input to right shifter 1010b. The output of the conditional bit inverter is expanded by adding to the right a randomly selected bit value and as many bits with the inverse value as required to complete the new size. The random bit could be any of the initial significand or a combination of them. This expanded number is input to the right shifter 1010b. Right shifter 1010b has another input for receiving the shift amount from shift amount calculator 1015ab. Shift amount calculator 1015b receives the exponent of the preprocessed FP number and generates the shift amount. The output of the right shifter 1010b is the n+m+1 MSBs of the preprocessed fixed point number. The LSB is similarly equal to 1 and is neither generated nor depicted.

In other implementations of the examples in FIG. 16, 17a y 17b, the MSB of the normalized significand may not include the bit 1 header. Therefore, this ibt to 1 may be added in the conditional bit inverter.

Another category of converters is converters for converting unprocessed FP numbers to preprocessed FP numbers. In a first case, the significand of the original FP number is larger than the significand of the target FP number. The converter discussed with reference to FIG. 15a may be used but some bias is introduced. In case of unbiased rounding, the new significand is calculated with the circuit illustrated in FIG. 18. For an n+m+1 bit significand, the n−1 MSBs remain the same in the original and in the target FP numbers. The nth MSB of the new significand is set to zero if the m+1 LSBs of the original significand are all zero, and to the nth MSB of the original significand in other case. The LSB of new significand shall be 1, as the FP number is a preprocessed FP number.

When the significand of the FP preprocessed number shall have more bits (n+m+1) than the significand of the unprocessed FP number (n), then:

a) in the case of biased rounding, the significand of the unprocessed number is expanded with as many zeros as necessary. This is illustrated in FIG. 19a. The LSB shall be equal to 1 and it is implicit.
b) in the case of unbiased rounding, the n−1 MSBs are the same. The nth bit is forced to zero. The m+1 bits to the right are set equal to the LSB of the unprocessed significand. This is illustrated in FIG. 19b. The LSB of the preprocessed significand shall be 1, as the FP number is a preprocessed number.

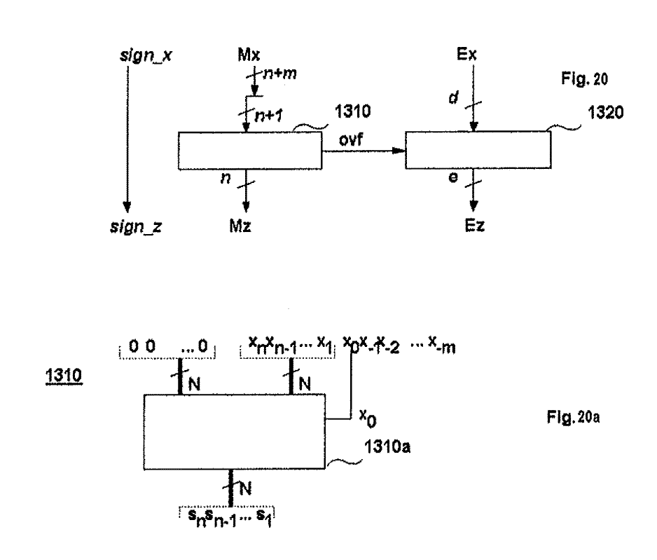

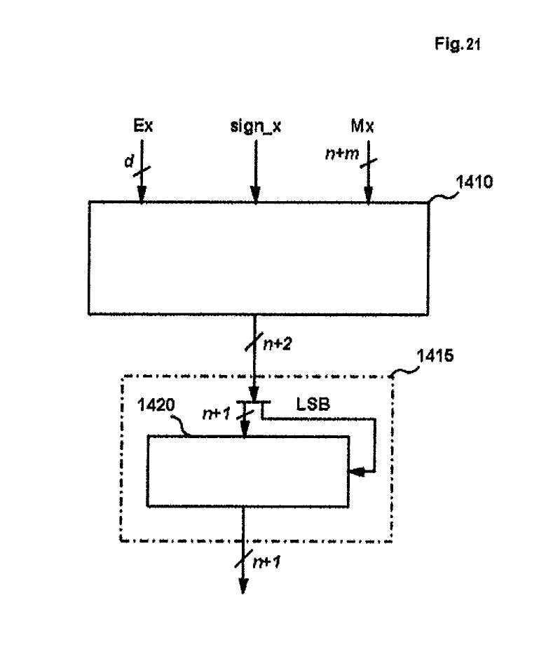

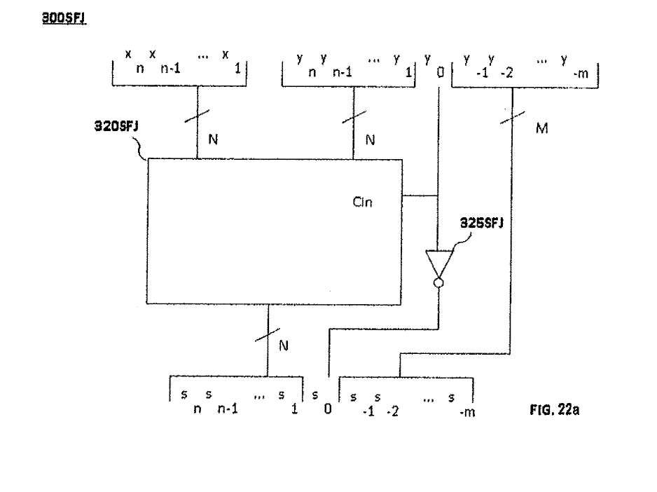

Another category of converters is converters for converting preprocessed FP numbers to unprocessed FP numbers. When the significand of the preprocessed FP number has more bits (n+m+1) than the significand of the unprocessed one (n), then the circuit illustrated in FIG. 20 may be used. The sign remains the same. The n+1 MSBs of the preprocessed significand are rounded to n by the rounder 1310. Rounder 1310 also generates an overflow bit that is used by exponent calculator 1320 to generate the exponent of the unprocessed FP number. The rounder 1310 is explained in FIG. 20a. An adder 1310a is used to increment by one the n MSBs of the preprocessed significand if the n+1th MSB is one. In alternative implementations different rounding units performing different rounding modes may be used. When the significand of the preprocessed FP number has less bits (m+1) than the significand of the unprocessed (m+n), then the circuit illustrated in la FIG. 15b may be used.

In an alternative implementation, the rounder may perform another type of rounding.

Yet another category of converters is converters for converting preprocessed FP numbers to unprocessed fixed point numbers. FIG. 21 illustrates such a converter where the number of bits of the input significand is greater than the number of bits of the output fixed point number. It comprises a sub-converter 1410 which corresponds to a preprocessed-FP-to-preprocessed-fixed point number converter 900 as discussed with reference to FIG. 16. The sub-converter 1410 receives the exponent Ex, the bit of the sign of the FP number (sign_x) and the significand Mx that comprises n+m bits. It generates a preprocessed fixed point number of n+2 bits at an output. Coupled to the output of said sub-converter 1410 is a rounding unit 1415 that includes an incrementer 1420 similar to the adder 1310a described with reference to FIG. 13a, to increment the n+1 MSBs of said output if the LSB is one. The output of the adder 1420 and consequently of the rounding unit 1415 is an unprocessed fixed point number of n+1 bits. In an alternative implementation, the rounder may perform another type of rounding.

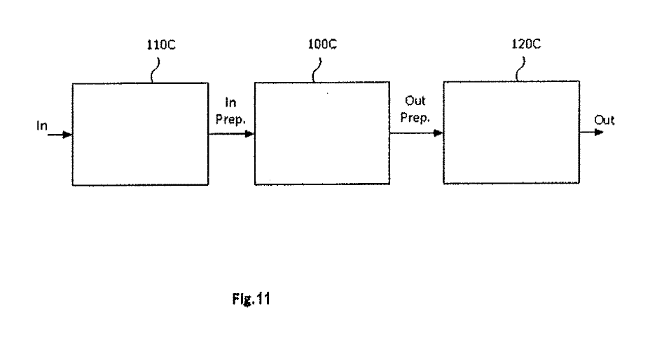

If the number of bits of the input significand is lower than the number of bits of the output fixed point number, such a converter may be identical to the converter 1000a described in FIG. 10a.

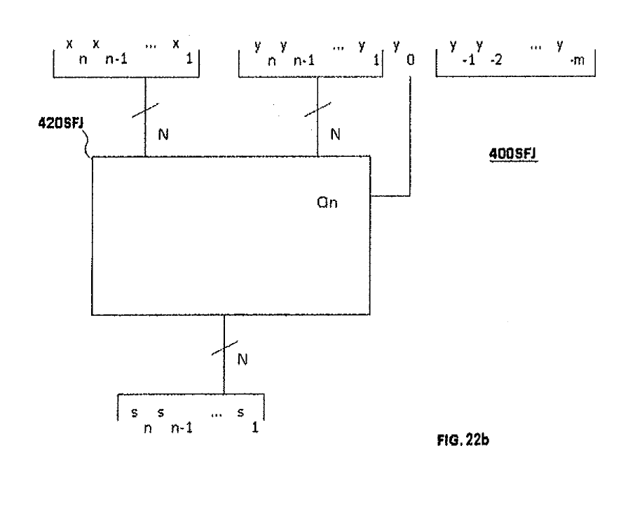

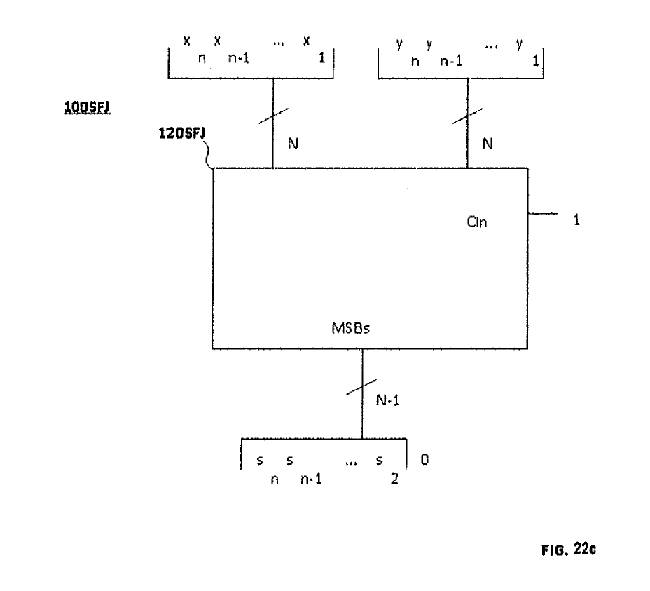

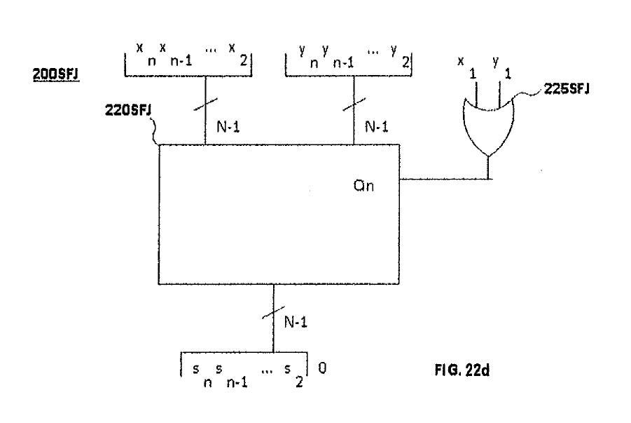

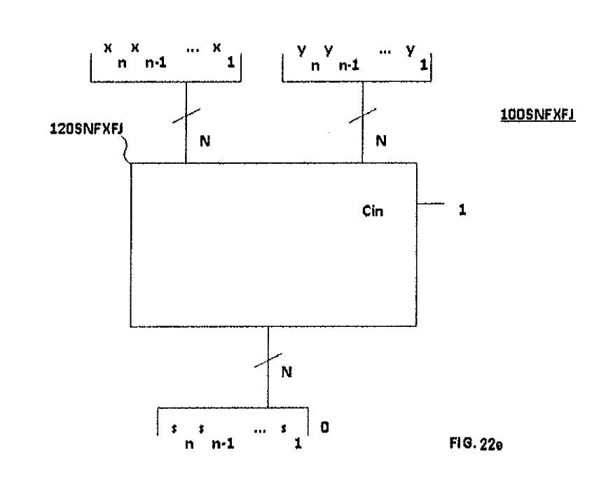

FIGS. 22a to 22e illustrate the implementations of a fixed point adding module according to different examples. A fixed point adding module 300SFJ, or 400SFJ, receives the n MSBs of a first preprocessed fixed point number of n+1 bits and the n+m+1 MSBs of a second preprocessed fixed point number of n+m+2 bits, at a first and second input, respectively, being m≧0. The fixed point adding module 300SFJ, or 400SFJ generates the z MSBs of a third preprocessed fixed point number of z+1 bits corresponding to the addition of both input numbers. The LSB of the preprocessed fixed point numbers is equal to 1 and is not required to be introduced or generated explicitly in the adding module. The fixed point adding module 300SFJ or 400SFJ comprises an n-bit adder 320SFJ, or 420SFJ, having the first and second n-bit inputs couple to the n MSBs of the first and the second preprocessed fixed point numbers, respectively, and the carry input coupled to the (n+1)th MSB of said second preprocessed fixed point number. The adder 320SFJ, or 420SFJ, generates the n MSBs of the third preprocessed fixed point number. FIG. 1b shows the boundary case wherein z=n. In the case that z>n, the (n+1)th MSB of the third preprocessed fixed point number is set to the inverse of the (n+1)th MSB of the second preprocessed fixed point number while the z−n−1 LSBs of said third preprocessed number are set equal to the z−n−1 LSBs of the second preprocessed fixed point number. FIG. 22a shown the boundary case wherein z=n+m+1. On the other hand, if z<n, the n-bit adder 320SFJ may be substitute for a z-bit adder to add the z MSBs of the first and second preprocessed input numbers, and a carry net module to generate the carry input of said z-bit adder, taking into account the n+1−z LSBs of the n+1 MSBs of said first and second input numbers. The LSB of the third preprocessed number is equal to 1, it doesn't need to be generated, and it is implicit in these examples.

FIG. 22c y 22d illustrate a fixed point adding module according to other examples wherein input numbers have the same size which provokes that the exact result of addition may not be a preprocessed number. A fixed point adding module 100SFJ or 200SFJ receives the n MSBs of a first and second preprocessed fixed point number at a first and second input, respectively, each preprocessed fixed point number having n+1 bits. The LSB of the preprocessed fixed point numbers is equal to 1. The fixed point adding module 100SFJ or 200SFJ generate a third preprocessed fixed point number corresponding to the addition of both input numbers rounded without bias. A fixed point adding module 100SFJ or 200SFJ comprises an adder 120SFJ or 220SFJ, which generates the n−1 MSBs of the third preprocessed fixed point number. The nth MSB is set to 0 while the LSB is again equal to 1 and needs not be generated or outputted. In FIG. 22c the adder 120SFJ may produce n bits, but only the n−1 MSBs of its output is used, whereas the carry input Cin is coupled to 1. In FIG. 22d the adder 220SFJ has n−1 bits and the carry input is coupled to an OR gate 225SFJ having the two inputs coupled to the nth MSB of the first and second preprocessed fixed point number, respectively. In an alternative implementation, if bias is not a problem, the nth MSB of the third preprocessed fixed point number may be generated by the adder instead of setting it to zero. In another alternative implementation, shown in FIG. 22e, the adding module may be arranged to produce the exact result of the addition, which is an unprocessed number, by outputting explicitly the LSB set to zero along with the output of adder 120SNFXFJ.

On the other hand, there are two different cases when one of the input numbers is an unprocessed number. When the size of the unprocessed input number is equal or greater than the size of the preprocessed number, the exact result of the addition may be an unprocessed number. The implementation of a fixed point adding module arranged to receive the N MSBs of a first preprocessed fixed point number of n+1 bits and the n+m+1 bits of a second unprocessed fixed point number, may be similar to the circuit shown in FIG. 22a. However, in this case, there is no implicit LSB at the output, which is an unprocessed fixed point number of n+m+1 bits. If a preprocessed output number is desired, an unprocessed to preprocessed converter, similar to the ones described subsequently herein, may be used. On the other hand, when the size of the unprocessed input number is lower than the size of the preprocessed one, the exact result of the addition is a preprocessed number. In this case, the fixed point adding module is arranged to receive the n bits of a first unprocessed fixed point number and the n+m MSBs of a second preprocessed fixed point number of n+m+1 bits. The n MSBs of the result is obtained by adding the n bits of the first number and the n MSBs of the second number, whereas the m+1 LSBs are the m+1 LSBs of the second number. This last includes the LSB which is implicit and equal to one. Since the result is a preprocessed number, a rounded to nearest output with fewer bits may be obtained just by truncating said result.

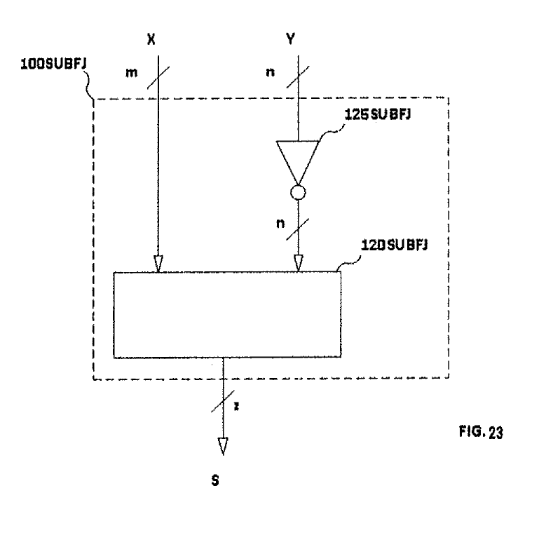

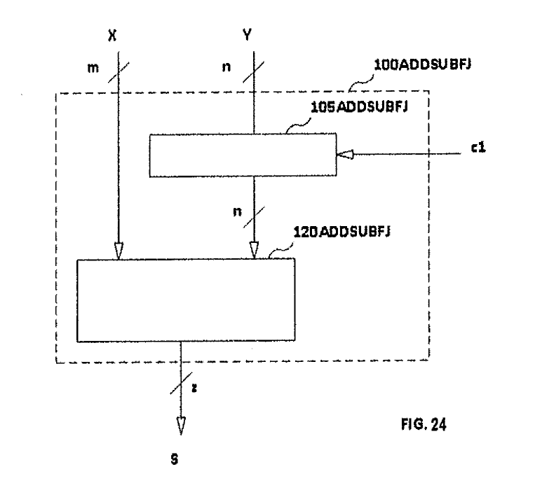

FIG. 23 illustrates a fixed point subtractor according to an example. A preprocessed fixed point subtracting module 100SUBFJ receives the m MSBs and the n MSBs of a first and a second preprocessed fixed point number, of m+1 and n+1 bits, at a first and a second input, respectively, and generates a third preprocessed fixed point number of z+1 bits corresponding to the first input number minus the second one. The LSB of the preprocessed fixed point numbers is equal to 1 and need not be introduced or generated. Preprocessed fixed point subtracting module 100SUBFJ comprises a preprocessed fixed point adding module 120SUBFJ, similar to the ones presented before, arranged to receive said first input and the bit-wise inversion of said second input with bit inverter 125SUBFJ, which in practice negates the second preprocessed number. The z-bit output of said preprocessed adding module corresponds to the z MSBs of the result of subtraction, whereas its LSB is implicit and equal to one. A very similar implementation is shown in FIG. 24, which corresponds to a preprocessed fixed point adding/subtraction module 100ADDSUBFJ. The bit-wise inverter is substituted by a conditional bit inverter 105ADDSUBFJ, to selectively invert the second input. Thus, said module produces the desired addition or subtraction of the input numbers according to a control signal c1.

In the following examples of multipliers (including squarers and constant multipliers), it is considered, unless otherwise stated, that fixed point numbers are unsigned. However, one skilled in the art may appreciate that two's complement numbers may be operated instead, by making known modifications to the disclosed circuits, such as sign extension instead of zero extension for additions.

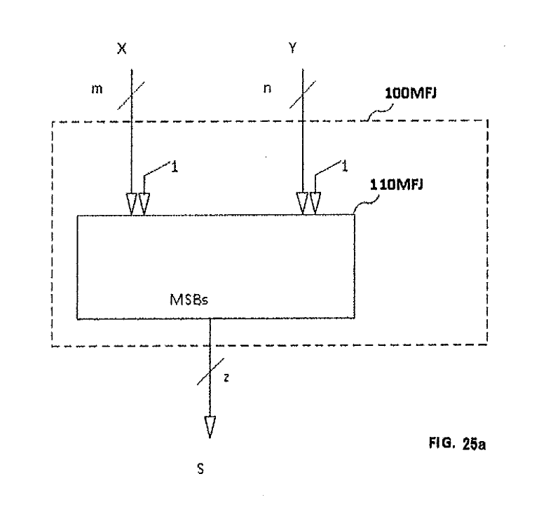

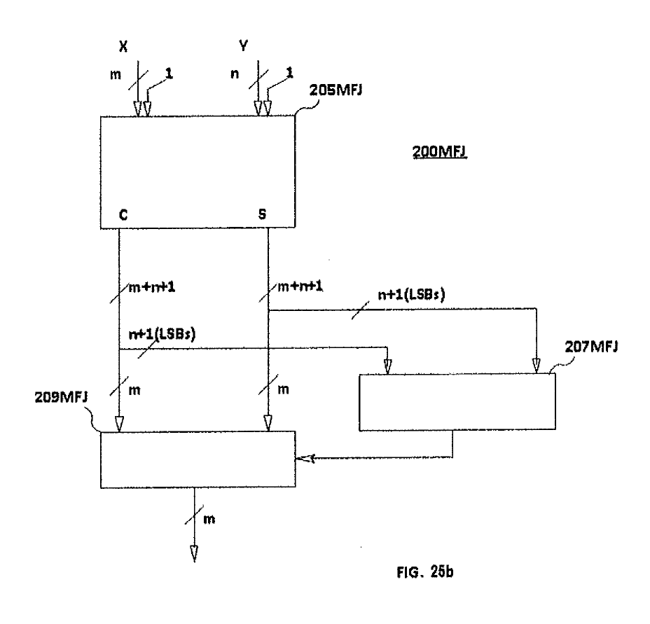

FIG. 25a illustrates the implementation of a preprocessed fixed point multiplication module according to an example. A preprocessed fixed point multiplication module 100MFJ receives the m MSBs and the n MSBs of a first and second preprocessed fixed point number, of m+1 and n+1 bits, at a first and second input, respectively, and generates a third preprocessed fixed point number of z+1 bits corresponding to the multiplication of both input numbers. The LSB of the preprocessed fixed point numbers is equal to 1 and need not be introduced at the input of said module. Preprocessed fixed point multiplication module 100MFJ comprises a fixed point multiplier 110MFJ arranged to receive said first and second inputs augmented to the right with the LSB of the preprocessed numbers and generates the n+m+1 MSBs of the multiplication of both numbers. The introduction of this additional one may be performed internally to the multiplier without the need for a special input. They are merely illustrated to indicate that the multiplier shall take them into account when performing the multiplication operation. The z MSBs of the output of the multiplier 110MFJ corresponds to the z MSB of the third preprocessed fixed point number. The LSB is equal to 1 and needs not be stored or generated. In alternative implementations the fixed point multiplier may just generate the product of the first and second input of the multiplication module, and said product may be added with said first and second input shifted one bit to the right to produce the correct result, corresponding to the product of the (full) input numbers.

Since, only the z MSBs of the multiplication are delivered, the multiplier circuit may be optimized by avoiding the computation of the LSBs.

FIG. 25b illustrates an implementation example of a preprocessed fixed point multiplier which avoids the generation of said LSBs. Fixed point multiplier 200MFJ comprises a redundant multiplier 205MFJ, a carry net module 207MFJ and a conversion module 209MFJ. The redundant multiplier 205MFJ receives, at a first and a second input, the m MSBs and the n MSBs of the first and second preprocessed fixed numbers, of m+1 and n+1 bits, respectively, and two additional inputs coupled to 1, so that the m bits at the input of each fixed point number are augmented to the right by 1 bit. However, in alternative implementations, the introduction of the additional one may be performed internally to the module 205MFJ without the need for a special input. It is merely illustrated in the example of FIG. 25b, and in other subsequent examples, to indicate the need for the functional introduction of the implicit LSB. The redundant multiplier 205MFJ generates, in a redundant representation format, the n+m+1 MSDs of a value corresponding to the multiplication operation between said preprocessed fixed point numbers. The LSD of said result is always one and it is not required explicitly. The redundant multiplier 205MFJ shown in FIG. 25b generates the result in carry-save format and then said result is delivered at a first and a second n+m+1 bit outputs, corresponding to the sum word and carry word respectively. However, one skilled in the art may appreciate that other redundant representation formats may be used with minor modifications to the disclosed circuits, such as signed digit representations.

The carry net module 207MFJ receives the n+1 LSDs of the output, which does not include the implicit LSB of the preprocessed format, of said redundant multiplier and generates the carry bit corresponding to the conversion of said digits to a non-redundant binary representation. In this particular example, since carry-save representation is used, the carry net module 207MFJ receives the n+1 LSBs of the sum and carry words, at a first and a second input, respectively, and generates the last carry bit corresponding to the addition of both inputs.

The conversion module 209MFJ receives the m MSDs of the output of the redundant multiplier 205MFJ and the carry bit from the carry net module 207MFJ, and generates the m bits corresponding to the m MSBs of the value of the multiplication of the input fixed point numbers in a non-redundant representation. In this particular example, since carry-save representation is used, the conversion module 209MFJ receives the m MSBs of the sum and carry words at a first and a second input, respectively, and the carry bit at a third input and generates a value corresponding to the addition of both input words and the carry bit. Besides, in this particular example, the size of the output and the first input are equal, but in an alternative implementation the size of the output may be z+1 bits, being z<n+m. In this case, the carry net module 207MFJ may receive the n+m−z+1 LSDs of the output of the redundant multiplier, and the conversion module 209MFJ, the z MSDs.

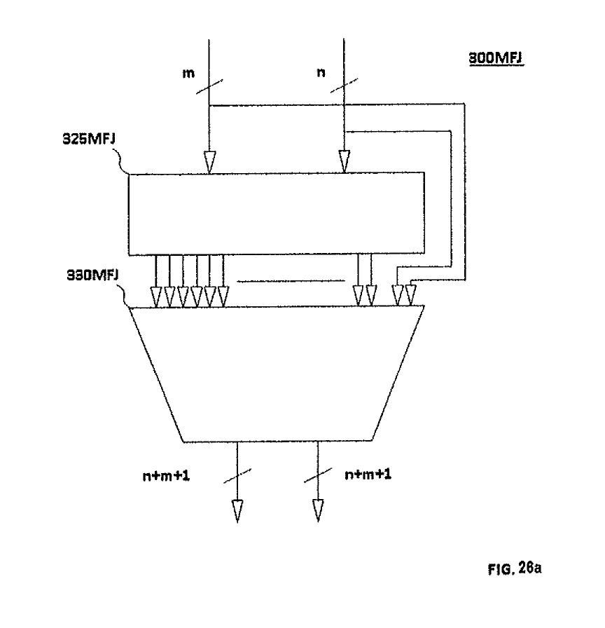

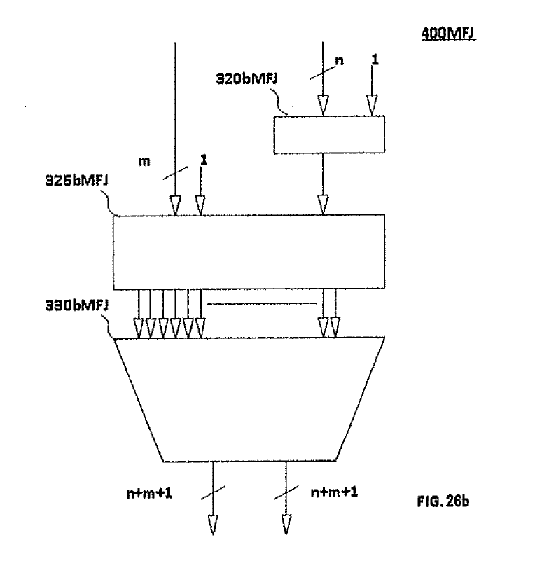

FIG. 26a y 26b illustrate the implementations of a redundant multiplier for preprocessed numbers 300MFJ, y 400MFJ, respectively, in which the LSB of the input numbers is not received. The redundant multiplier for preprocessed numbers in FIG. 26a, and FIG. 26b, only receives the m MSBs, and the n MSBs, of a first, and a second, preprocessed fixed point number (X and Y) of m+1, and n+1 bits, respectively, because the LSB is constant and equal to zero. Said redundant multiplier generates, in a redundant representation, the m+n+1 MSDs of the multiplication result of both input numbers, the LSB of such result being also implicit and equal to zero. In other words, if the m MSBs of X are represented by X′, y the m MSBs of Y by Y′, so the value of the n+m+1 digits output is equal to X′*Y′+1/2X′+1/2Y′.

The redundant multiplier for preprocessed numbers represented in FIG. 26a comprises a partial products generator module 325MFJ and a compressor tree 330MFJ. The partial products generator module 325MFJ receives said m MSBs, and n MSBs, from both preprocessed fixed point numbers, in a first and in a second input, respectively, and generates the partial products corresponding to the product of the first input per each bit of the second input. In an alternative implementation, the second entry may be divided in several groups of bits and the generated partial products may correspond to the products of the first input per each group of bits.

The compressor tree 330MFJ receives the output of the partial product generator module 325MFJ and a copy of the two inputs of the partial product generator module 325MFJ and generates a m+n+1 digit redundant output corresponding to the addition of all its inputs correctly aligned. It should be noted that said copies are aligned, such that the second LSB is aligned with the LSB of the least significant partial product (the one corresponding to the LSB of the second input). In this particular example, since carry-save representation is used, two m+n+1 bit numbers are produced corresponding to the sum and carry words. In an alternative implementation, a different redundant representation format may be used. In other implementations if non redundant output is desired, a conversion module may be used to transform the output of the compressor tree 330MFJ to a non-redundant m+n+1 bit number corresponding to the m+n+1 MSBs of the product of the initial preprocessed numbers.

The preprocessed redundant multiplier represented in FIG. 26b is similar to the previous one, but the second input is recoded (for example it may be Booth recoded) before entering the partial product generator module 325bMFJ to produce less partial products, by using a recodification module 320bMFJ. The value 1 is also inserted at the input of the recodification module 320bMFJ so that the n bits at the second input are augmented to the right by 1 bit corresponding to the implicit LSB. However, in other implementations the introduction of the additional one may be performed internally to the recodification module 320bMFJ without the need for a special input. It is merely illustrated in the example to indicate the need for the functional introduction of the implicit LSB. Similarly, the LSB of the other input is also illustrated at the first input of the partial product generator module 325bMFJ.

The architectures shown with reference to FIGS. 25a-26ba, may be implemented for either unsigned or signed numbers by using the adequate modules accordingly, such as unsigned or signed fixed point multiplier. However a different approach may be utilized to implement multiplication modules for signed preprocessed numbers. This is based on using the unsigned version of any of the examples shown before and the conversion of two's complement input numbers to sign-and-magnitude format. This conversion may easily be implemented for preprocessed numbers using a conditional bit inverter to invert the n−1 LSBs of the n MSBs of a preprocessed number of n+1 bits, if it is negative Then, the magnitude may be operated by the unsigned multiplier module while the sign may be processed apart. Finally, a conversion from the sign-and-magnitude result to two's complement number, which is similar to the previous one, is required. Besides, one skilled in the art may appreciate that it may be easy to modify this design to support both formats at the same unit.

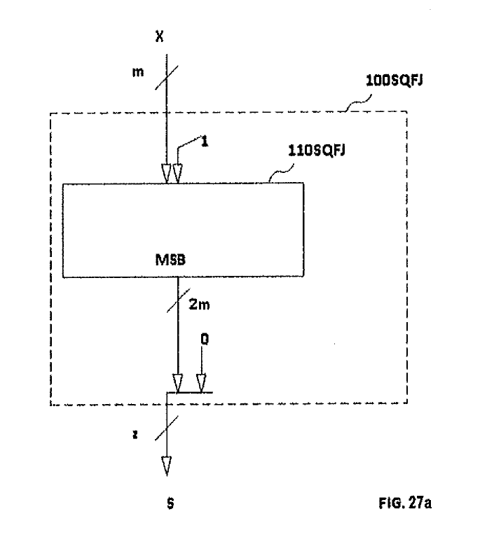

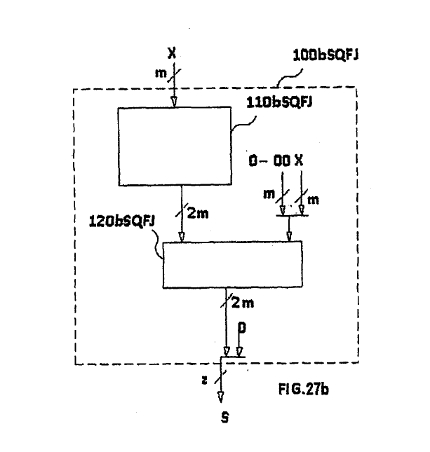

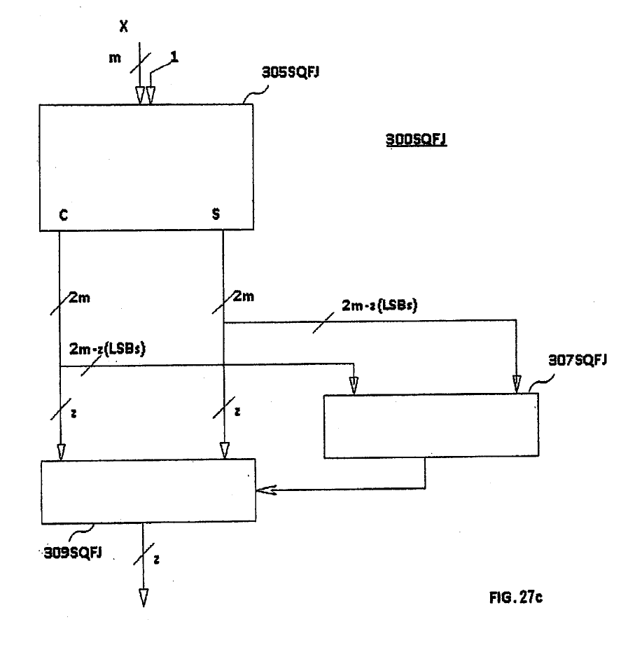

FIGS. 27a and 27b illustrate the implementations of a preprocessed fixed point squaring module according to two examples, considering unsigned input. A preprocessed fixed point squaring module 100SQFJ or 100bSQFJ receives the m MSBs of a first preprocessed fixed point number of m+1 bits, at a first input and generates a second preprocessed fixed point number of z+1 bits corresponding to the squaring of the input number. The LSB of the preprocessed fixed point numbers is equal to 1 and need not be introduced at the input of said module. Preprocessed fixed point squaring module 100SQFJ of FIG. 27a comprises a fixed point squarer 110SQFJ arranged to receive said first input augmented to the right with the LSB of the preprocessed number and generates the 2m MSBs of the squaring of said number. The introduction of this additional one may be performed internally to the squarer without the need for a special input. They are merely illustrated to indicate that the squarer shall take them into account when performing the multiplication operation. The output of the squarer 110SQFJ is augmented to the right with a bit set to zero, corresponding to the second LSB of the result of the squaring operation. Said zero bit may be outputted by the squarer (or even avoided if z<2m+1). It is illustrated apart merely to indicate that its calculation is not required. The z MSBs of said augmented output of the squarer corresponds to the z MSB of the second preprocessed fixed point number. The LSB is equal to 1 and needs not be stored or generated.

Alternatively, preprocessed fixed point squaring module 100bSQFJ of FIG. 27b comprises a fixed point squarer 110bSQFJ arranged to receive just said first input and generate the 2*m bits of the squaring of said input. An adder 120bSQFJ is utilized to incorporate the effect of the implicit LSB of the input number by adding the n MSBs of said input preprocessed number, aligned to the right, to the output of the squarer 110bSQFJ. In other implementations, said addition may be performed within the squarer 110bSQFJ or the zero extension may be performed within the adder. Similarly to example of FIG. 27a, the output of the adder 120bSQFJ may be augmented to the right with a zero bit if z>2*m. The z MSBs of the output of the adder 120bSQFJ (augmented if it is required) corresponds to the z MSB of the second preprocessed fixed point number. The LSB is equal to 1 and needs not be stored or generated.

Since, only the z MSBs of the squaring are delivered, the squarer circuit may be optimized by avoiding the computation of the LSBs. FIG. 27c illustrates an implementation example of a preprocessed fixed point squarer which avoids the generation of said LSBs. Fixed point squarer 300SQFJ comprises a redundant squaring module 305SQFJ, a carry net module 307SQFJ and a conversion module 309SQFJ. The redundant squaring module 305SQFJ receives, at a first input, the m MSBs of the first preprocessed fixed number of m+1 bits and an additional input coupled to 1, so that the m bits at the input are augmented to the right by 1 bit. However, in alternative implementations, the introduction of the additional one may be performed internally to the module 305SQFJ without the need for a special input. It is merely illustrated in the example of FIG. 27c, and in other subsequent examples, to indicate the need for the functional introduction of the implicit LSB. The redundant squaring module 305SQFJ generates, in a redundant representation format, the 2m MSDs of a value corresponding to the squaring of the preprocessed input number. The second LSD and the LSD of said result are always zero and one respectively and they are not required explicitly. The redundant squaring module 305SQFJ shown in FIG. 27c generates the result in carry-save format and then said result is delivered at a first and a second 2m bit outputs, corresponding to the sum word and carry word respectively. However, one skilled in the art may appreciate that other redundant representation formats may be used with minor modifications to the disclosed circuits, such as signed digit representations.

The carry net module 307SQFJ receives the 2*m−z LSDs of the output of said redundant squaring module 305SQFJ, and generates the carry bit corresponding to the conversion of said digits to a non-redundant binary representation. In this particular example, since carry-save representation is used, the carry net module 307SQFJ receives the 2*m−z LSBs of the sum and carry words, at a first and a second input, respectively, and generates the last carry bit corresponding to the addition of both inputs.

The conversion module 309SQFJ receives the z MSDs of the output of the redundant squaring module 305SQFJ and the carry bit from the carry net module 307SQFJ, and generates the z bits corresponding to the z MSBs of the value of the squaring of the input fixed point number in a non-redundant representation. In this particular example, since carry-save representation is used, the conversion module 309SQFJ receives the z MSBs of the sum and carry words, at a first and a second input, respectively, and the carry bit at a third input and generates a value corresponding to the addition of both input words and the carry bit.

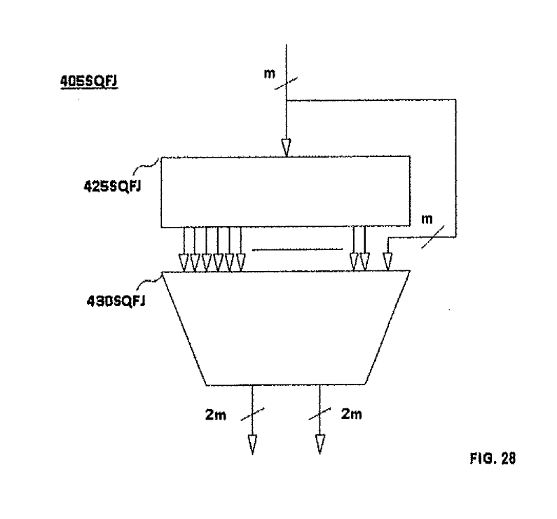

FIG. 28 illustrates an implementation of a preprocessed redundant squaring module according to one example, wherein the LSB of the input number is not received. Thus, said module receives only the m MSBs of a preprocessed fixed point number (X), since the LSB is constant and equal to one. Said preprocessed redundant squaring module 405SQFJ generates, in a redundant representation, the 2*m MSDs of the result of the squaring the preprocessed input, being the second LSB and the LSB of said result implicit and equal to zero and one, respectively. Said in a different way, if the m MSBs of X are represented by X′, then the 2*m digit value at the output is equal to X′̂2+X′. The preprocessed redundant squaring module 405SQFJ comprises a partial product generator module 425SQFJ and a compressor tree 430SQFJ. The partial product generator module 425SQFJ receives said m MSBs of the preprocess fixed point number at a first input, and generates a set of partial products, which allows, by adding them, to obtain a value corresponding to the squaring of said first input (i.e., X′̂2). One skilled in the art may appreciate that there are different sets of partial products which may be utilized depending on the degree of optimization desired.

The compressor tree 430SQFJ receives the output of the partial product generator module 425SQFJ and a copy of the m MSBs of the preprocessed input number and generates a 2*m digit redundant output corresponding to the addition of all its inputs correctly aligned. We should note that said m MSBs are aligned in such a way, that, its LSB is aligned with the LSB of the least significant partial product. In an alternative implementation said m MSBs may be introduced either within the compressor tree 430SQFJ or the partial product generator module 425SQFJ. In this particular example, since carry-save representation is used, two 2*m bit numbers are produced corresponding to the sum and carry words. In an alternative implementation, a different redundant representation format may be used. In other implementations if non redundant output is desired, a conversion module may be used to transform the output of the compressor tree 430SQFJ to a non-redundant 2*m bit number corresponding to the 2*m MSBs of the squaring of the initial preprocessed number.

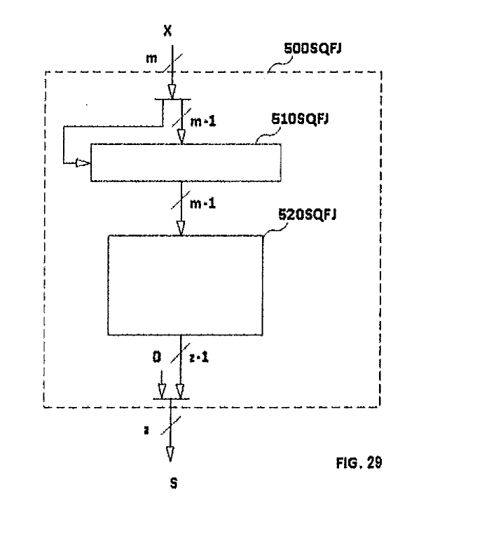

In the examples shown in FIGS. 27a, 27b, 27c and 28, the preprocessed input number is considered unsigned. However, in alternative implementations of those examples, the input preprocessed number may be signed. In that case, the squarer used may be specifically arranged to support squaring of signed numbers instead of unsigned ones. Besides, the zero extensions required for additions, such as the one in example of FIG. 27b, should be substituted by a sign extension. However, a different solution is presented in the example of FIG. 29. Said FIG. 29 illustrates the implementations of a preprocessed fixed point squaring module 500SQFJ for signed input according to an example. The preprocessed fixed point signed squaring module 500SQFJ receives the m MSBs of a first preprocessed fixed point two's complement number of m+1 bits, at a first input, and generates a second preprocessed fixed point two's complement number of z+1 bits corresponding to the squaring of the input number. The LSB of the preprocessed fixed point numbers is equal to 1 and need not be introduced at the input, or generated at the output, of said module. Preprocessed fixed point signed squaring module 500SQFJ of FIG. 9 comprises a conditional bit inverter 510SQFJ and a preprocessed fixed point squaring module 520SQFJ for unsigned preprocessed numbers of m bits, similar to the ones presented in previous examples. The m−1 LSBs of the input are introduced to conditional bit inverter 510SQFJ. The MSB of said input, which is the sign of the preprocessed input number, is used to control the conditional bit inverter 510SQFJ. Conditional bit inverter 510SQFJ shall carry out a bit-wise inversion of said m−1 bits if said sign bit is equal to one. Thus, the output of the conditional bit inverter 510SQFJ, along with the implicit LSB, corresponds to the magnitude of the preprocessed input number, since said number is negated if it is negative. The m−1 bit output of the conditional bit inverter 510SQFJ is coupled to the preprocessed fixed point squaring module 520SQFJ, which generates the z−1 MSBs of the squaring of said magnitude. The output of the preprocessed fixed point squaring module 520SQFJ, augmented to the left with a sign bit, which is always zero, corresponds to the z MSBs of the second preprocessed fixed point two's complement number. The LSB is equal to 1 and needs not be stored or generated.

The examples shown in figures from FIGS. 27a to 28 are for unsigned input number whereas the example in FIG. 29 is exclusively for signed input number. However, one skilled in the art may appreciate that it is possible, with minor modifications, to design a new architecture combining them to support both formats at the same unit.

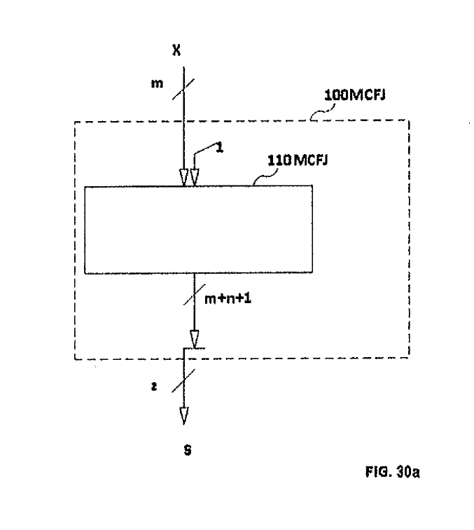

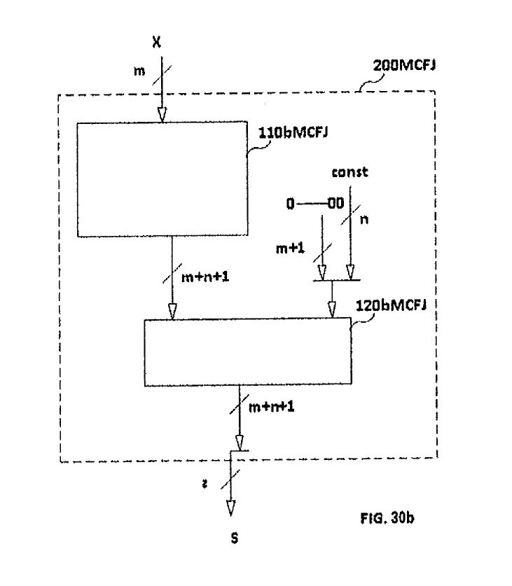

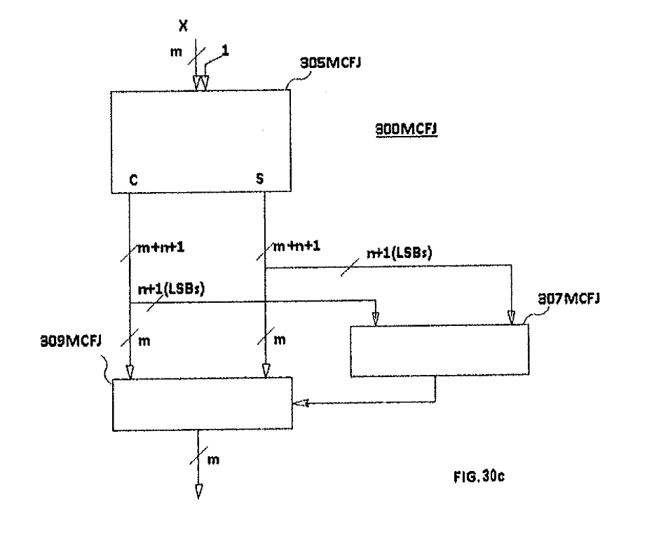

FIGS. 30a and 30b illustrate the implementations of a preprocessed fixed point constant multiplication module according to two examples. A preprocessed fixed point constant multiplication module 100MCFJ or 200MCFJ receives the m MSBs of a first preprocessed fixed point number of m+1 bits, at a first input and generates a second preprocessed fixed point number of z+1 bits corresponding to the multiplication of the input number and a constant preprocessed fixed point number of n+1 bits. The LSB of the preprocessed fixed point numbers is equal to 1 and need not be introduced at the input of said module. Preprocessed fixed point constant multiplication module 100MCFJ of FIG. 30a comprises a fixed point constant multiplier 110MCFJ arranged to receive said first input augmented to the right with the LSB of the preprocessed number and generates the n+m+1 MSBs of the multiplication of said number and said constant number. The introduction of this additional one may be performed internally to the multiplier without the need for a special input. They are merely illustrated to indicate that the multiplier shall take them into account when performing the multiplication operation. The z MSBs of the output of the constant multiplier 110MCFJ corresponds to the z MSB of the second preprocessed fixed point number. The LSB is equal to 1 and needs not be stored or generated.

Alternatively, preprocessed fixed point constant multiplication module 200MCFJ of FIG. 30b comprises a fixed point constant multiplier 110bMCFJ arranged to receive just said first input and generate the n+m+1 bits of the multiplication of said input and said constant number. An adder 120bMCFJ is utilized to incorporate the effect of the implicit LSB of the input number by adding the n MSBs of the constant number, aligned to the right, to the output of the constant multiplier 110bMCFJ. In the example of FIG. 30b an unsigned constant number is supposed, but sign extension instead of zero extension may be used for signed constants. In other implementations, a constant adder, optimized to add the constant value to its only input value, may be used instead of the adder 120bMCFJ and the external constant. In others implementation, said addition may be performed within the constant multiplier 110bMCFJ. The z MSBs of the output of the adder 120bMCFJ corresponds to the z MSB of the second preprocessed fixed point number. The LSB is equal to 1 and needs not be stored or generated.

In alternative implementations of the examples of FIG. 30a y 30b the desired constant number may not be a preprocessed number since its LSB may be zero. However, all the LSBs before the first bit equal to one may be removed to generate a preprocessed constant number. In some implementations, those LSBs equal to zero may added to the right of the output of the constant multiplier 110MCFJ, or 110bMCFJ, if any those bits corresponds to the integer part of the number to generate the correct result. In this case, the result may be an unprocessed number. In some implementation a unprocessed to preprocessed numbers converter may be use. In other ones, the unprocessed number may be the output number.

Since, only the z MSBs of the multiplication are delivered, the multiplier circuit may be optimized by avoiding the computation of the LSBs. FIG. 30c illustrates an implementation example of a preprocessed fixed point constant multiplier which avoids the generation of said LSBs. Fixed point constant multiplier 300MCFJ comprises a redundant constant multiplication module 305MCFJ, a carry net module 307MCFJ and a conversion module 309MCFJ. The redundant constant multiplication module 305MCFJ receives, at a first input, the m MSBs of the first preprocessed fixed number, and an additional input coupled to 1, so that the m bits at the input is augmented to the right by 1 bit. However, in alternative implementations, the introduction of the additional one may be performed internally to the module 305MCFJ without the need for a special input. It is merely illustrated in the example of FIG. 30c, and in other subsequent examples, to indicate the need for the functional introduction of the implicit LSB. The redundant constant multiplication module 305MCFJ generates, in a redundant representation format, the n+m+1 MSDs of a value corresponding to the multiplication operation between the preprocessed input number and a constant preprocessed fixed point number of n+1 bits. The LSD The LSD of said result is always one and it is not required explicitly. The redundant constant multiplication module 305MCFJ shown in FIG. 30c generates the result in carry-save format and then said result is delivered at a first and a second n+m+1 bit outputs, corresponding to the sum word and carry word respectively. However, one skilled in the art may appreciate that other redundant representation formats may be used with minor modifications to the disclosed circuits, such as signed digit representations.

The carry net module 307MCFJ receives the n+1 LSDs of the output of said redundant constant multiplication module 305MCFJ, which does not include the implicit LSB of the preprocessed format, and generates the carry bit corresponding to the conversion of said digits to a non-redundant binary representation. In this particular example, since carry-save representation is used, the carry net module 307MCFJ receives the n+1 LSBs of the sum and carry words, at a first and a second input, respectively, and generates the last carry bit corresponding to the addition of both inputs.

The conversion module 309MCFJ receives the m MSDs of the output of the redundant constant multiplication module 305MCFJ and the carry bit from the carry net module 307MCFJ, and generates the m bits corresponding to the m MSBs of the value of the multiplication of the input fixed point number and the constant number in a non-redundant representation. In this particular example, since carry-save representation is used, the conversion module 309MCFJ receives the m MSBs of the sum and carry words at a first and a second input, respectively, and the carry bit at a third input and generates a value corresponding to the addition of both input words and the carry bit. Besides, in this particular example, the size of the output and the first input are equal, but in an alternative implementation the size of the output may be z+1 bits, being z<n+m+1. In this case, the carry net module 307MCFJ may receive the n+m−z+1 LSDs of the output of the redundant multiplier, and the conversion module 309MCFJ, the z MSDs.

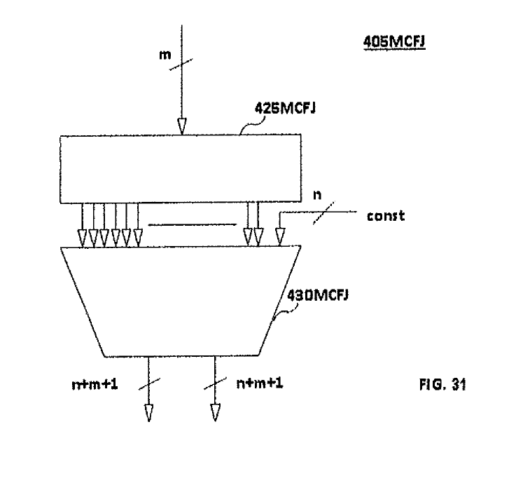

FIG. 31 illustrates an implementation of a preprocessed redundant constant multiplication module 405MCFJ according to one example, wherein the LSB of the input number is not received. Thus, said module receives only the m MSBs of a preprocessed fixed point number (X), since the LSB is constant and equal to one. Said preprocessed redundant constant multiplication module generates, in a redundant representation, the m+n+1 MSDs of the result of the multiplication between the preprocessed input number and a constant preprocessed fixed point number of n+1 bits (Y), being the LSB of said result also implicit and equal to one. Said in a different way, if the m MSBs of X are represented by X′ and the n MSBs of Y are represented by Y′, then the m+n+1 digit value at the output is equal to X′*Y′+1/2X′+1/2Y′. The preprocessed redundant constant multiplication module 405MCFJ comprises a partial product generator module 425MCFJ and a compressor tree 430MCFJ. The partial product generator module 425MCFJ receives said m MSBs of the preprocess fixed point number, at a first input, and generates a set of partial products, which allows, by adding them, to obtain a value corresponding to the product of said first input times the n MSBs of the constant preprocessed number (i.e., X′*Y′). One skilled in the art may appreciate that there are different sets of partial products which may be utilized depending on the degree of optimization desired. Besides, in an alternative implementation, the partial product generator module may be arranged to take into account also the LSB of the constant (i.e., generate X′*Y′+1/2X′).

The compressor tree 430MCFJ receives the output of the partial product generator module 425MCFJ, a copy of the m-bit input and the n MSBs of the constant preprocessed number, and generates a m+n+1 digit redundant output corresponding to the addition of all its inputs correctly aligned. We should note that said copy and said n MSBs are aligned, in such a way that their second LSB is aligned with the LSB of the least significant partial product. In an alternative implementation said copy and said n MSBs of the constant number may be introduced either within the compressor tree 430MCFJ or the partial product generator module 425MCFJ. In this particular example, since carry-save representation is used, two m+n+1 bit numbers are produced corresponding to the sum and carry words. In an alternative implementation, a different redundant representation format may be used. In other implementations if non redundant output is desired, a conversion module may be used to transform the output of the compressor tree 4300MCFJ to a non-redundant m+n+1 bit number corresponding to the m+n+1 MSBs of the product of the initial preprocessed number and the constant number.

The architectures shown with reference from FIGS. 30a to 31, may be implemented for either unsigned or signed numbers by using the adequate modules accordingly, such as unsigned or signed fixed point constant multiplier, and substituting the zero extensions required for additions, such as the one in example of FIG. 30b, by a sign extension. However a different approach may be utilized to implement constant multiplication modules for signed preprocessed numbers. This may be based on the use of the unsigned version of any of the examples shown before and the conversion of the two's complement input number to sign-and-magnitude. This conversion is easily implemented for preprocessed numbers using a conditional bit inverter to invert the n−1 LSBs of the N MSBs of a preprocessed number of n+1 bits, if it is negative. Then, the magnitude may be processed by the constant multiplier module for unsigned inputs while the sign is processed apart. Finally, a conversion from the sign-and-magnitude result to two's complement number, which is similar to the previous one, is required. Besides, one skilled in the art may appreciate that it is easy to modify this design to support both formats at the same unit.

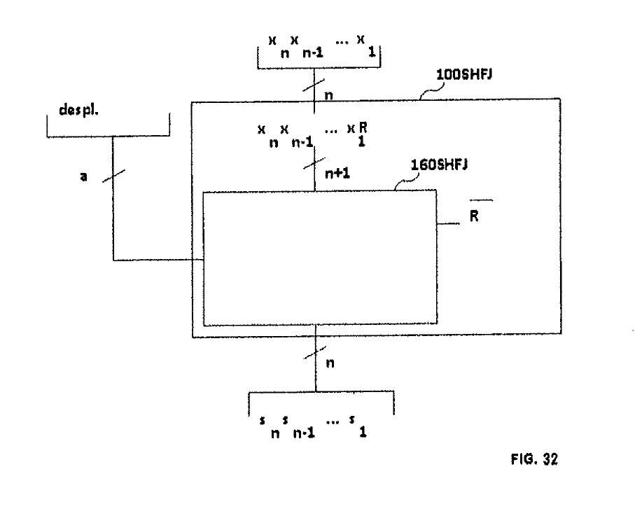

The implementation of a preprocessed left shifter is described FIG. 32, according to an example. Since the left shifting of a preprocessed fixed point number produces an unprocessed number, a rounding to nearest is required. The preprocessed left shifter 100SHFJ performs the left shifting of a preprocessed fixed point number without introducing bias due to rounding. Preprocessed left shifter 100SHFJ receives the n MSBs of a first preprocessed fixed point number of n+1 bits, at a first input, and shift amount, at a second input, and generates a second preprocessed fixed point number of n+1 bits corresponding to the left shifting of the input preprocessed number according to the shift amount. The LSB of the preprocessed fixed point numbers is equal to 1 and need not be introduced or generated. Preprocessed left shifter 100SHFJ comprises a special barrel left-shifter 160SHFJ having a new third one-bit input which allows selecting the value used to fill the vacant positions after shifting. Special left-shifter 160SHFJ is arranged to receive the n MSBs of the first preprocessed fixed point number augmented to the left with a bit having a random value, at a first input, the shift amount, at a second input, and the inverse of said random bit, at said new third input. In this way, the vacant position after left shifting is randomly filled either by one bit sets to one and the remaining bits set to zero, or the opposite, and no bias is produced. The random bit may be any selected bit, or combination of selected bits, of the first preprocessed fixed point number, or any other bit with adequate statistical characteristics. In other implementations the shift amount may be a constant value, and the shifting may be hardwired instead of using a special left shifter. In alternative implementations the size of the output may not be equal to the size of the first input.

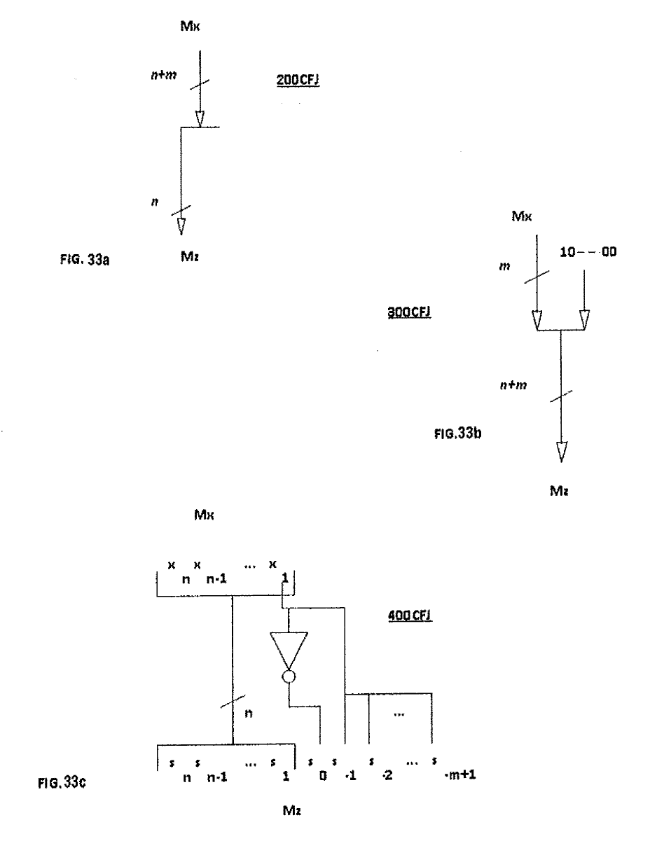

Other category of converters is converters for converting preprocessed fixed point numbers to preprocessed Fixed Point numbers of different size. FIG. 33a is an example of such a converter. Converter 800a illustrates a converter adapted to convert a preprocessed fixed point number of n+m+1 bits to an n+1 bit preprocessed fixed point number. The LSB of both numbers is equal to 1 and is therefore not depicted. The n MSBs of the original number shall be the n MSBs of the target preprocessed number. That is, a simple truncation function may take place.

FIG. 33b is another example of a preprocessed fixed point number to preprocessed fixed point number converter. Converter 800b illustrates a converter adapted to convert a preprocessed fixed point number of m+1 bits to an n+m+1 number. Converter 800b is a biased version of such a converter. Again, The LSB of both numbers is equal to 1 and is therefore not depicted. According to converter 800b, a circuit expands the number size by adding (to the right) a lagging one bit and as many zeros as required to complete the new number size.

FIG. 33c is another example of a preprocessed fixed point number to preprocessed fixed point number converter. Converter 800c illustrates a converter adapted to convert a preprocessed fixed point number of n+1 bits to an n+m+1 number. Converter 800c is an unbiased version of such a converter. Again, The LSB of both numbers is equal to 1 and is therefore not depicted. According to converter 800c, a circuit is used to expand the number's size by adding to the right a randomly selected bit value and as many bits with the inverse value as required to complete the new number size. The random bit may be any one of the initial number's or combination of them, such as the second LSB, as shown in FIG. 33c.

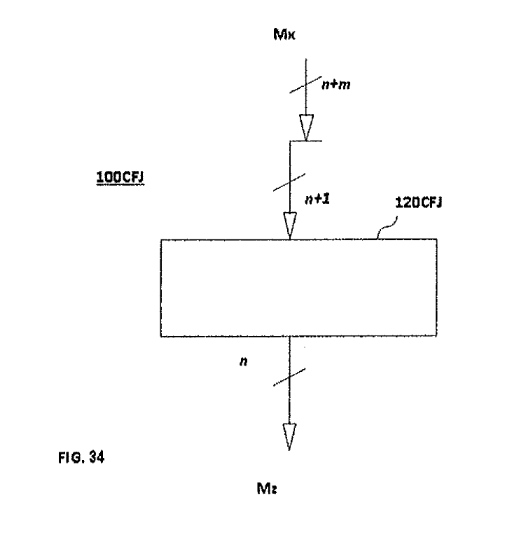

Another category of converters is converters for converting preprocessed fixed point numbers to unprocessed fixed point numbers FIG. 34 illustrates an example of converter 100CFJ for converting a n+m+1 bit preprocessed number to a n bit unprocessed number. The n+1 MSBs of the input number are introduced to a rounding module 120CFJ to produce a rounded unprocessed n bit number corresponding to the output value. The computation of the sticky bit corresponding to the remaining m bits is not required, since the LSB is always 1 and then, also the sticky bit is one.

FIG. 35 shows an implementation of said converter when the rounding module perform round to nearest. Converter 100bCFJ comprises an adder 1310aCFJ, used to increment by one the n MSBs of the preprocessed significand if the n+1th MSB is one. When m=0, i.e., the input processed number has n+1 bits, the n-bit input value is augmented with the LSB of said number, which is equal to one, before it inputs the rounding module. In alternative implementations different rounding modules performing different rounding modes may be used. On the other hand, the converter adapted to convert a preprocessed fixed point number of m+1 bits to an n+m+1 bit unprocessed number, is similar to the one described with reference to FIG. 33b, but the output doesn't have an implicit LSB.

Another category of converters is converters for converting preprocessed FP numbers to preprocessed fixed-point numbers (FIG. 16, 17a y 17b) previously commented.

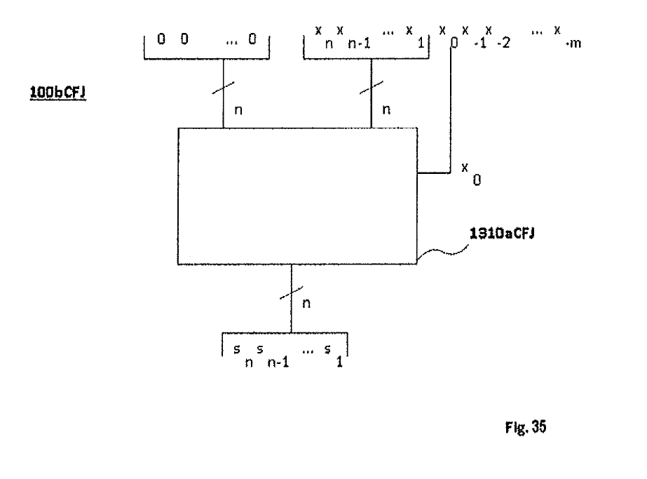

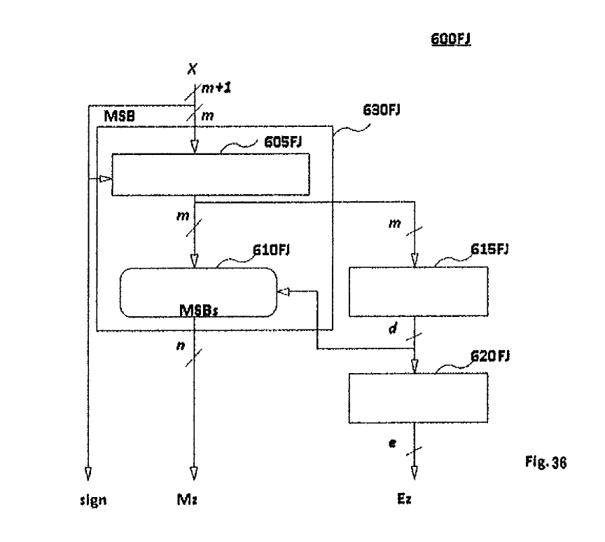

Another category of converters is converters for converting preprocessed fixed-point numbers to preprocessed FP numbers. FIG. 36 illustrates an example of such a converter for a preprocessed fixed-point number of m+2 bits and a preprocessed FP number having a significand of n+1 bits. Converter 600FJ comprises a normalization module 630FJ having a conditional bit inverter 605FJ in series with a preprocessed left shifter 610FJ, which may be similar to the one described with reference to FIG. 32. The conditional bit inverter has a first input for receiving the m LSBs of an m+2 bit preprocessed fixed-point number. The MSB of the m+2 bit number is the sign, and shall be the sign of the preprocessed FP number as well as used to control the conditional bit inverter 605FJ. The m-bit output of the conditional bit inverter 605FJ is input to the preprocessed left shifter 610FJ. In alternative implementations the preprocessed left shifter precedes the conditional bit inverter 605FJ. The function of preprocessed left shifter 610FJ is to normalize the input number by shifting it according to the received shift mount and rounding it without bias. An implementation of said preprocessed left shifter is described in more detail in FIG. 32.

In this example of FIG. 36, the maximum shift amount is m+1. If the fixed-point number is equal to zero and the random bit (R) in FIG. 32 is also equal to zero, it requires a maximum shift amount having an additional bit (m+1), so that the significand is normalized. Alternatively, if the fixed-point number is equal to zero, it may be treated as a special case and be converted to FP zero. Then the maximum shift amount would be equal to m.

The input value of preprocessed left shifter 610FJ is augmented with an additional LSB sets to any bit with a random value (for instance, the LSB of the initial input value) and both, the vacant positions required to complete the size of n, if n>m+1, and the vacant positions produced after shifting are set to the invert of the random value. The output of preprocessed left shifter 610FJ comprises the n MSBs of the significand Mz of the preprocessed FP number. Said output corresponds only to the n MSBs of the shifted value if n<m. The LSB of the significand Mz is implicit and it is equal to 1.

In a parallel path, the converter 600FJ comprises LOD module 615FJ having an input coupled to the output of conditional bit inverter 605FJ and an output for generating the shift amount for the preprocessed left shifter 610FJ which is also used as input to exponent computation module 620FJ to generate the exponent Ez of the preprocessed FP number. Alternatively, the input of LOD module 615FJ may be directly coupled at the input of converter 600FJ but, in this case, it should detect the first zero instead of the one when the number is negative.

Compared to conventional fixed-point-to-FP numbers converters, when m>n, there is no rounding up taking place after the shifting operation and therefore there is a reduction in components and processing. When m<n, then there is no bias produced with the used of the proposed converter.

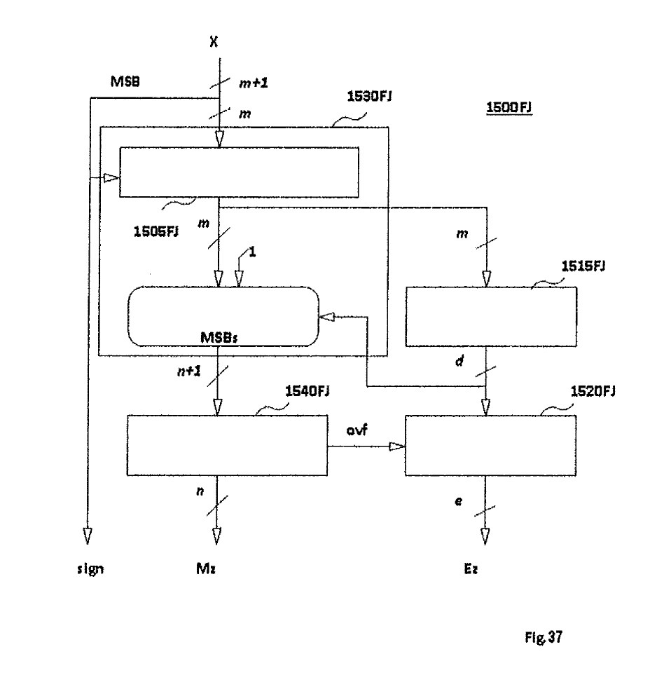

Another category of such converters is converters for converting preprocessed fixed-point numbers to unprocessed FP numbers. FIG. 37 illustrates an example of such a converter for a preprocessed fixed-point numbers of m+2 bits and a unprocessed FP number having a significand of n bits. Converter 1500FJ has an input to receive the m+1 MSBs of an m+2 bit preprocessed fixed point number. Converter 1500FJ comprises a normalization module 1530FJ, having a conditional bit inverter 1505FJ in series with a left shifter 1510FJ, and a rounding module 1540FJ. The conditional bit inverter 1505FJ has a first input for receiving the m LSBs of said m+1 bit input. The MSB of the preprocessed fixed point number is its sign and shall be the sign of the unprocessed FP number as well as used to control the conditional bit inverter 1505FJ. The m-bit output of the conditional bit inverter 1505FJ is input to left shifter 1510FJ. The value 1 is also inserted at the input of the left shifter 1510FJ so that the m bits at the output of the conditional bit inverter 1505FJ are augmented to the right by 1 bit corresponding to the implicit LSB. However, in other implementations the introduction of the additional one may be performed internally to the left shifter 1510FJ without the need for a special input. The left shifter 1510FJ produces a n+1 bit output corresponding to the significand Mz of the unprocessed FP number before rounding. Said output corresponds only to the n+1 MSBs of the shifted value if n<m. Both, the vacant positions to complete the size of n if n>m, and the vacant positions produced after shifting are set to zero. The n+1 output of the normalization module 1530FJ are rounded to n bits by the rounding module 1540FJ. Rounding module 1540FJ also generates an overflow output that is used by exponent calculator 1520FJ to generate the exponent of the unprocessed FP number. The rounder 1540FJ is similar to the rounder 100bCFJ explained in FIG. 35. An adder is used to increment by one the n MSBs of the output of normalization module 1530FJ, if the LSB of said output is one. In alternative implementations different rounding units performing different rounding modes may be used. In other implementations, the MSB of the normalized significand Mz may not include the leading one. Therefore, the output of the conditional bit inverter may be one bit less.

In a parallel path, the converter 1500FJ comprises LOD module 1515FJ having an input coupled to the output of conditional bit inverter 1505FJ and an output for generating the shift amount for the left shifter 1510FJ which is also used, along with the overflow signal, as input to exponent computation module 1520FJ to generate the exponent Ez of the preprocessed FP number. Alternatively, the input of LOD module 1515FJ may be directly coupled at the input of converter 1500FJ. The converter shown in this example may produce some bias when n<m and the input number is in such a way that the LSB of the output of the left shifter 1510FJ coincides with the LSB of said input number. This bias may be avoided by applying standard techniques when this situation occurs; such as only perform the rounding up if the second LSB of the number is also one. In some implementations, said situation may be detected by checking the shift amount whereas in others it may be detected by computing the sticky bit over the m-n LSBs of the shifted value.

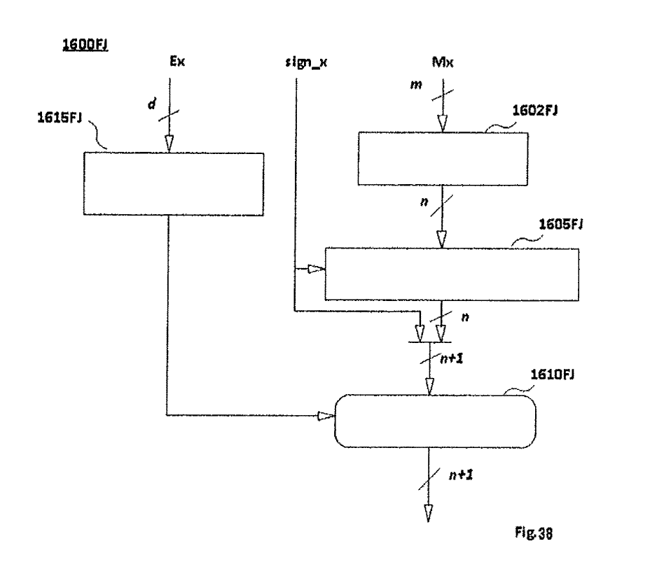

Another category of converters is converters for converting unprocessed FP numbers to preprocessed fixed point numbers. FIG. 38 illustrates a converter 1600FJ for converting an FP number having an m bit significand and a d-bit exponent to a preprocessed fixed point number of n+2 bits. The m-bit significand is input to a unprocessed-to-preprocessed fixed point numbers converter 1602FJ, similar to the ones described in FIGS. 18 to 19b, according to the relation between n and m, arranges to generate the n MSBs of a n+1 bit preprocessed fixed point number. In an alternative implementation, since said significand is normalized, its MSB may be implicit, and said MSB may be not introduced explicitly to the converter. Said n MSBs of said preprocessed number are input to a conditional bit inverter 1605FJ whereas the LSB is implicit and equal to one.

The sign of the unprocessed FP number is used to control the conditional bit inverter 1605FJ. The output of the conditional bit inverter 1605FJ along with the sign (sign_x) is input to right shifter 1610FJ. Right shifter 1610FJ has another input for receiving the shift amount from shift amount calculator 1615FJ. Shift amount calculator 1615FJ receives the exponent of the unprocessed FP number and generates the shift amount. The output of the right shifter 1610FJ is the n+1 MSBs of the preprocessed fixed point number. The LSB is similarly equal to 1 and is neither generated nor depicted. In an alternative implementation the conditional bit inverter may be placed after the right shifter.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

Furthermore, the described embodiments of the invention with reference to the drawings comprise computer systems and processes performed in computer systems, characterized functionally, and independent of the support or technology used for implementation. This support means may be, for example, an application specific integrated circuit (ASIC, acronym) circuit, a programmable logic circuit (FPGA or CPLD, acronym in English) including a memory, or any other device, such circuits being adapted or configured to perform, or for use in performing, the relevant processes.

Although the embodiments described comprise computing devices, the invention also extends to computer programs, more particularly to computer programs in a carrier means adapted to carry out the invention. The computer program may be in source code, object code or an intermediate code between source code and object code such as in partially compiled form, or in any other form suitable for use in the implementation of the processes according to the invention. The carrier may be any entity or device capable of carrying the program.

For example, the carrier may comprise a storage medium such as a ROM, for example a CD ROM or semiconductor ROM, or magnetic recording medium, for example a floppy disc or hard disk. In addition, the carrier may be a transmissible carrier medium such as an electrical or optical signal that can be transmitted via electrical or optical cable or by radio or other means.

When the computer program is contained in a signal that can be transmitted directly via cable or other device or means, the carrier may be constituted by such cable or other device or means.

1. A device for performing a desired addition or subtraction operation of at least two preprocessed floating point numbers to generate a third preprocessed floating point number, each number having a preprocessed significand of m+2 digits, the device comprising:
an exponent data path; and
a significand data path, comprising
a first input arranged to receive at most the m+1 Most Significant Digits (MSDs) of the preprocessed significand of the first number,
a second input arranged to receive at most the m+1 MSDs of the preprocessed significand of the second number,
wherein the significand data path is arranged to generate at most the m+1 MSDs of the preprocessed significand of the third number, whereas the Least Significant Digit (LSD) of all preprocessed significands is equal to B/2, B being the base of the numerical system.

2. A device for performing a multiplication operation of at least two preprocessed floating point numbers to generate a third preprocessed floating point number, each number having a preprocessed mantissa of m+2 digits, the device comprising:
an exponent data path; and
a significand data path, the significand data path comprising
a first input arranged to receive at most the m+1 MSDs of the preprocessed significand of the first number,
a second input arranged to receive at most the m+1 MSDs of the preprocessed significand of the second number,
wherein the significand data path is arranged to generate at most the m+1 MSDs of the significand of the third preprocessed number, whereas the LSD of all preprocessed significands is equal to B/2, B being the base of the numerical system.

3. A device for performing a floating point fused multiply-add operation between three floating point preprocessed numbers to generate a fourth floating point preprocessed number, each number having a preprocessed significand of m+2 digits, the device comprising:
an exponent data path arranged to receive the exponents of the three preprocessed input numbers, and to generate the exponent of the result of the floating point fused multiply-add operation; and
a significand data path, comprising:
a multiplication path comprising
a first input arranged to receive at most the m+1 MSDs of the preprocessed significand of the first number,
a second input arranged to receive at most the m+1 MSDs of the preprocessed significand of the second number,
the multiplication path arranged to multiply said preprocessed significands of the first and second numbers and generate a multiplication result in an output
an adding path, configured to receive at most the m+1 MSDs of the preprocessed significand of the third number in a first input and the multiplication result in a second input, and to generate the at most m+1 MSDs of the significand of the fourth preprocessed number, whereas the LSD of all preprocessed significands is equal to B/2, B being the base of the numerical system.

4. A device configured to be connected to an arithmetic unit, said arithmetic unit arranged to process at least a first preprocessed floating point number to generate at least a second preprocessed floating point number, said preprocessed floating point numbers having a significand with an LSD equal to B/2, B being the base of the numerical system, said device being configured to convert one input number to said at least first preprocessed floating point number or said at least second preprocessed floating point number to an output number.

5. A device for performing a desired operation of at least a first preprocessed fixed point number having n+1 digits to generate at least a second preprocessed fixed point number having z+1 digits, the device comprising at least one arithmetic unit having a first input for receiving the n MSDs of said at least first preprocessed fixed point number, wherein the at least one arithmetic unit is arranged to generate the z MSDs of the at least second preprocessed fixed point number, whereas the Least Significant Digit (LSD) of all preprocessed fixed point numbers is equal to B/2, B being the base of the numerical system.
